(19) United States
(12) Patent Application Publication
(10) Pub. No.: US 2024/0021862 A1
(43) Pub. Date: Jan. 18, 2024

(54) SECONDARY BATTERY, POWER STORAGE SYSTEM, VEHICLE, AND METHOD FOR FABRICATING POSITIVE ELECTRODE

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Tetsuya KAKEHATA, Isehara, Kanagawa (JP); Tetsuji ISHITANI, Atsugi, Kanagawa (JP); Shotaro MURATSUBAKI, Atsugi, Kanagawa (JP)

(21) Appl. No.: 18/252,316

(22) PCT Filed: Nov. 9, 2021
(86) PCT No.: PCT/IB2021/060336

§ 371 Date: May 9, 2023

(30) Foreign Application Priority Data
Nov. 17, 2020 (JP) 2020-191265
Nov. 17, 2020 (JP) 2020-191268
Nov. 17, 2020 (JP) 2020-191271
Dec. 16, 2020 (JP) 2020-208472

(51) Int. Cl. H01M 10/052; H01M 4/525; H01M 10/42; H01M 10/0587; B60L 50/60

(52) U.S. Cl. CPC H01M 10/052; H01M 4/525; H01M 10/4235; H01M 10/0587; B60L 50/66; H01M 2004/028

(57) ABSTRACT

A secondary battery stable in a high-potential state and/or a high-temperature state is provided. The secondary battery includes a positive electrode and a negative electrode, and one or both of the positive electrode and the negative electrode contain an active material and a composite compound with a crystal structure. The composite compound has a function of a binder. The composite compound can also be used as an electrolyte. The composite compound with a crystal structure has typically a molecular crystal. The composite compound with a crystal structure can be obtained by mixing a first compound and a second compound while heating is performed at higher than or equal to a temperature at which a mixture of the first compound and the second compound is melted.

### TECHNICAL FIELD

The present invention relates to a secondary battery including a positive electrode. The present invention also relates to a power storage system, a vehicle, and the like each including a secondary battery. In addition, the present invention relates to methods for fabricating a secondary battery and a positive electrode.

Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that semiconductor devices in this specification mean all devices that can function by utilizing semiconductor characteristics, and an electro-optical device, a semiconductor circuit, and an electronic device are all included in semiconductor devices.

Note that electronic devices in this specification mean all devices including positive electrode active materials, secondary batteries, power storage devices, or power storage systems, and information terminal devices including secondary batteries, for example, are included in electronic devices.

Note that in this specification, a power storage device refers to every element and device having a function of storing power. A power storage device includes, for example, a power storage device such as a lithium-ion secondary battery (also simply referred to as a secondary battery), a lithium-ion capacitor, and an electric double layer capacitor.

### BACKGROUND ART

In recent years, a variety of power storage devices such as lithium-ion secondary batteries and lithium-ion capacitors have been actively developed. Demand for lithium-ion secondary batteries with high output and high energy density has rapidly grown with the development of the semiconductor industry, for portable information terminals such as mobile phones, smartphones, and laptop computers, portable music players, digital cameras, medical equipment, home power storage systems, industrial power storage systems, clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

As positive electrode active materials of lithium-ion secondary batteries, composite oxides having a layered rock-salt structure, such as lithium cobalt oxide and lithium nickel-cobalt-manganese oxide, have been widely used. Positive electrode active materials containing such composite oxides can have valuable characteristics of high capacity and a high discharge voltage. To exhibit high capacity, positive electrode active materials are exposed to a high potential at the time of charge. In such a high-potential state, release of a large amount of lithium might reduce the stability of the crystal structures of the composite oxides, thereby causing significant deterioration in charge and discharge cycles. In view of the aforementioned background, improvements of positive electrode active materials for secondary batteries are actively conducted so as to achieve highly stable secondary batteries with high capacity (e.g., Patent Document 1 to Patent Document 3).

### REFERENCES

### Patent Documents

[Patent Document 1] Japanese Published Patent Application No. 2018-088400
[Patent Document 2] WO2018/203168 Pamphlet
[Patent Document 3] Japanese Published Patent Application No. 2020-140954

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348.
[Non-Patent Document 2] Motohashi, T. et al., “Electronic phase diagram of the layered cobalt oxide system LiₓCoO₂ (0.0≤x≤1.0)”, Physical Review B, 80 (16), 2009, 165114
[Non-Patent Document 3] Zhaohui Chen et al., “Staging Phase Transitions in LiₓCoO₂”, Journal of The Electrochemical Society, 2002, 149 (12), A1604-A1609.
[Non-Patent Document 4] W. E. Counts et al., Journal of the American Ceramic Society, 1953, 36 [1], pp. 12-17.
[Non-Patent Document 5] Belsky, A. et al., “New developments in the Inorganic Crystal Structure Database (ICSD): accessibility in support of materials research and design”, Acta Cryst., 2002, B58, 364-369.

### SUMMARY OF THE INVENTION

### Problems to be Solved by the Invention

In spite of the active improvements of positive electrode active materials in Patent Documents 1 to 3 above, there is room for improvements of positive electrode active materials in terms of reliability, safety, and the like for secondary batteries.

Thus, an object of one embodiment of the present invention is to provide a highly reliable or safe secondary battery and a fabrication method thereof. Another object is to provide a secondary battery with excellent charge and discharge cycle performance and a fabrication method thereof. Another object is to provide a secondary battery with high discharge capacity and a fabrication method thereof.

Aiming at the above-described secondary batteries, an object of one embodiment of the present invention is to provide a positive electrode or a negative electrode that is stable in a high-potential state and/or a high-temperature state and a fabrication method thereof.

Aiming at the above-described positive electrode or negative electrode, an object is to provide a positive electrode active material or a negative electrode active material whose crystal structure is unlikely to be broken by repeated charge and discharge and a formation method thereof. Another object is to provide a positive electrode active material or a negative electrode active material with excellent charge and discharge cycle performance and a formation method thereof. Another object is to provide a positive electrode active material or a negative electrode active material with high discharge capacity and a formation method thereof.

Note that the description of these objects does not preclude the existence of other objects. Note that one embodiment of the present invention does not have to achieve all the objects. Other objects can be derived from the description of the specification, the drawings, and the claims.

### Means for Solving the Problems

In order to provide a positive electrode or a negative electrode that is stable in a high-potential state and/or a high-temperature state in a secondary battery, the present inventors have found a structure in which the positive electrode or the negative electrode contains at least an active material and a composite compound. The composite compound preferably has crystallinity, e.g., a molecular crystal.

In the secondary battery, the composite compound preferably functions as a binder and has high ionic conductivity.

In the secondary battery, the composite compound preferably functions as a solid electrolyte as well as a binder. In the case where the composite compound functions as a solid electrolyte, the secondary battery does not necessarily include a separator. The composite compound is preferably placed such that an active material is not in contact with an organic electrolyte (a liquid electrolyte is referred to as an electrolyte solution). For example, the composite compound is preferably placed to cover part of the active material.

A specific embodiment of the present invention is a secondary battery including a positive electrode and a negative electrode. One or both of the positive electrode and the negative electrode contain an active material and a composite compound with a crystal structure. The composite compound has a function of a binder.

Another embodiment of the present invention is a secondary battery including a positive electrode, a negative electrode, and an electrolyte. One or both of the positive electrode and the negative electrode contain an active material and a composite compound with a crystal structure. The composite compound has a function of a binder. The composite compound includes a region positioned between the active material and the electrolyte.

Another embodiment of the present invention is a secondary battery including a positive electrode and a negative electrode. One or both of the positive electrode and the negative electrode contain an active material and a composite compound with a crystal structure. The composite compound has functions of a binder and an electrolyte.

Another embodiment of the present invention is a secondary battery including a positive electrode and a negative electrode. One or both of the positive electrode and the negative electrode contain an active material, a composite compound with a crystal structure, and a first binder. The composite compound has functions of a second binder and an electrolyte.

Another embodiment of the present invention is a secondary battery including a positive electrode and a negative electrode. One or both of the positive electrode and the negative electrode contain an active material and a composite compound with a crystal structure. The composite compound has a function of a binder. The composite compound contains succinonitrile, a lithium ion, and a bis(fluorosulfonyl)imide ion.

Another embodiment of the present invention is a secondary battery including a positive electrode and a negative electrode. One or both of the positive electrode and the negative electrode contain an active material and a composite compound with a crystal structure. The composite compound has a function of a binder. The composite compound contains glutaronitrile, a lithium ion, and a bis(fluorosulfonyl)imide ion.

Another embodiment of the present invention is a secondary battery including a positive electrode and a negative electrode. One or both of the positive electrode and the negative electrode contain an active material and a composite compound with a crystal structure. The composite compound has a function of a binder. The composite compound contains adiponitrile, a lithium ion, and a bis(fluorosulfonyl)imide ion.

Another embodiment of the present invention is a secondary battery including a positive electrode, a negative electrode, and an electrolyte. One or both of the positive electrode and the negative electrode contain an active material and a composite compound with a crystal structure. The composite compound has a function of a binder. The composite compound includes a region positioned between the active material and the electrolyte. The composite compound contains succinonitrile, a lithium ion, and bis(fluorosulfonyl)imide.

Another embodiment of the present invention is a secondary battery including a positive electrode, a negative electrode, and an electrolyte. One or both of the positive electrode and the negative electrode contain an active material and a composite compound with a crystal structure. The composite compound has a function of a binder. The composite compound includes a region positioned between the active material and the electrolyte. The composite compound contains glutaronitrile, a lithium ion, and bis(fluorosulfonyl)imide.

Another embodiment of the present invention is a secondary battery including a positive electrode, a negative electrode, and an electrolyte. One or both of the positive electrode and the negative electrode contain an active material and a composite compound with a crystal structure. The composite compound has a function of a binder. The composite compound includes a region positioned between the active material and the electrolyte. The composite compound contains adiponitrile, a lithium ion, and a bis(fluorosulfonyl)imide ion.

Another embodiment of the present invention is a secondary battery including a positive electrode and a negative electrode. One or both of the positive electrode and the negative electrode contain an active material and a composite compound with a crystal structure. The composite compound has functions of a binder and an electrolyte. The composite compound contains succinonitrile, a lithium ion, and a bis(fluorosulfonyl)imide ion.

Another embodiment of the present invention is a secondary battery including a positive electrode and a negative electrode. One or both of the positive electrode and the negative electrode contain an active material and a composite compound with a crystal structure. The composite compound has functions of a binder and an electrolyte. The composite compound contains glutaronitrile, a lithium ion, and a bis(fluorosulfonyl)imide ion.

Another embodiment of the present invention is a secondary battery including a positive electrode and a negative electrode. One or both of the positive electrode and the negative electrode contain an active material and a composite compound with a crystal structure. The composite compound has functions of a binder and an electrolyte. The composite compound contains adiponitrile, a lithium ion, and bis(fluorosulfonyl)imide.

In one embodiment of the present invention, it is preferable that the active material in the positive electrode contain a composite oxide containing magnesium and cobalt, the cobalt exist in an inner portion and a surface portion of the active material, and the magnesium exist at least in the surface portion.

In one embodiment of the present invention, it is preferable that, in cross-sectional observation by a scanning transmission electron microscope (STEM), the active material in the positive electrode have a surface roughness of at least less than 3 nm when surface unevenness information is quantified.

In one embodiment of the present invention, it is preferable that a separator be provided between the positive electrode and the negative electrode.

In one embodiment of the present invention, it is preferable that the active material in the positive electrode have a layered rock-salt crystal structure.

In one embodiment of the present invention, it is preferable that the active material in the negative electrode contain silicon or carbon.

In one embodiment of the present invention, it is preferable that one or both of the positive electrode and the negative electrode contain a conductive material.

In one embodiment of the present invention, it is preferable that the conductive material in the positive electrode contain carbon black, graphene, or carbon nanotube.

In one embodiment of the present invention, it is preferable that the conductive material in the negative electrode contain carbon black, graphene, or carbon nanotube.

Another embodiment of the present invention is a power storage system including any of the above secondary batteries and a protection circuit.

Another embodiment of the present invention is a vehicle including any of the above secondary batteries.

One embodiment of the present invention is a method for fabricating a positive electrode, including a first step and a second step. The first step includes a step of forming positive electrode slurry by mixing a composite compound with a crystal structure and a positive electrode active material while heating is performed. The second step includes a step of applying the positive electrode slurry to a current collector. The heating is performed at higher than or equal to a melting point of the composite compound with a crystal structure.

Another embodiment of the present invention is a method for fabricating a positive electrode, including a first step and a second step. The first step includes a step of forming positive electrode slurry by mixing a first compound, a second compound, and a positive electrode active material while heating is performed. The second step includes a step of applying the positive electrode slurry to a current collector. The heating in the first step is performed at higher than or equal to melting points of the first compound and the second compound.

Another embodiment of the present invention is a method for fabricating a positive electrode, including a first step to a third step. The first step includes a step of forming a composite compound with a crystal structure by mixing a first compound and a second compound while heating is performed. The second step includes a step of forming positive electrode slurry by mixing a positive electrode active material and the composite compound while heating is performed. The third step includes a step of applying the positive electrode slurry to a current collector. The heating in the first step is performed at higher than or equal to a melting point of the composite compound.

In one embodiment of the present invention, it is preferable that the first compound contain succinonitrile, glutaronitrile, or adiponitrile, and the second compound contain lithium bis(fluorosulfonyl)imide.

Another embodiment of the present invention is a method for fabricating a positive electrode, including a first step to a fifth step. The first step includes a step of forming a first mixture by mixing a first binder mixture and a conductive material. The second step includes a step of forming a second mixture by mixing the first mixture and a positive electrode active material. The third step includes a step of forming a third mixture by mixing the second mixture, a second binder mixture, and a dispersion medium. The fourth step includes a step of fabricating a coated electrode by applying the third mixture to a current collector and drying the dispersion medium. The fifth step includes a step of injecting a composite compound with a crystal structure into a space in the coated electrode while heating is performed.

In one embodiment of the present invention, it is preferable that the composite compound with a crystal structure be obtained by mixing lithium bis(fluorosulfonyl)imide and succinonitrile, glutaronitrile, or adiponitrile while heating is performed.

### Effect of the Invention

According to one embodiment of the present invention, a highly reliable or safe secondary battery and a fabrication method thereof can be provided. Alternatively, a secondary battery with excellent charge and discharge cycle performance and a fabrication method thereof can be provided. Alternatively, a secondary battery with high discharge capacity and a fabrication method thereof can be provided.

Aiming at the above-described secondary batteries, one embodiment of the present invention can provide a positive electrode or a negative electrode that is stable in a high-potential state and/or a high-temperature state and a fabrication method thereof.

Aiming at the above-described positive electrode or negative electrode, a positive electrode active material or a negative electrode active material whose crystal structure is unlikely to be broken by repeated charge and discharge and a formation method thereof can be provided. Alternatively, a positive electrode active material or a negative electrode active material with excellent charge and discharge cycle performance and a formation method thereof can be provided. Alternatively, a positive electrode active material or a negative electrode active material with high discharge capacity and a formation method thereof can be provided.

Note that the description of these effects does not preclude the existence of other effects. Note that one embodiment of the present invention does not need to have all the effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A to FIG. 1C4 are diagrams illustrating a secondary battery of one embodiment of the present invention.

FIG. 2A and FIG. 2B are diagrams illustrating secondary batteries of one embodiment of the present invention.

FIG. 3A and FIG. 3B are diagrams showing an example of a method for fabricating a positive electrode used in a lithium-ion secondary battery of one embodiment of the present invention.

FIG. 4A and FIG. 4B are diagrams showing an example of a method for fabricating a positive electrode used in a lithium-ion secondary battery of one embodiment of the present invention.

FIG. 5A and FIG. 5B are diagrams showing examples of a method for fabricating a lithium-ion secondary battery of one embodiment of the present invention.

FIG. 6A to FIG. 6C are diagrams showing examples of a method for forming a positive electrode active material composite of one embodiment of the present invention.

FIG. 7A and FIG. 7B are calculation models according to density functional theory for positive electrode active material composites of one embodiment of the present invention.

FIG. 8A to FIG. 8C are graphs showing calculation results of positive electrode active material composites of one embodiment of the present invention that are obtained by density functional theory.

FIG. 9A to FIG. 9C are diagrams showing a method for forming a positive electrode active material of one embodiment of the present invention.

FIG. 10 is a diagram showing a method for forming a positive electrode active material of one embodiment of the present invention.

FIG. 11A to FIG. 11C are diagrams showing a method for forming a positive electrode active material of one embodiment of the present invention.

FIG. 12A is a front view of a positive electrode active material of one embodiment of the present invention, and FIG. 12B is a cross-sectional view of the positive electrode active material of one embodiment of the present invention.

FIG. 13 is a diagram illustrating crystal structures of a positive electrode active material of one embodiment of the present invention.

FIG. 14 shows XRD patterns calculated from crystal structures.

FIG. 15 is a diagram illustrating crystal structures of a positive electrode active material of a conventional example.

FIG. 16 shows XRD patterns calculated from crystal structures.

FIG. 17A to FIG. 17C show lattice constants calculated from XRD patterns.

FIG. 18A to FIG. 18C show lattice constants calculated from XRD patterns.

FIG. 19 is a graph showing charge curves of secondary batteries using a positive electrode active material of one embodiment of the present invention and a secondary battery using a positive electrode active material of a comparative example.

FIG. 20A and FIG. 20B show dQ/dV curves of half cells of one embodiment of the present invention, and FIG. 20C shows a dQ/dV curve of a half cell of a comparative example.

FIG. 21 is a schematic cross-sectional view of a positive electrode active material.

FIG. 22A and FIG. 22B are SEM images of positive electrodes.

FIG. 23A is a front view of a positive electrode active material based on FIB (Focused Ion Beam) processing and SEM observation, FIG. 23B is a partial enlarged view of FIG. 23A, FIG. 23C is a cross-sectional view of FIG. 23B, FIG. 23D is a side view obtained by rotating the positive electrode active material of FIG. 23A, FIG. 23E is a partial enlarged view of FIG. 23D, and FIG. 23F is a cross-sectional view of FIG. 23E.

FIG. 24A to FIG. 24C are SEM images of a positive electrode.

FIG. 25A to FIG. 25C are SEM images of a positive electrode.

FIG. 26A and FIG. 26B are STEM images of a positive electrode.

FIG. 27A to FIG. 27C show EDX analysis results of a positive electrode.

FIG. 28A and FIG. 28B are cross-sectional TEM images of a positive electrode active material layer.

FIG. 29A to FIG. 29C show nanobeam electron diffraction patterns of a positive electrode active material layer.

FIG. 30A to FIG. 30C are diagrams illustrating examples of crystal structures.

FIG. 31A is a STEM image of a particle after pressing, and FIG. 31B and FIG. 31C are schematic cross-sectional views.

FIG. 32A is an exploded perspective view of a coin-type secondary battery, FIG. 32B is a perspective view of the coin-type secondary battery, and FIG. 32C is a cross-sectional perspective view thereof.

FIG. 33A illustrates an example of a cylindrical secondary battery. FIG. 33B illustrates an example of a cylindrical secondary battery. FIG. 33C illustrates an example of a plurality of cylindrical secondary batteries. FIG. 33D illustrates an example of a power storage system including the plurality of cylindrical secondary batteries.

FIG. 34A and FIG. 34B are diagrams illustrating examples of a secondary battery, and FIG. 34C is a diagram illustrating the internal state of a secondary battery.

FIG. 35A to FIG. 35C are diagrams illustrating an example of a secondary battery.

FIG. 36A and FIG. 36B are diagrams illustrating external views of secondary batteries.

FIG. 37A to FIG. 37C are diagrams illustrating a method for fabricating a secondary battery.

FIG. 38A to FIG. 38C are diagrams illustrating structure examples of a battery pack.

FIG. 39A and FIG. 39B are diagrams illustrating examples of a secondary battery.

FIG. 40A to FIG. 40C are diagrams illustrating an example of a secondary battery.

FIG. 41A and FIG. 41B are diagrams illustrating an example of a secondary battery.

FIG. 42A is a perspective view of a battery pack of one embodiment of the present invention, FIG. 42B is a block diagram of the battery pack, and FIG. 42C is a block diagram of a vehicle having a motor.

FIG. 43A to FIG. 43D are diagrams illustrating examples of transport vehicles.

FIG. 44A and FIG. 44B are diagrams illustrating a power storage device of one embodiment of the present invention.

FIG. 45A is a diagram illustrating an electric bicycle, FIG. 45B is a diagram illustrating a secondary battery of the electric bicycle, and FIG. 45C is a diagram illustrating an electric motorcycle.

FIG. 46A to FIG. 46D are diagrams illustrating examples of electronic devices.

FIG. 47A illustrates examples of wearable devices, FIG. 47B is a perspective view of a watch-type device, and FIG. 47C is a diagram illustrating a side surface of the watch-type device. FIG. 47D is a diagram illustrating an example of wireless earphones.

FIG. 48A to FIG. 48C are diagrams each showing a structural formula of a compound and the amount of charge of nitrogen atoms.

FIG. 49A to FIG. 49C are diagrams each showing an example of a stable structure of a composite compound.

FIG. 50A is a diagram showing a method for forming a composite compound, FIG. 50B is a photograph of a formed composite compound, and FIG. 50C is a diagram showing analysis results.

FIG. 51A is a diagram showing a method for forming a composite compound, FIG. 51B is a photograph of a formed composite compound, and FIG. 51C is a diagram showing analysis results.

### MODE FOR CARRYING OUT THE INVENTION

Embodiments of the present invention will be described in detail below with reference to the drawings. However, the present invention is not limited to the description below and it is easily understood by those skilled in the art that the mode and details can be modified in various ways. In addition, the present invention should not be construed as being limited to the description of the embodiments below.

In this specification and the like, a secondary battery includes a positive electrode and a negative electrode, for example. The positive electrode includes a positive electrode active material. The positive electrode active material is a substance that performs a reaction contributing to the charge and discharge capacity, for example. Note that the positive electrode active material may partly include a substance that does not contribute to the charge and discharge capacity.

In this specification and the like, a positive electrode active material is expressed as a positive electrode material, a secondary battery positive electrode material, a composite oxide, or the like in some cases. In this specification and the like, a positive electrode active material preferably contains a compound corresponding to a composite oxide. In this specification and the like, a positive electrode active material preferably contains a composition corresponding to a composite oxide. In this specification and the like, a positive electrode active material preferably contains a composite corresponding to a composite oxide.

In this specification and the like, particles are not necessarily spherical (with a circular cross section) and include particles with cross-sectional shapes such as an ellipse, a rectangle, a trapezoid, a quadrilateral with rounded corners, and an asymmetrical shape, and a particle may have an indefinite shape.

In this specification and the like, for example, particle diameters can be obtained by laser diffraction particle size distribution measurement and can be compared by the numerical values of D50. Here, D50 is a particle diameter when the accumulated amount of particles accounts for 50% of an accumulated particle amount curve which is the result of the particle size distribution measurement. In other words, D50 is a median. Measurement of the size of a particle is not limited to laser diffraction particle size distribution measurement; in the case where the size is less than or equal to the lower measurement limit of laser diffraction particle size distribution measurement, the major axis of a cross section of the particle may be measured by analysis with a SEM (Scanning Electron Microscope), a TEM (Transmission Electron Microscope), or the like.

In this specification and the like, the Miller index is used for the expression of crystal planes and orientations. An individual plane that shows a crystal plane is denoted by “( )”. In the crystallography, a bar is placed over a number in the expression of crystal planes, orientations, and space groups; in this specification and the like, because of application format limitations, crystal planes, orientations, and space groups are sometimes expressed by placing − (minus sign) in front of the number instead of placing a bar over the number.

In this specification and the like, a layered rock-salt crystal structure of a composite oxide containing lithium and a transition metal has a rock-salt ion arrangement where cations and anions are alternately arranged. In the layered rock-salt crystal structure, the transition metal and lithium are regularly arranged to form a two-dimensional plane, so that lithium can diffuse two-dimensionally. Note that in the layered rock-salt crystal structure, a defect such as a cation or anion vacancy may exist. Moreover, in the layered rock-salt crystal structure, a lattice of a rock-salt crystal is distorted in some cases.

In this specification and the like, a rock-salt crystal structure refers to a structure in which cations and anions are alternately arranged. Note that a defect such as a cation or anion vacancy may exist in part of the crystal structure.

In this specification and the like, the theoretical capacity of a positive electrode active material refers to the amount of electricity for the case where all the lithium that can be inserted and extracted in the positive electrode active material is extracted. The theoretical capacity of LiFePO₄ is 170 mAh/g, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, the remaining amount of lithium that can be inserted into and extracted from a positive electrode active material is represented by x in a compositional formula, e.g., x in LiₓCoO₂ or x in LiₓMO₂. In this specification, LiₓCoO₂ can be replaced with LiₓMO₂ as appropriate. In the case of a positive electrode active material in a secondary battery, x can be represented by (theoretical capacity−charge capacity)/theoretical capacity. For example, when a secondary battery using LiCoO₂ as a positive electrode active material is charged to 219.2 mAh/g, the positive electrode active material can be represented by Li_{0.2}CoO₂ or x=0.2. Small x in LiₓCoO₂ means, for example, 0.1<x≤0.24.

Lithium cobalt oxide to be used for a positive electrode, which has been appropriately synthesized and almost satisfies the stoichiometric proportion, is LiCoO₂, and the occupancy rate x of Li in the lithium sites is 1. For a secondary battery after its discharge ends, it can be said that lithium cobalt oxide is LiCoO₂ and x=1. Here, “discharge ends” means that a voltage becomes 2.5 V (vs. lithium counter electrode) or lower at a current of 100 mA/g, for example.

In this specification and the like, an example of a cycle test performed using a lithium metal for a counter electrode is sometimes described at the time of evaluating a positive electrode and a positive electrode active material; however, one embodiment of the present invention is not limited to this example. Instead of a lithium metal, for example, graphite, lithium titanate, or the like may be used. That is, the properties of a positive electrode and a positive electrode active material, such as a crystal structure unlikely to be broken by repeated charge and discharge and excellent cycle performance, are not affected by a material of a negative electrode.

In this specification and the like, a cycle test refers to a test in which charge and discharge are repeated. Through a cycle test, the degradation degree of a secondary battery can be checked, which enables a positive electrode and a positive electrode active material to be evaluated.

In this specification and the like, an example is sometimes described in which a secondary battery using a lithium counter electrode is charged and discharged at a relatively high charge voltage of 4.6 V; however, charge and discharge may be performed at a charge voltage of lower than 4.6 V. Charge and discharge at a lower voltage will result in cycle performance better than performance described in this specification and the like.

In this specification and the like, the term “kiln” refers to an apparatus for heating an object. Instead of the kiln, the term “furnace”, “stove”, or “heating apparatus” may be used, for example.

### Embodiment 1

In this embodiment, a secondary battery of one embodiment of the present invention will be described. The secondary battery includes a positive electrode of one embodiment of the present invention and a negative electrode. Note that a secondary battery using lithium ions as carrier ions is referred to as a lithium-ion secondary battery.

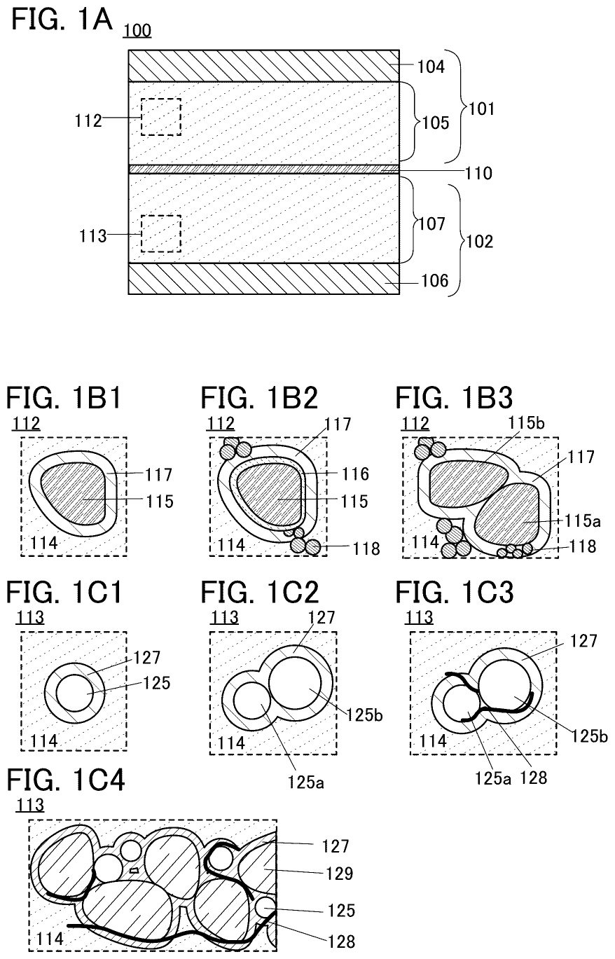

FIG. 1A is a cross-sectional view of a secondary battery 100. The secondary battery 100 includes a positive electrode 101 and a negative electrode 102. A separator 110 is positioned between the positive electrode 101 and the negative electrode 102. In other words, the positive electrode 101 and the negative electrode 102 are separated from each other by the separator 110. Note that the separator 110 is not necessarily provided as long as the state where the positive electrode 101 and the negative electrode 102 are separated from each other can be maintained.

The positive electrode 101 includes a positive electrode current collector 104 and a positive electrode active material layer 105. The positive electrode active material layer 105 contains a positive electrode active material. The positive electrode active material contains an active material capable of receiving and releasing carrier ions. As the active material, for example, a composite oxide represented by LiM1O₂ (M1 is one or two or more selected from Fe, Ni, Co, Mn, and Al) can be used. The composite oxide is obtained by using a first oxide and a second oxide as starting materials, for example, and the term “composite” sometimes means that two or more oxides are used as starting materials. The composite oxide will be specifically described in the following embodiments.

The positive electrode active material is placed in a state where electrons can be donated and accepted to/from the positive electrode current collector 104. That is, the positive electrode active material is in electrical contact with the positive electrode current collector 104. The positive electrode current collector 104 may be provided with an undercoat layer. In that case, the positive electrode active material is in electrical contact with the positive electrode current collector 104 through the undercoat layer. The positive electrode active material may be in electrical contact with the positive electrode current collector 104 through a conductive material. The conductive material is also referred to as a conductive additive, and a material with a lower resistivity than the positive electrode active material is used. The conductive material enables an efficient current path to be formed between the positive electrode active material and the positive electrode current collector or between the positive electrode active materials. In order to achieve this, it is preferable that the conductive materials be appropriately dispersed in the positive electrode active material layer 105.

The negative electrode 102 includes a negative electrode current collector 106 and a negative electrode active material layer 107. The negative electrode active material layer 107 contains a negative electrode active material. The negative electrode active material contains an active material capable of receiving and releasing carrier ions. The active material of the negative electrode will be specifically described in the following embodiments.

The negative electrode active material is placed in a state where electrons can be donated and accepted to/from the negative electrode current collector 106. That is, the negative electrode active material is in electrical contact with the negative electrode current collector 106. The negative electrode current collector 106 may be provided with an undercoat layer. In that case, the negative electrode active material is in electrical contact with the negative electrode current collector 106 through the undercoat layer. The negative electrode active material may be in electrical contact with the negative electrode current collector 106 through a conductive material. The conductive material is also referred to as a conductive additive, and a material with a lower resistivity than the negative electrode active material is used. The conductive material enables an efficient current path to be formed between the negative electrode active material and the negative electrode current collector or between the negative electrode active materials. In order to achieve this, it is preferable that the conductive materials be appropriately dispersed in the negative electrode active material layer 107.

The positive electrode active material and components in the vicinity thereof will be described. FIG. 1B1 corresponds to an enlarged view of a region 112 in FIG. 1A, and FIG. 1B1 illustrates at least an electrolyte (a liquid electrolyte is referred to as an electrolyte solution) 114 and a positive electrode active material 115. The positive electrode active material 115 is preferably covered with a composite compound 117.

The composite compound 117 is obtained by using a first compound and a second compound as starting materials, for example, and the term “composite” sometimes means that two or more compounds are used as starting materials. The composite compound preferably has a crystal structure.

As the composite compound having a crystal structure, a molecular crystal is preferably used, for example. The molecular crystal is a general term of crystals of a molecular composite compound formed by binding a compound A and a compound B with physical intermolecular force, e.g., a coordinate bond. The molecular crystal is formed by mixing the first compound and the second compound, and preferably has a structure in which parts of the compounds are bound to each other with a coordinate bond.

The composite compound 117 can serve as a binder for the positive electrode active material 115. In addition to the binder included in the positive electrode active material layer, the composite compound 117 may serve as the binder for the positive electrode active material 115.

The composite compound 117 preferably contains a material with high ionic conductivity. Carrier ions can be received and released between the positive electrode active material 115 and the electrolyte 114 through the composite compound 117. That is, the composite compound 117 can serve as an electrolyte.

Furthermore, the composite compound 117 can have both functions of a binder and an electrolyte.

The composite compound 117 having a crystal structure is in a solid state. The use of the composite compound 117 having a crystal structure as an electrolyte can eliminate the need for a separator. That is, a secondary battery using the composite compound 117 having a crystal structure as an electrolyte can have a structure similar to that of an all-solid-state secondary battery.

When covered with the composite compound 117, the positive electrode active material 115 can have a region not in contact with the electrolyte 114. In that case, the composite compound 117 is placed to have a region positioned between the positive electrode active material 115 and the electrolyte 114. Such a composite compound 117 probably inhibits the deterioration of the positive electrode active material 115 due to the electrolyte 114.

Here, the deterioration will be described. The deterioration is probably caused by a defect generated in the positive electrode active material 115. Examples of the defect include a crack and a pit. The positive electrode active material 115 expands and contracts repeatedly at the time of charging and discharging a secondary battery, and physical pressure is probably applied to the positive electrode active material 115 because of a volume change due to repeated expansion and contraction. Application of the pressure might generate a defect, e.g., a crack. A crack refers to a crevice generated by application of physical pressure. A pit refers to a hole formed by extraction of some layers of a main component, e.g., cobalt or oxygen, and includes a hole generated by pitting corrosion. For example, cobalt is considered to sometimes dissolve into the electrolyte 114, and a hole might be generated by dissolution of one cobalt layer. This is called a pit. A pit might progress during charge and discharge of a secondary battery, which makes a hole deep. That is, a pit can also be referred to as a progressive defect.

With the composite compound 117, the structure in which the electrolyte 114 and the positive electrode active material 115 are not in contact with each other can be provided, in which case generation and progress of the defect, e.g., a pit, that might cause the deterioration can be inhibited. In order to obtain an effect of inhibiting the deterioration, the composite compound 117 needs to cover part of the positive electrode active material 115. Such a structure can inhibit the deterioration of a secondary battery.

Another positive electrode active material and components in the vicinity thereof will be described. FIG. 1B2 corresponds to an enlarged view of the region 112 in FIG. 1A, and FIG. 1B2 illustrates at least a conductive material 118 and the positive electrode active material 115 covered with a barrier layer 116. A positive electrode active material covered with a barrier layer is sometimes referred to as a positive electrode active material composite, and the positive electrode active material composite will be described in Embodiment 3 and the like. The other components in FIG. 1B2 are the same as those in FIG. 1B1. The barrier layer 116 exists as a region containing a material different from the main active material of the positive electrode active material 115. Alternatively, the barrier layer 116 exists as a region containing an additive element contained in the positive electrode active material 115. A material used as the additive element will be specifically described in the following embodiments.

The barrier layer 116 is preferably positioned in a surface portion of the positive electrode active material 115. A surface portion refers to, for example, a region that is within 50 nm, preferably within 35 nm, further preferably within 20 nm, most preferably within 10 nm in depth from a surface of a positive electrode active material toward an inner portion. A plane generated by a split and/or a crack may also be referred to as a surface.

The barrier layer 116 existing in the surface portion can inhibit the deterioration of the positive electrode active material 115 over time. In order to inhibit deterioration over time, the barrier layer 116 preferably covers the entire surface of the positive electrode active material 115; needless to say, the effect of inhibiting the deterioration can also be obtained when the barrier layer 116 covers part of the positive electrode active material 115.

After the positive electrode active material 115 including the barrier layer 116 in the surface portion is formed, the positive electrode active material 115 is preferably provided with the composite compound 117. That is, the composite compound 117 is preferably positioned outward from the barrier layer 116. This is because the composite compound 117 prevents the positive electrode active material 115 and the electrolyte 114 from being in contact with each other. In addition, the composite compound 117 preferably includes a region having a larger thickness than the barrier layer 116.

The conductive material 118 is placed to supplement the conductivity of the positive electrode active material 115. Thus, the conductive material 118 contains a material with higher conductivity than the positive electrode active material 115. A material used as the conductive material will be specifically described in the following embodiments.

The conductive material 118 can serve as a current path between the positive electrode active material 115 and the positive electrode current collector 104. The conductive material 118 is sometimes mixed in the composite compound 117. In a region where the conductive material 118 is mixed, the composite compound 117 is broken and the positive electrode active material 115 is exposed from the composite compound 117 in some cases. The conductive material 118 may be used in the above-described structure in FIG. 1B1.

Another positive electrode active material and components in the vicinity thereof will be described. FIG. 1B3 corresponds to an enlarged view of the region 112 in FIG. 1A, and FIG. 1B3 illustrates a state where at least a first positive electrode active material 115a and a second positive electrode active material 115b are bound to each other. The other components in FIG. 1B3 are the same as those in FIG. 1B2. As another component in FIG. 1B3, a barrier layer positioned in surface portions of the first positive electrode active material 115a and the second positive electrode active material 115b may be provided as in FIG. 1B2.

Since the first positive electrode active material 115a and the second positive electrode active material 115b are bound to each other, the composite compound 117 covers both the first positive electrode active material 115a and the second positive electrode active material 115b. In the case of providing the barrier layer, the composite compound 117 is preferably positioned outward from the barrier layer. It can be considered that the first positive electrode active material 115a and the second positive electrode active material 115b are not in contact with the electrolyte 114 owing to the composite compound 117, thereby inhibiting the deterioration of the first positive electrode active material 115a and the second positive electrode active material 115b due to the electrolyte 114.

Next, a negative electrode active material and components in the vicinity thereof will be described. FIG. 1C1 corresponds to an enlarged view of a region 113 in FIG. 1A, and FIG. 1C1 illustrates at least the electrolyte 114 and a first negative electrode active material 125. The electrolyte 114 is also included in the positive electrode 101. The first negative electrode active material 125 is preferably covered with a composite compound 127. The composite compound 127 can serve as a binder for the first negative electrode active material 125. The composite compound 127 preferably contains a material with high ionic conductivity, and the first negative electrode active material 125 covered with the composite compound 127 can receive and release carrier ions from/to the electrolyte 114 even through the composite compound 127. That is, the composite compound 127 can serve as an electrolyte.

The composite compound 127 may contain the same material as the composite compound 117 included in the positive electrode. Alternatively, the composite compound 127 may contain a different material from the composite compound 117 included in the positive electrode.

The composite compound 127 is a composite compound obtained by using a first compound and a second compound as starting materials, and the term “composite” sometimes means that two or more kinds of compounds are used as starting materials. The composite compound preferably has a crystal structure. The composite compound having a crystal structure has a high capability of holding the first negative electrode active material 125 and is suitably used as a binder. The composite compound having a crystal structure is suitable also as an electrolyte; it functions as what is called a solid electrolyte and can eliminate the need for a separator.

As the composite compound having a crystal structure, a molecular crystal is preferably used, for example.

The first negative electrode active material 125 covered with the composite compound 127 can be placed so as not to be in contact with the electrolyte 114. This inhibits the deterioration of the first negative electrode active material 125 due to the electrolyte.

In order to inhibit the deterioration, the composite compound 127 needs to cover part of the first negative electrode active material 125. Such a structure can inhibit the deterioration of a secondary battery.

Another negative electrode active material and components in the vicinity thereof will be described. FIG. 1C2 corresponds to an enlarged view of the region 113 in FIG. 1A, and FIG. 1C2 illustrates a state where at least a first negative electrode active material 125a and a second negative electrode active material 125b are bound to each other. The other components in FIG. 1C2 are the same as those in FIG. 1C1.

Since the first negative electrode active material 125a and the second negative electrode active material 125b are bound to each other, the composite compound 127 covers both the first negative electrode active material 125a and the second negative electrode active material 125b. It can be considered that the first negative electrode active material 125a and the second negative electrode active material 125b are not in contact with the electrolyte 114 owing to the composite compound 127, thereby inhibiting the deterioration of the first negative electrode active material 125a and the second negative electrode active material 125b due to the electrolyte.

The negative electrode active material and another component in the vicinity thereof will be described. FIG. 1C3 corresponds to an enlarged view of the region 113 in FIG. 1A, and FIG. 1C3 illustrates a state where at least the first negative electrode active material 125a and the second negative electrode active material 125b are bound to each other and also illustrates a conductive material 128. The other components in FIG. 1C3 are the same as those in FIG. 1C2.

The conductive material 128 is placed to supplement the conductivity of the first negative electrode active material 125. Thus, the conductive material 128 contains a material with higher conductivity than the first negative electrode active material 125. A material used as the conductive material will be specifically described in the following embodiments.

The conductive material 128 can serve as a current path between the first negative electrode active material 125 and the negative electrode current collector 106. In FIG. 1C3, the conductive material 128 probably serves also as a current path between the first negative electrode active material 125a and the second negative electrode active material 125b. The conductive material 128 is sometimes mixed in the composite compound 127. In a region where the conductive material 128 is mixed, the composite compound 127 is broken and the first negative electrode active material 125a and the second negative electrode active material 125b are partly exposed from the composite compound 127 in some cases.

The negative electrode active material and other components in the vicinity thereof will be described. FIG. 1C4 corresponds to an enlarged view of the region 113 in FIG. 1A, and FIG. 1C4 illustrates at least the first negative electrode active material 125 and a second negative electrode active material 129. A plurality of the first negative electrode active materials 125 and a plurality of the second negative electrode active materials 129 are illustrated. Note that a material or a particle diameter preferably differs between the first negative electrode active material 125 and the second negative electrode active material 129. For example, it is preferable that the first negative electrode active material 125 contain silicon and be a nanoparticle with a small particle diameter, the second negative electrode active material 129 contain graphite, and the particle diameter of the second negative electrode active material 129 be larger than the particle diameter of the first negative electrode active material 125. The other components in FIG. 1C4 are the same as those in FIG. 1C3.

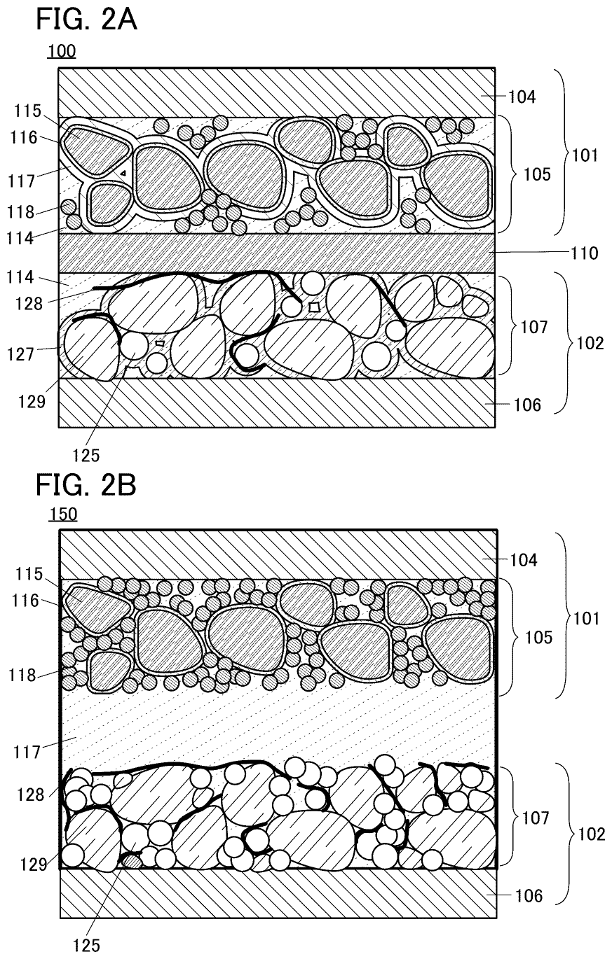

Next, structure examples of secondary batteries in each of which any one of the above-described positive electrode active materials and any one of the above-described negative electrode active materials are combined will be described. FIG. 2A is a cross-sectional view of the secondary battery 100. The secondary battery 100 shows an example in which the positive electrode active material and the like illustrated in FIG. 1B2 and the negative electrode active material and the like illustrated in FIG. 1C4 are used. As described here, a combination of any one of the above-described positive electrode active materials and any one of the above-described negative electrode active materials can be used for the secondary battery.

The separator 110 is infiltrated with the electrolyte 114. A state of being infiltrated is sometimes referred to as impregnation.

The positive electrode active material 115 covered with the composite compound 117 and the first negative electrode active material 125 and the second negative electrode active material 129 each covered with the composite compound 127 include regions not in contact with the electrolyte 114, thereby inhibiting the deterioration of the positive electrode active material 115, the first negative electrode active material 125, and the second negative electrode active material 129 due to the electrolyte. The deterioration is probably caused by defects generated in the positive electrode active material 115, the first negative electrode active material 125, and the second negative electrode active material 129. Examples of the defects include a crack and a pit. The structure in which the electrolyte 114 is in contact with neither the positive electrode active material 115, the first negative electrode active material 125, nor the second negative electrode active material 129 can inhibit generation and progress of the defects, especially pits.

Note that in order to inhibit the deterioration, the positive electrode active material 115, the first negative electrode active material 125, and the second negative electrode active material 129 need to include the regions not in contact with the electrolyte 114; thus, the composite compound 117 does not necessarily cover the entire surfaces of the positive electrode active material 115, the first negative electrode active material 125, and the second negative electrode active material 129 and needs to cover parts of them. Such a structure can inhibit generation and progress of the defects, especially pits, so that the deterioration of the secondary battery can be inhibited.

The composite compound 117 has a function of binding a plurality of the positive electrode active materials 115 to each other and has a function of a binder. The composite compound 117 has a function of binding the positive electrode current collector 104 to the positive electrode active material 115 and has a function of a binder. The composite compound 117 may include a region where the conductive material 118 is mixed. In the case where the conductivity of the composite compound 117 is low, a current path can be secured by the conductive material 118. The positive electrode active material 115 or the composite compound 117 sometimes enters the surface of the positive electrode current collector 104. That is, the surface of the positive electrode current collector 104 sometimes has unevenness in a cross-sectional view of the secondary battery. In some cases, the composite compound 117 is broken in the surface of the positive electrode current collector 104 and the positive electrode active material 115 is exposed from the composite compound 117. The exposed region is in contact with the positive electrode current collector 104 and thus is probably not in contact with the electrolyte 114.

The composite compound 127 has a function of binding the first negative electrode active materials 125 to each other, binding the second negative electrode active materials 129 to each other, or binding the first negative electrode active material 125 to the second negative electrode active material 129, and has a function of a binder. The composite compound 127 has a function of binding the negative electrode current collector 106 to the first negative electrode active material 125 or the second negative electrode active material 129, and has a function of a binder. The composite compound 127 may include a region where the conductive material 128 is mixed. In the case where the conductivity of the composite compound 127 is low, a current path can be secured by the conductive material 128. The first negative electrode active material 125, the second negative electrode active material 129, or the composite compound 127 sometimes enters the surface of the negative electrode current collector 106. That is, the surface of the negative electrode current collector 106 sometimes has unevenness in a cross-sectional view of the secondary battery. In some cases, the composite compound 127 is broken in the surface of the negative electrode current collector 106 and the first negative electrode active material 125 or the second negative electrode active material 129 is exposed from the composite compound 127. The exposed region is in contact with the negative electrode current collector 106 and thus is probably not in contact with the electrolyte 114.

The composite compound 127 may contain the same material as or a different material from the composite compound 117. The composite compound 117 and the composite compound 127 each preferably have a crystal structure, and further preferably have high ionic conductivity. When having high ionic conductivity, the composite compound 117 and the composite compound 127 can each function as an electrolyte.

The composite compound 117 or the composite compound 127 can be obtained by using the first compound and the second compound as starting materials.

A compound represented by General Formula (G1) below is contained as the first compound. General Formula (G1) below represents a compound having a cyano group.

[Chemical Formula 1]

CN—R—CN (G1)

In General Formula (G1) above, R represents a hydrocarbon having 1 to 5 carbon atoms. In General Formula (G1) above, R preferably represents a hydrocarbon having 2 to 4 carbon atoms.

Specific examples of General Formula (G1) above include succinonitrile, glutaronitrile, and adiponitrile, and a specific example of the compound having a cyano group is acetonitrile. As the first compound, one or two or more selected from them can be used.

As the second compound, one or two or more selected from lithium bis(fluorosulfonyl)imide (Li(FSO₂)₂N, abbreviation: LiFSI), lithium bis(trifluoromethanesulfonyl)imide (Li(CF₃SO₂)₂N, abbreviation: LiTFSI), and lithium bis(pentafluoroethanesulfonyl)imide (Li(C₂F₅SO₂)₂N, abbreviation: LiBETI) can be used.

Preferred examples of a combination of the first compound and the second compound are shown in (H1) to (H3) below.

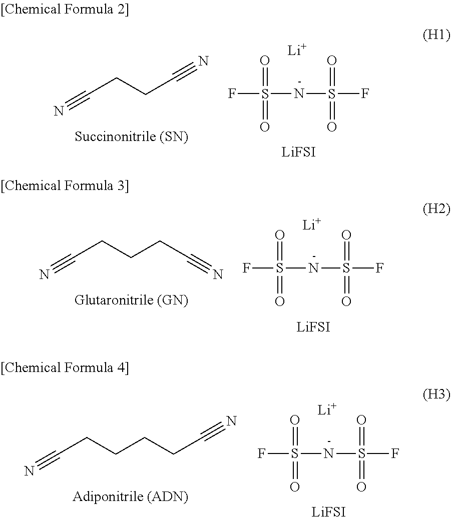

Whether or not a composite compound obtained by the combination of the compounds shown in each of (H1) to (H3) above forms a molecular crystal can be confirmed by XRD measurement or the like. In XRD measurement results, the value of the peak position (2θ) allows a deviation of ±0.50°.

Note that the composite compound obtained by the combination of the compounds shown in (H1) above is represented by Li(FSI)(SN)₂ and sometimes has a melting point of 63.4° C. or around 63.4° C. The composite compound obtained by the combination of the compounds shown in (H2) above is represented by Li(FSI)(GN)₂ and sometimes has a melting point of 89.3° C. or around 89.3° C. The composite compound obtained by the combination of the compounds shown in (H3) above is represented by Li(FSI)(ADN)₂ and sometimes has a melting point of 90.9° C. or around 90.9° C.

That is, in order to obtain the composite compound 117 having a high melting point, the composite compound obtained by the combination of the compounds shown in each of (H2) and (H3) above is preferred to the composite compound obtained by the combination of the compounds shown in (H1) above.

Next, the amounts of charge of nitrogen atoms in succinonitrile, glutaronitrile, and adiponitrile that can each be used as the first compound are calculated. The nitrogen atoms can form coordinate bonds with lithium ions, and the strengths of the coordinate bonds between the lithium ions and the first compounds can be calculated from the amounts of charge of the nitrogen atoms, which enables comparison of the strengths. Gaussian 09 is used as quantum chemistry computational software for the calculation. Molecular structures of succinonitrile, glutaronitrile, and adiponitrile in the ground states are optimized, and then charge distribution in the molecules is analyzed to obtain the amounts of charge.

First, structural optimization calculation is performed on succinonitrile, glutaronitrile, and adiponitrile in the ground states that can each be used as the first compound. Density functional theory (DFT) is used for the structural optimization calculation. In the DFT, the total energy is represented as the sum of potential energy, electrostatic energy between electrons, electronic kinetic energy, and exchange-correlation energy including all the complicated interactions between electrons. Also in the DFT, an exchange-correlation interaction is approximated by a functional (a function of another function) of one electron potential represented in terms of electron density to enable high-speed and high-accuracy calculations. Here, B3LYP that is a hybrid functional is used to specify the weight of each parameter related to exchange-correlation energy. In addition, as a basis function, 6-311G (a basis function of a triple-split valence basis set using three contraction functions for each valence orbital) is applied to all the atoms. By the above basis function, for example, is to 3s orbitals are considered in the case of hydrogen atoms, while is to 4s and 2p to 4p orbitals are considered in the case of carbon atoms. Furthermore, to improve calculation accuracy, the p function and the d function as polarization basis sets are added to hydrogen atoms and atoms other than hydrogen atoms, respectively.

In the analysis of charge distribution, electrostatic potential charge fitting is performed using a point based on a scheme of a Merz-Singh-Kollmans (MK) method. Table 1 below summarizes the calculation conditions.

TABLE 1

| | |
|---|---|
| Software | Gaussian09 |
| Functional | B3LYP |
| Basis function | 6-311G (d, p) |
| Charge distribution | Electrostatic potential charge fitting by Merz- |
| analysis | Singh-Kollmans (MK) method |
| Calculation target | Molecular structure optimization and charge |
| | distribution analysis |

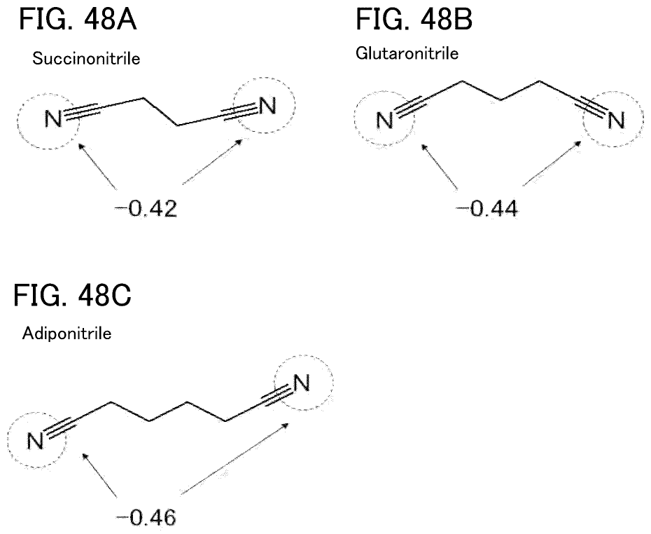

FIG. 48A shows a structural formula of succinonitrile and the amounts of charge of nitrogen atoms in succinonitrile. The amounts of charge of nitrogen atoms in succinonitrile are each −0.42. FIG. 48B shows a structural formula of glutaronitrile and the amounts of charge of nitrogen atoms in glutaronitrile. The amounts of charge of nitrogen atoms in glutaronitrile are each −0.44. FIG. 48C shows a structural formula of adiponitrile and the amounts of charge of nitrogen atoms in adiponitrile. The amounts of charge of nitrogen atoms in adiponitrile are each −0.46.

Longer carbon chains in succinonitrile, glutaronitrile, and adiponitrile presumably result in larger amounts of charge of nitrogen atoms and strengthen the coordinate bonds with lithium ions. Accordingly, the coordinate bonds between adiponitrile and lithium ions are probably strong.

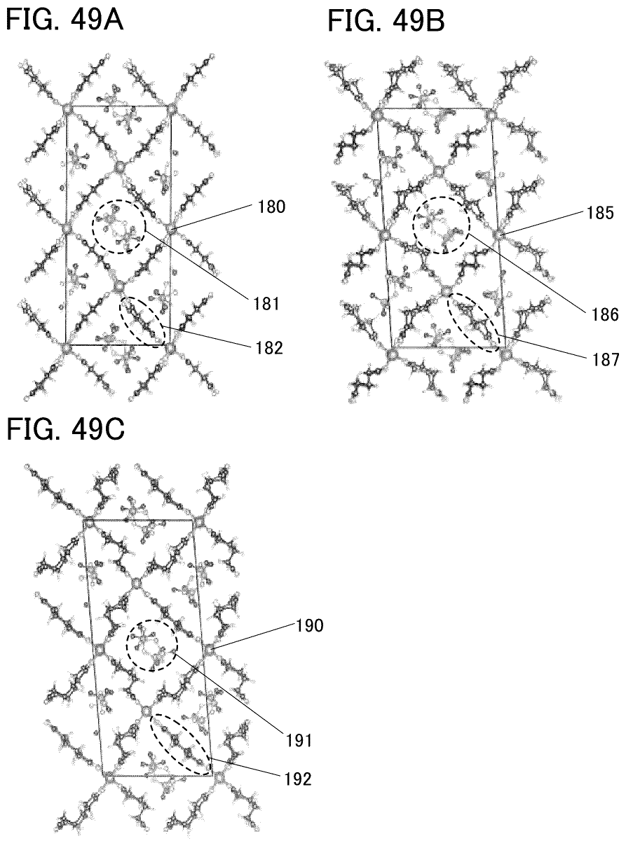

Next, FIG. 49 shows examples of calculation results relating to the stable structures of the composite compounds. The calculation is performed under the calculation conditions shown in Table 2 below.

TABLE 2

| | |
|---|---|
| Software | VASP |
| Functional | GGA + U (DFT-D2) |
| Pseudo potential | PAW |
| Cutoff energy (eV) | 600 |
| Number of atoms | Li(FSI)(SN)₂: |
| | 8 Li atoms, 64 C atoms, 40 N atoms, 32 O atoms, |
| | 16 F atoms, 16 S atoms, and 64 H atoms |
| | Li(FSI)(GN)₂: |
| | 8 Li atoms, 80 C atoms, 40 N atoms, 32 O atoms, |
| | 16 F atoms, 16 S atoms, and 96 H atoms |
| | Li(FSI)(ADN)₂: |
| | 8 Li atoms, 96 C atoms, 40 N atoms, 32 O atoms, |
| | 16 F atoms, 16 S atoms, and 128 H atoms |
| k-points | 1 × 1 × 1 |
| Calculation target | Optimization of lattice and atomic site |

FIG. 49A shows an example of a stable structure of a composite compound containing succinonitrile and lithium bis(fluorosulfonyl)imide. It is found that the composite compound shown in FIG. 49A contains succinonitrile 182, lithium ions 180, and (fluorosulfonyl)imide ions 181.

In the case of the stable structure, it turns out that the composite compound has a partial structure shown in General Formula (G2) below in which a lithium ion has coordinate bonds with cyano groups.

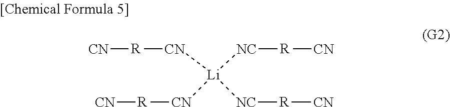

In General Formula (G2) above, R represents a hydrocarbon having 1 to 5 carbon atoms. In General Formula (G2) above, R preferably represents a hydrocarbon having 2 to 4 carbon atoms.

In the case of the stable structure shown in FIG. 49A, the composite compound has a partial structure shown in (H4) below in which a lithium ion has coordinate bonds with succinonitrile.

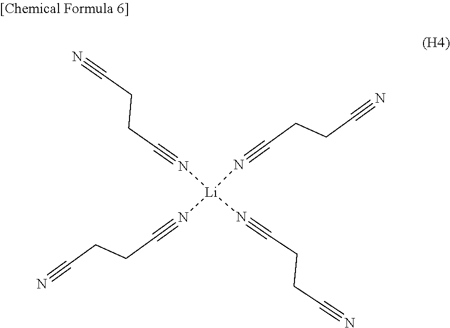

FIG. 49B shows an example of a stable structure of a composite compound containing glutaronitrile and lithium bis(fluorosulfonyl)imide. It is revealed that the composite compound shown in FIG. 49B contains glutaronitrile 187, lithium ions 185, and bis(fluorosulfonyl)imide ions 186. That is, in the case of the stable structure in FIG. 49B, the composite compound has a partial structure in which a lithium ion has coordinate bonds with glutaronitrile.

FIG. 49C shows an example of a stable structure of a composite compound containing adiponitrile and lithium bis(fluorosulfonyl)imide. It is revealed that the composite compound shown in FIG. 49C contains adiponitrile 192, lithium ions 190, and bis(fluorosulfonyl)imide ions 191. That is, in the case of the stable structure in FIG. 49C, the composite compound has a partial structure in which a lithium ion has coordinate bonds with adiponitrile.

Next, a structure example of an all-solid-state secondary battery using the composite compound 117 as an electrolyte will be described. FIG. 2B is a cross-sectional view of a secondary battery 150 that is an all-solid-state secondary battery. The secondary battery 150 does not include a separator and includes the composite compound 117 as an electrolyte; the positive electrode active material 115 and the like at least partly covered with the barrier layer 116 are used as a positive electrode active material; and the first negative electrode active material 125, the second negative electrode active material 129, and the like are used as a negative electrode active material.

The composite compound 117 is mixed with the positive electrode active material 115 and the like, whereby the components on the positive electrode side of the secondary battery 150 can be obtained. The composite compound 117 is placed to fill spaces between positive electrode active material particles. The composite compound 117 is mixed with the first negative electrode active material 125, the second negative electrode active material 129, and the like, whereby the components on the negative electrode side of the secondary battery 150 can be obtained.

Although FIG. 2B illustrates the all-solid-state secondary battery not including a separator, a structure including a separator may be employed.

The contents in this embodiment can be combined with the contents in the other embodiments as appropriate.

### Embodiment 2

In this embodiment, a secondary battery of one embodiment of the present invention will be described. The secondary battery includes at least a positive electrode, a negative electrode, an electrolyte, and an exterior body. A separator may be provided between the positive electrode and the negative electrode. In the positive electrode, a positive electrode active material layer desirably contains a positive electrode active material and a composite compound, and the composite compound is further preferably positioned to cover the surface of the positive electrode active material. The composite compound preferably has crystallinity, e.g., a molecular crystal. The molecular crystal preferably has high ionic conductivity and can be used as an electrolyte. In that case, the composite compound can be referred to as a molecular crystal electrolyte.

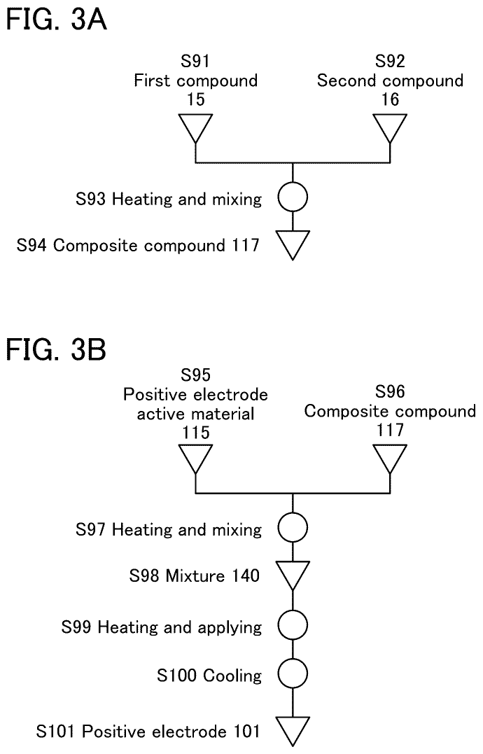

Examples of a method for fabricating the secondary battery of one embodiment of the present invention will be described with reference to FIG. 3 to FIG. 5.

### [Method 1 for Fabricating Positive Electrode]

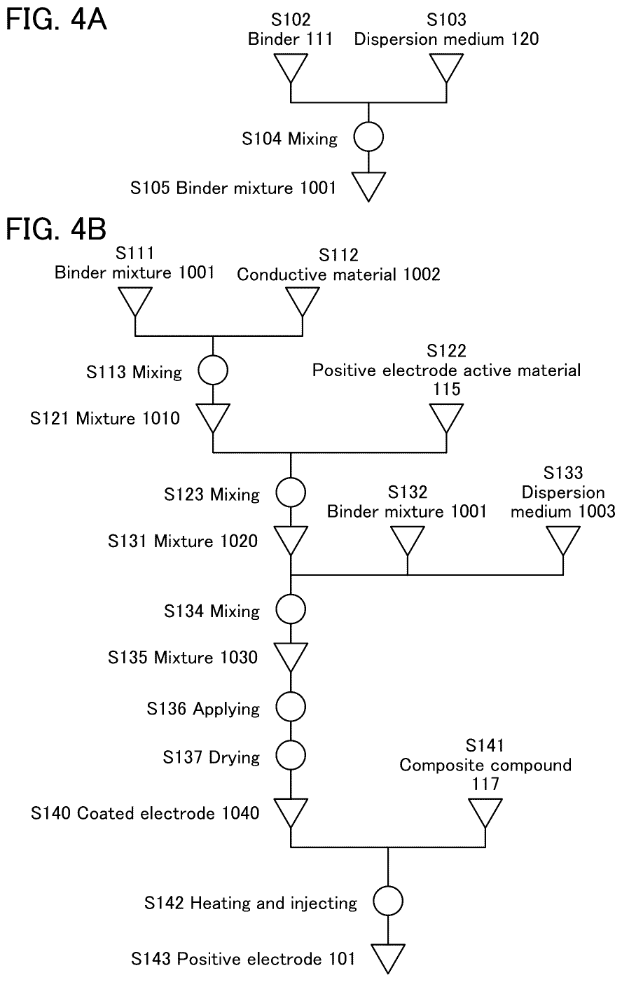

Methods for fabricating the positive electrode of one embodiment of the present invention will be described with reference to FIG. 3 and FIG. 4. The positive electrode active material layer preferably contains a positive electrode active material composite described in Embodiment 3 or a positive electrode active material described in Embodiment 4, and may further contain a composite compound, a conductive material, and the like. The composite compound desirably has a function of a binder that binds a plurality of the positive electrode active material composites to each other or a plurality of the positive electrode active materials to each other. Furthermore, the composite compound desirably allows passage of lithium ions.

In FIG. 3A, a first compound 15 is prepared in Step S91 and a second compound 16 is prepared in Step S92. Next, in Step S93, the first compound 15 and the second compound 16 are mixed while being heated. When the temperature of the heated state can be maintained, mixing may be performed after the heating. The temperature of the heating in Step S93 is desirably higher than or equal to a temperature at which a mixture of the first compound 15 and the second compound 16 is completely melted (e.g., higher than or equal to its melting point). The heating in Step S93 may be multistep heating. After the heating and the mixing in Step S93, the temperature is lowered to room temperature, whereby the composite compound 117 is obtained in Step S94. The composite compound 117 has a molecular crystal, and the positive electrode active material and the like can be covered with the composite compound 117 having a crystal structure.

As the first compound 15, a nitrile solvent can be used; for example, one kind or two or more kinds of acetonitrile, succinonitrile, glutaronitrile, and adiponitrile can be used.

As the second compound 16, one or two or more selected from lithium bis(fluorosulfonyl)imide (Li(FSO₂)₂N, abbreviation: LiFSI), lithium bis(trifluoromethanesulfonyl)imide (Li(CF₃SO₂)₂N, abbreviation: LiTFSI), and lithium bis(pentafluoroethanesulfonyl)imide (Li(C₂F₅SO₂)₂N, abbreviation: LiBETI) can be used.

The composite compound 117 desirably has a function of a binder that fixes a plurality of positive electrode active material composites to each other or a plurality of positive electrode active materials to each other. Furthermore, the composite compound 117 desirably allows passage of lithium ions. The composite compound 117 preferably has crystallinity, and further preferably has a molecular crystal having the first compound 15 and the second compound 16.

The positive electrode active material 115 is prepared in Step S95 in FIG. 3B. As the positive electrode active material 115, the positive electrode active material composite described in Embodiment 3 or the positive electrode active material described in Embodiment 4 is preferably used.

The composite compound 117 is prepared in Step S96 in FIG. 3B. For example, the composite compound 117 formed in FIG. 3A can be used. Instead of preparing the composite compound 117 in Step S96, the first compound 15 in Step S91 and the second compound 16 in Step S92 in FIG. 3A may be prepared as they are.

Next, in Step S97, the positive electrode active material 115 and the composite compound 117 are mixed while being heated, whereby a mixture 140 is obtained in Step S98. The mixture 140 is sometimes referred to as positive electrode slurry. The mixture 140 can also be obtained in Step S98 in such a manner that the positive electrode active material 115, the first compound 15, and the second compound 16 in Step S92 are mixed while being heated in Step S97.

When the temperature of the heated state in Step S97 can be maintained, mixing may be performed after the heating. In Step S99, heating and application to a current collector are performed. Through cooling in Step S100, the positive electrode 101 is obtained in Step S101. The composite compound 117 is preferably a solid in the positive electrode 101.

Note that Step S97 may be a step of heating the positive electrode active material 115, the first compound 15, and the second compound 16 while they are mixed.

In Step S97, a conductive material as well as the positive electrode active material 115 and the composite compound 117 may be mixed. For example, one or two or more selected from carbon black such as acetylene black or furnace black, graphite such as artificial graphite or natural graphite, carbon fiber such as carbon nanofiber or carbon nanotube, graphene, and a graphene compound can be used as the conductive material.

In this specification and the like, graphene includes single-layer graphene and multilayer graphene (also referred to as multi graphene). In this specification and the like, a graphene compound includes graphene oxide, multilayer graphene oxide, reduced graphene oxide, reduced multilayer graphene oxide, and the like. Graphene contains carbon, has a plate-like shape, a sheet-like shape, or the like, and has a two-dimensional structure formed of a six-membered ring composed of carbon atoms. Graphene may be referred to as a carbon sheet. Graphene or a graphene compound preferably has a bent shape. A graphene compound preferably has a functional group. Graphene or a graphene compound may be rounded to have a cylindrical shape.

The temperature of the heating in each of Step S97 and Step S99 is desirably higher than or equal to a temperature at which the composite compound 117 is completely melted. In the case where Li(FSI)(SN)₂ is used as the composite compound 117, for example, the temperature of the heating is preferably higher than or equal to 60° C. and lower than or equal to 100° C., further preferably higher than or equal to 65° C. and lower than or equal to 80° C. Note that the heating temperature in Step S97 is not necessarily the same as the heating temperature in Step S99, and the heating temperature in Step S97 is preferably higher than the heating temperature in Step S99. In Step S97 and Step S99, the composite compound 117 is preferably a liquid.

The positive electrode current collector can be formed using a material having high conductivity, such as a metal like stainless steel, gold, platinum, aluminum, or titanium, or an alloy thereof. It is preferable that a material used for the positive electrode current collector not be dissolved at the potential of the positive electrode. For the positive electrode current collector, it is also possible to use an aluminum alloy to which an element that improves heat resistance, such as silicon, titanium, neodymium, scandium, or molybdenum, is added. The positive electrode current collector can have a foil-like shape, a plate-like shape, a sheet-like shape, a net-like shape, a punching-metal shape, an expanded-metal shape, or the like as appropriate. The positive electrode current collector preferably has a thickness greater than or equal to 5 μm and less than or equal to 30 μm.

### [Method 2 for Fabricating Positive Electrode]

Next, as one embodiment of the present invention, a method different from that in Method 1 for fabricating positive electrode will be described.

In FIG. 4A, a binder 111 is prepared in Step S102 and a dispersion medium 120 is prepared in Step S103.

As the binder 111, for example, one or two or more selected from materials such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, and nitrocellulose can be used. The lithium ion conductivity of the material used as the binder is preferably lower than the lithium ion conductivity of the composite compound 117.

As the dispersion medium 120, for example, one or two or more selected from water, methanol, ethanol, acetone, tetrahydrofuran (THF), dimethylformamide (DMF), N-methylpyrrolidone (NMP), and dimethyl sulfoxide (DMSO) can be used, and the dispersion medium 120 containing two or more of them is sometimes referred to as a mixed solution. A combination of polyvinylidene fluoride (PVDF) and N-methylpyrrolidone (NMP) is preferably used as the combination of the binder 111 and the dispersion medium 120.

Next, the binder 111 and the dispersion medium 120 are mixed in Step S104, whereby a mixture is obtained in Step S105. This mixture is referred to as a binder mixture 1001 to be distinguished from other mixtures. As a mixing means, for example, a propeller mixer, a planetary mixer, or a thin-film spin mixer can be used. In the binder mixture 1001, the binder 111 is desirably dispersed well in the dispersion medium 120.

The binder mixture 1001 is prepared in Step S111 and a conductive material 1002 is prepared in Step S112 in FIG. 4B. In order to perform stiff kneading in a later step, the amount of the binder mixture 1001 prepared in Step S111 is smaller than the total amount of the binder mixture 1001 required for forming a positive electrode active material layer to achieve a suitable mixing amount for stiff kneading. In this case, an additional binder mixture 1001 is preferably added in a step after the stiff kneading for a shortage of the binder mixture 1001. Note that stiff kneading refers to mixing of a high-viscosity mixture.

For example, one or two or more selected from carbon black such as acetylene black or furnace black, graphite such as artificial graphite or natural graphite, carbon fiber such as carbon nanofiber or carbon nanotube, graphene, and a graphene compound can be used as the conductive material 1002.

Next, the binder mixture 1001 and the conductive material 1002 are mixed in Step S113 to obtain a mixture 1010 in Step S121. As a mixing means, for example, a propeller mixer, a planetary mixer, or a thin-film spin mixer can be used.

Next, the positive electrode active material 115 is prepared in Step S122 in FIG. 4B.

Next, the mixture 1010 and the positive electrode active material 115 are mixed in Step S123 to obtain a mixture 1020 in Step S131. As a mixing means, for example, a propeller mixer, a planetary mixer, or a thin-film spin mixer can be used. In the case where the viscosity is appropriately adjusted in Step S123, it is possible to perform stiff kneading and separate an aggregation of a powder of the positive electrode active material or the like by the stiff kneading.

Next, the binder mixture 1001 is prepared in Step S132, and a dispersion medium 1003 is prepared in Step S133. In the case where the amount of the binder mixture 1001 prepared in Step S111 is smaller than the total amount required for forming the positive electrode active material layer, an additional binder mixture 1001 can be added in Step S132 for a shortage of the binder mixture 1001. In the case where the dispersion medium of the binder mixture 1001 is prepared, a dispersion medium similar to that in Step S102 in FIG. 4A can be prepared as the dispersion medium 1003. It is desirable to adjust the amount of the dispersion medium 1003 to be prepared such that the viscosity is appropriate for application in a later step. In the case where the total amount of the binder mixture 1001 required for forming the positive electrode active material layer is prepared in Step S111, it is unnecessary to prepare the binder mixture 1001 in Step S132. That is, in the case where the total amount of the binder mixture 1001 required for forming the positive electrode active material layer is prepared in Step S111, Step S132, Step S133, and Step S134 can be omitted.

Next, the mixture 1020 of Step S131, the binder mixture 1001 prepared in Step S132, and the dispersion medium 1003 prepared in Step S133 are mixed in Step S134 to obtain a mixture 1030 in Step S135. The mixture 1030 is sometimes referred to as positive electrode slurry.

Next, the mixture 1030 is applied to a positive electrode current collector in Step S136. The positive electrode current collector can be formed using a material that has high conductivity, such as a metal like stainless steel, gold, platinum, aluminum, or titanium, or an alloy thereof. It is preferable that a material used for the positive electrode current collector not be dissolved at the potential of the positive electrode. For the application method in Step S136, a slot die method, gravure, a blade method, or a combination of any of them can be used, for example. Furthermore, a continuous coater or the like may be used for the application. Subsequent to Step S136, the mixture 1030 applied to the positive electrode current collector is dried in Step S137. As the drying method, for example, one or two or more selected from batch-type methods using a hot plate, a drying furnace, a circulation drying furnace, a vacuum drying furnace, and the like, and sequential-type methods using a combination of warm-air drying, infrared drying, and the like with a continuous coater can be used. After the drying, a coated electrode 1040 is obtained in Step S140.

Next, the composite compound 117 in Step S112 in FIG. 3A is prepared in Step S141 in FIG. 4B.

Next, in Step S142 in FIG. 4B, the coated electrode 1040 in Step S140 and the composite compound 117 are heated, so that the composite compound 117 can be injected into spaces included in the coated electrode 1040. The temperature of the heating is desirably higher than or equal to a temperature at which the composite compound 117 is completely melted. For the injection method, one or two or more selected from dropping methods such as a slot die method, gravure, a blade method, and ODF (One Drop Filling), a flat plate press method, roll press, a combination of any of them, and the like can be used. The injection is desirably performed in a reduced pressure environment, in which case the spaces included in the coated electrode 1040 can be effectively infiltrated with the composite compound 117. In the case where Li(FSI)(SN)₂ is used as the composite compound 117, for example, the temperature of the heating is higher than or equal to 60° C. and lower than or equal to 100° C., preferably higher than or equal to 65° C. and lower than or equal to 80° C.

The positive electrode active material adheres to the positive electrode current collector or another positive electrode active material with the binder mixed earlier. By injection of the liquid composite compound 117 into the positive electrode active material in this state, the spaces can be efficiently infiltrated with the composite compound 117. The composite compound 117 becomes a solid at room temperature and thus can serve as a binder. The composite compound 117 preferably has high ionic conductivity. Such a structure can reduce the proportion of the binder and can increase the proportion of the positive electrode active material in the conventional positive electrode. A press step is sometimes performed on the coated electrode at the time of fabricating the positive electrode, and the above injection performed in the reduced pressure environment can reduce the press pressure. In addition, the injection performed in the reduced pressure environment can eliminate the need for the press step.

Through the above steps, the positive electrode 101 of one embodiment of the present invention shown in FIG. 4B can be fabricated (Step S143).

### [Method for Fabricating Negative Electrode]

The negative electrode can be fabricated by a method similar to the methods for fabricating the positive electrode 101 shown in FIG. 3 and FIG. 4. In the case where the negative electrode 102 is fabricated using the fabrication methods shown in FIG. 3 and FIG. 4, a negative electrode active material is prepared instead of the positive electrode active material 115 prepared in Step S121 in FIG. 3B and the positive electrode active material 115 prepared in Step S122 in FIG. 4B.

As the negative electrode active material, an alloy-based material, a carbon-based material, or a mixture thereof can be used, for example.

As the negative electrode active material, an element that enables charge and discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a composite compound containing any of the above elements may be used as the negative electrode active material. Examples of the composite compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium, a composite compound containing the element, and the like may be referred to as an alloy-based material.

In this specification and the like, SiO refers to silicon monoxide, for example. Note that SiO can alternatively be expressed as SiOₓ. Here, it is preferred that x be 1 or have an approximate value of 1. For example, x is preferably more than or equal to 0.2 and less than or equal to 1.5, further preferably more than or equal to 0.3 and less than or equal to 1.2.

A carbon-based material may be used as the negative electrode active material. As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferable because it may have a spherical shape. Moreover, MCMB is preferable because it can relatively easily have a small surface area. Examples of natural graphite include flake graphite and spherical natural graphite.

Graphite has a low potential substantially equal to that of a lithium metal when lithium ions are intercalated into graphite. For this reason, a lithium-ion secondary battery using graphite can have a high operating voltage. In addition, graphite is preferred because of its advantages such as a relatively high capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₂), niobium pentoxide (Nb₂O₅), tungsten oxide (WO₂), or molybdenum oxide (MoO₂) can be used.

As the negative electrode active material, a lithium-graphite intercalation composite compound (LiₓC₆), SiC, or the like can be used.

Alternatively, as the negative electrode active material, Li₃₋ₓMₓN (M is Co, Ni, or Cu) with a Li₃N structure, which is a nitride of lithium and a transition metal, can be used. For example, Li_{2.6}Co_{0.4}N₃ is preferable because of high discharge capacity (900 mAh/g and 1890 mAh/cm³).

A nitride of lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the nitride of lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those for the conductive material and the binder that can be included in the positive electrode active material layer can be used.

For the negative electrode current collector, copper or the like can be used in addition to a material similar to that for the positive electrode current collector. Note that a material that is not alloyed with carrier ions of lithium or the like is preferably used for the negative electrode current collector.

The negative electrode can be fabricated by using the above-described negative electrode active material and the like in accordance with FIG. 3A and FIG. 3B. In that case, the negative electrode 102 can be obtained in Step S130 in FIG. 3B. In addition, the negative electrode can be fabricated by using the above-described negative electrode active material and the like in accordance with FIG. 4A and FIG. 4B. In that case, the negative electrode 102 can be obtained in Step S143 in FIG. 4B.

### [Method 1 for Fabricating Secondary Battery]

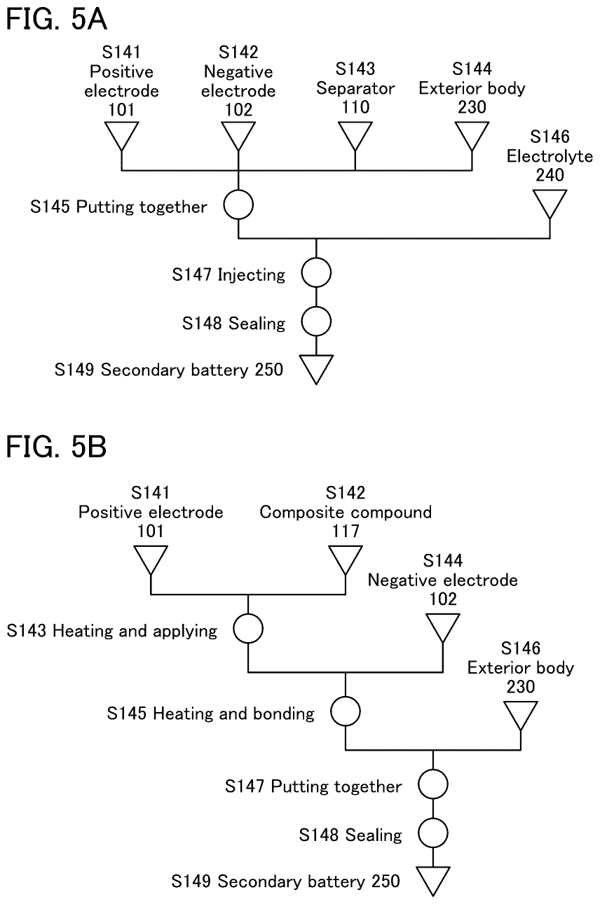

Methods for fabricating the secondary battery of one embodiment of the present invention will be described with reference to FIG. 5A and FIG. 5B.

In FIG. 5A, the positive electrode 101 is prepared in Step S141, the negative electrode 102 is prepared in Step S142, the separator 110 is prepared in Step S143, and an exterior body 230 is prepared in Step S144.

The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, polyimide, acrylic, polyolefin, or polyurethane.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the above-described material is coated with the ceramic-based material, the oxidation resistance is improved; hence, deterioration of the separator in charge at a high voltage can be suppressed and thus the reliability of the secondary battery can be improved. When the above-described material is coated with the fluorine-based material, the separator is easily brought into close contact with an electrode, resulting in high output characteristics. When the above-described material is coated with the poly amide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

For the exterior body, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of polyethylene, polypropylene, polycarbonate, ionomer, polyamide, or the like and an insulating synthetic resin film of a polyamide-based resin, a polyester-based resin, or the like is provided over the metal thin film as the outer surface of the exterior body.

Next, the positive electrode 101, the negative electrode 102, the separator 110, and the exterior body 230 are put together in Step S145. The separator 110 is placed between the positive electrode 101 and the negative electrode 102. The separator may be processed into a bag-like shape to enclose one of the positive electrode 101 and the negative electrode 102. Next, the positive electrode 101, the negative electrode 102, and the separator 110 are placed inside the exterior body 230. At this time, the exterior body 230 desirably has an opening portion for injection of an electrolyte. Note that an electrode terminal such as a lead may be provided as appropriate depending on the shape of a battery to be fabricated.

Next, an electrolyte 240 is prepared in Step S146.

As one mode of the electrolyte 240, an electrolyte solution containing a solvent and an electrolyte dissolved in the solvent can be used. As the solvent of the electrolyte solution, an aprotic organic solvent is preferably used. For example, one or two or more selected from ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used.

Alternatively, the use of one or more kinds of ionic liquids (room temperature molten salts) which have features of non-flammability and non-volatility as the solvent of the electrolyte solution can prevent a secondary battery from exploding, catching fire, and the like even when the secondary battery internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one or two or more lithium salts selected from LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, lithium bis(oxalate)borate (Li(C₂O₄)₂, LiBOB), and the like can be used.

The electrolyte solution is preferably highly purified and contains a small amount of dust particles and elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

Furthermore, one or two or more additive agents selected from vinylene carbonate, propane sultone (PS), tert-butylbenzene (TBB), fluoroethylene carbonate (FEC), lithium bis(oxalate)borate (LiBOB), and dinitrile composite compounds such as succinonitrile and adiponitrile may be added to the electrolyte solution. The additive agent concentration in the solvent in which the electrolyte is dissolved is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, the secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Next, in Step S147, the electrolyte 240 is injected from the opening portion of the exterior body 230. Next, in Step S148, the opening portion of the exterior body 230 is sealed. Note that the injection in Step S147 and the sealing in Step S148 may be performed in a reduced pressure atmosphere.

Through the above steps, a secondary battery 250 can be fabricated in Step S149.

### [Method 2 for Fabricating Secondary Battery]

Next, as one embodiment of the present invention, a method different from that in Method 1 for fabricating secondary battery will be described.

In FIG. 5B, the positive electrode 101 is prepared in Step S141 and the composite compound 117 is prepared in Step S142. The positive electrode 101 fabricated by the fabrication method in FIG. 4B is preferably used as the positive electrode 101.

Next, in Step S143, the composite compound 117 is brought into a melted state by heating and then applied to the active material layer of the positive electrode 101. For the application method, one or two or more selected from a slot die method, gravure, a blade method, a combination of any of them, and the like can be used. Furthermore, a continuous coater or the like may be used for the application. Through Step S143, a layer containing the composite compound 117 can be formed over the positive electrode 101. The layer containing the composite compound 117 has a function of a separator that prevents direct contact between the positive electrode 101 and the negative electrode 102 and a function of a solid electrolyte capable of lithium ion conduction between the positive electrode 101 and the negative electrode 102.

Next, the negative electrode 102 is prepared in Step S144. The negative electrode 102 fabricated in accordance with the method for fabricating the negative electrode shown in FIG. 4B is preferably used as the negative electrode 102.

Next, heating and bonding are performed in Step S145. The negative electrode 102 is stacked over the component formed in Step S143 including the layer of the composite compound 117 over the positive electrode 101, and this stack is heated for bonding. The temperature of the heating in Step S145 is desirably lower than or equal to a temperature at which the composite compound 117 is completely melted. That is, the temperature of the heating in Step S145 is desirably lower than that of the heating in Step S143. In the case where Li(FSI)(SN)₂ is used as the composite compound 117, for example, the temperature of the heating can be higher than or equal to 55° C. and lower than or equal to 65° C.

Next, the exterior body 230 is prepared in Step S146.

Next, the positive electrode 101, the negative electrode 102, and the composite compound 117 that are bonded to each other and the exterior body 230 are put together in Step S147. Note that an electrode terminal such as a lead may be provided as appropriate depending on the shape of a battery to be fabricated.

Next, the exterior body 230 is sealed in Step S148. The sealing is desirably performed in a reduced pressure atmosphere. The exterior body 230 including the positive electrode 101, the negative electrode 102, and the composite compound 117 is preferably heated and pressed from the outside at the time of the sealing, in which case the space inside the positive electrode, the negative electrode, or the exterior body can be reduced.

Note that instead of the composite compound 117 prepared in Step S142, a solid electrolyte containing an inorganic material such as a sulfide-based or oxide-based inorganic material, or a solid electrolyte containing a high-molecular material such as a PEO (polyethylene oxide)-based high-molecular material can be used as the electrolyte.

Through the above steps, the secondary battery 250 can be fabricated in Step S149.

As described above, the secondary battery fabricated in Method 2 for fabricating secondary battery can be referred to as an all-solid-state secondary battery. An all-solid-state secondary battery is a lithium-ion secondary battery having a high level of safety and excellent characteristics.

The contents described in this embodiment can be combined with the contents described in the other embodiments.

### Embodiment 3

Described in this embodiment are a positive electrode active material composite that can be used as the positive electrode active material 115 of one embodiment of the present invention, a formation method thereof, a positive electrode, and a fabrication method thereof.

A positive electrode includes a positive electrode active material layer and a positive electrode current collector. The positive electrode active material layer includes a positive electrode active material composite 100z containing a first material 100x functioning as a positive electrode active material and a second material 100y covering at least part of the first material 100x. The second material 100y can function as the barrier layer 116 described above in Embodiment 1 and the like. Note that the barrier layer is sometimes referred to as a coating layer. The positive electrode active material layer may further contain a conductive material and a binder. A composite compound may be contained as the binder. In the case where the composite compound is contained as the binder, the composite compound 117 can be placed outside the second material 100y.

The positive electrode active material composite 100z is obtained through a composite-making process using at least the first material 100x and the second material 100y. As the second material 100y, an active material capable of receiving and releasing lithium may be used. As the composite-making process, one or two or more of composite-making processes selected from composite-making processes utilizing mechanical energy such as a mechanochemical method, a mechanofusion method, and a ball mill method; composite-making processes utilizing a liquid phase reaction such as a coprecipitation method, a hydrothermal method, and a sol-gel method; and composite-making processes utilizing a gas phase reaction such as a barrel sputtering method, an ALD (Atomic Layer Deposition) method, an evaporation method, and a CVD (Chemical Vapor Deposition) method can be used, for example. Note that the composite-making process in this specification is also referred to as a surface coating process or a coating process.

Heat treatment is preferably performed after the composite-making process. In the case where heat treatment is performed after the composite-making process, the second material 100y covering at least part of the first material 100x functioning as a positive electrode active material sinters or melts and spreads. Thus, an effect of reducing areas where the first material 100x is directly in contact with an electrolyte can be expected. However, when the temperature of the heat treatment after the composite-making process is too high, elements contained in the second material 100y diffuse into the first material 100x more than necessary, in which case the chargeable/dischargeable capacity of the first material 100x as an active material might be reduced and an effect of the second material 100y as the barrier layer might be reduced. Hence, when heat treatment is performed after the composite-making process, the heating temperature, heating time, and heating atmosphere are preferably set appropriately.

### [Positive Electrode Active Material]

As the first material 100x, a composite oxide that is represented by LiM1O₂ (M1 is one or two or more selected from Fe, Ni, Co, Mn, and Al) and has a layered rock-salt crystal structure can be used. Alternatively, as the first material 100x, a composite oxide which is represented by LiM1O₂ and to which an additive element X is added can be used. As the additive element X contained in the first material 100x, it is preferable to use one or two or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic. These elements further stabilize the crystal structure of the first material 100x in some cases. In order to further stabilize the crystal structure, the additive element X is preferably positioned in the surface portion of the positive electrode active material. That is, a region containing the additive element X is positioned in the surface portion. The region containing the additive element X positioned in the surface portion can serve as the barrier layer 116. Furthermore, the barrier layer 116 includes the region containing the additive element X and can also contain the second material 100y outside the region.

The first material 100x to which the additive element X is added as described above can contain lithium cobalt oxide to which magnesium and fluorine are added, lithium cobalt oxide to which magnesium, fluorine, aluminum, and nickel are added, lithium cobalt oxide to which magnesium, fluorine, and titanium are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-cobalt-manganese oxide to which magnesium and fluorine are added, or the like. The region containing the additive element can be used as the barrier layer 116. Note that as for the proportions of the transition metals of the lithium nickel-cobalt-manganese oxide, the proportion of nickel is preferably high; for example, a material with a ratio of nickel:cobalt:manganese=8:1:1 and the neighborhood thereof or nickel:cobalt:manganese=9:0.5:0.5 and the neighborhood thereof is preferred. Lithium nickel-cobalt-manganese oxide to which calcium is added is preferably contained as the above-described lithium nickel-cobalt-manganese oxide.

Alternatively, as the first material 100x, a material in which secondary particles of the composite oxide represented by LiM1O₂ (M1 is one or more selected from Fe, Ni, Co, Mn, and Al) are coated with a metal oxide may be used. As the metal oxide, an oxide of one or two or more of metals selected from Al, Ti, Nb, Zr, La, and Li can be used. For example, a composite oxide in which secondary particles of the composite oxide represented by LiM1O₂ (M1 is one or more selected from Fe, Ni, Co, Mn, and Al) are coated with aluminum oxide (such a composite oxide is sometimes referred to as a metal-oxide-coated composite oxide) can be used as the first material 100x. For example, a metal-oxide-coated composite oxide in which secondary particles of lithium nickel-cobalt-manganese oxide with a ratio of nickel:cobalt:manganese=8:1:1 or nickel:cobalt:manganese=9:0.5:0.5 are coated with aluminum oxide can be used. A region containing a metal oxide such as aluminum oxide can be used as the barrier layer 116.

Here, the thickness of the region where the second material 100y is positioned that functions as the barrier layer is preferably small and, for example, larger than or equal to 1 nm and smaller than or equal to 200 nm, further preferably larger than or equal to 1 nm and smaller than or equal to 100 nm.

As the method for forming the first material 100x, a formation method described later in Embodiment 4 can be used.

As the second material 100y, one or two or more of an oxide and LiM2PO₄ (M2 is one or more selected from Fe, Ni, Co, and Mn) having an olivine crystal structure can be used. Oxides often have a stable crystal structure, and examples of the oxides include aluminum oxide, zirconium oxide, hafnium oxide, and niobium oxide. In addition, LiM2PO₄ often has a stable crystal structure, and examples of LiMPO₄ include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCO_{b}PO₄, LiNiₐMn_{b}PO₄ (a+b≤K 1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≤1, 0<c<1, 0<d<1, and 0<e<1), and LiFe_{f}Ni_{g}CoₕMnᵢPO₄ (f+g+h+i≤1, 0<f<1, 0<g<1, 0<h<1, and 0<i<1).

In the case where the second material 100y has a particle form, a carbon coating layer may be provided on the surface of the particle.

### [Positive Electrode Active Material Composite]

In this embodiment, an example of a method for forming a positive electrode active material composite in which at least part of the particle surface of the particulate first material 100x functioning as a positive electrode active material is covered with the second material 100y is described as a method 1 for forming a positive electrode active material composite. For the positive electrode active material composite, a structure in which at least part of the particle surface of the particulate first material 100x is covered with the second material 100y is desirable, and a structure in which substantially the entire particle surface of the particulate first material 100x is covered with the second material 100y is further desirable. Here, the state where substantially the entire particle surface is covered refers to a state where the second material 100y is positioned such that the first material 100x is not directly in contact with the electrolyte.

A structure in which substantially the entire particle surface of the first material 100x is covered with the second material 100y through the composite-making process might have charge and discharge characteristics different from those of a structure in which the second material 100y and the first material 100x are simply mixed.

When at least part of the particle surface, desirably, substantially the entire particle surface of the first material 100x functioning as a positive electrode active material is covered with the second material 100y, a region where the first material 100x is directly in contact with the electrolyte becomes small, which can inhibit release of a transition metal element and/or oxygen from the first material 100x even in a high-voltage charged state and thus can inhibit a capacity decrease due to repeated charge and discharge.

With the use of a material with a stable crystal structure as the second material 100y, effects such as inhibition of release of a transition metal element and/or oxygen from the first material 100x even in a high-voltage charged state, an improvement in stability at high temperatures, and an improvement in fire resistance can be obtained in the secondary battery of one embodiment of the present invention.

As the first material 100x, lithium cobalt oxide to which magnesium and/or fluorine are/is added or lithium cobalt oxide to which magnesium, fluorine, aluminum, and/or nickel are/is added is preferably used. Note that magnesium, fluorine, and aluminum have a feature of existing in a surface portion of a positive electrode active material in a large amount, and nickel has a feature of widely distributing throughout a positive electrode active material. As the first material 100x, it is preferable to use secondary particles of lithium nickel-cobalt-manganese oxide with a ratio of nickel:cobalt:manganese=8:1:1 and the neighborhood thereof or nickel:cobalt:manganese=9:0.5:0.5 and the neighborhood thereof, for example. A positive electrode active material composite formed using a metal-oxide-coated composite oxide in which the above first material 100x is coated with aluminum oxide has excellent stability in a high-voltage charged state. Thus, the durability and stability of the positive electrode active material in high-voltage charge can be further improved. In addition, the secondary battery using the positive electrode active material composite can have further improved heat resistance and/or fire resistance.

A positive electrode active material that has been subjected to initial heating described later exhibits remarkably excellent repetitive charge and discharge characteristics at a high voltage and is thus particularly preferred as the first material 100x.

In this embodiment, the positive electrode of the present invention may have a structure in which at least part of the surface of the positive electrode active material composite is covered with graphene or a graphene compound. It is preferable that 80% or more of the surface of the positive electrode active material composite and/or 80% or more of an aggregate including the positive electrode active material composite be covered with graphene or a graphene compound.

### [Method for Forming Positive Electrode Active Material Composite]

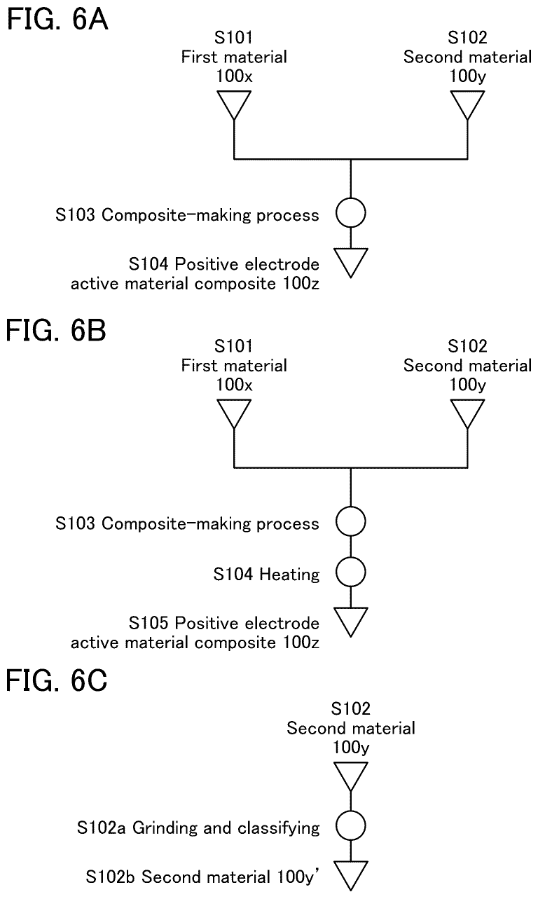

An example of a method for forming the positive electrode active material composite of one embodiment of the present invention will be described with reference to FIG. 6. As the method for forming the positive electrode active material composite, a formation method for the case of performing a composite-making process on the second material 100y and the first material 100x using mechanical energy will be described. Note that the present invention should not be interpreted as being limited to the following description.

In FIG. 6A, the first material 100x is prepared in Step S101 and the second material 100y is prepared in Step S102.

As the first material 100x, it is possible to use a composite oxide represented by LiM1O₂ (M1 is one or more selected from Fe, Ni, Co, Mn, and Al) to which the additive element X is added, which is formed by a formation method described later in Embodiment 4, e.g., lithium cobalt oxide to which magnesium and fluorine are added or lithium cobalt oxide to which magnesium, fluorine, aluminum, and nickel are added. In particular, lithium cobalt oxide to which magnesium, fluorine, aluminum, and nickel are added and which is subjected to initial heating described in Embodiment 4 is preferred. As another example of the first material 100x, lithium nickel-cobalt-manganese oxide can be used. Here, as for the proportions of the transition metals of the lithium nickel-cobalt-manganese oxide, the proportion of nickel is preferably high; e.g., a material with a ratio of nickel:cobalt:manganese=8:1:1 and the neighborhood thereof or nickel:cobalt:manganese=9:0.5:0.5 and the neighborhood thereof is preferred. As another example of the first material 100x, a metal-oxide-coated composite oxide in which secondary particles of lithium nickel-cobalt-manganese oxide are coated with aluminum oxide can be used. Here, the thickness of the aluminum oxide is preferably small; for example, the thickness of the aluminum oxide is greater than or equal to 1 nm and less than or equal to 200 nm, further preferably greater than or equal to 1 nm and less than or equal to 100 nm.

As already described above, LiM2PO₄ (M2 is one or more selected from Fe, Ni, Co, and Mn) can be used as the second material 100y. Alternatively, an oxide can be used as the second material 100y. As the oxide, for example, one or two or more selected from aluminum oxide, zirconium oxide, hafnium oxide, niobium oxide, and the like can be used. The above-described material, e.g., LiFePO₄, LiMnPO₄, LiFeₐMn_{b}PO₄ (a+b≤1, 0<a<1, and 0<b<1), or LiFeₐNi_{b}PO₄ (a+b≤1, 0<a<1, and 0<b<1) can be used as LiM2PO₄. In the case where the second material 100y is a particle, a carbon coating layer may be provided on the surface of the particle.

Note that a material functioning as a positive electrode active material can be used as the second material 100y. In that case, it is possible to select, as a combination of the first material 100x and the second material 100y, a combination that is unlikely to generate a step in a charge-discharge curve in accordance with characteristics required for a secondary battery or a combination that generates a step in a charge-discharge curve in a desired charge rate. Note that a step in a charge-discharge curve is sometimes referred to as a plateau, and includes a region where an output can be stably extracted.

Next, in Step S103, a composite-making process of the first material 100x and the second material 100y is performed. In the case of performing the composite-making process by using mechanical energy, the composite-making process can be performed by a mechanochemical method. Alternatively, the composite-making process may be performed by a mechanofusion method.

In the case where a ball mill is used for the composite-making process in Step S103, zirconia balls are preferably used as media, for example. As the ball mill process, a dry process is desired. In the case of performing a wet process as the ball mill process, acetone can be used. In the case of performing a wet ball mill process, it is preferable to use dehydrated acetone with a moisture content of 100 ppm or lower, desirably 10 ppm or lower.

Through the composite-making process in Step S103, at least part of, desirably substantially the entire particle surface of the particulate first material 100x can be covered with the second material 100y.

Through the above steps, the positive electrode active material composite 100z of one embodiment of the present invention shown in FIG. 6A can be formed (Step S104).

Next, FIG. 6B shows a formation method different from that in FIG. 6A. In FIG. 6B, the steps up to Step S103 are the same as those in the formation method shown in FIG. 6A, and heat treatment is performed in Step S104 after Step S103. The heating in Step S104 is performed in an oxygen-containing atmosphere at higher than or equal to 400° C. and lower than or equal to 950° C., preferably higher than or equal to 450° C. and lower than or equal to 800° C., for longer than or equal to 1 hour and shorter than or equal to 60 hours, preferably for longer than or equal to 2 hours and shorter than or equal to 20 hours.

Through the above steps, the positive electrode active material composite 100z of one embodiment of the present invention shown in FIG. 6B can be formed (Step S105).

Note that in order to obtain a favorable coating state in the composite-making process, the ratio of the particle diameter of the second material 100y to the particle diameter of the first material 100x (the particle diameter of the second material 100y/the particle diameter of the first material 100x) is preferably greater than or equal to 1/200 and less than or equal to 1/50, further preferably greater than or equal to 1/200 and less than or equal to 1/100. To adjust the particle diameter of the second material 100y, a microparticulation process shown in FIG. 6C may be performed. At the time of preparing the second material 100y in Step S102 in FIG. 6A and FIG. 6B, the microparticulation process is performed by grinding and classification in Step S102a in FIG. 6C. Through the microparticulation process, a second material 100y′ with an adjusted particle diameter can be obtained in Step S102b.

### [Calculation on Positive Electrode Active Material Composite]

As an example of the positive electrode active material composite, a structure in which LiCoO₂ with a layered rock-salt structure is used as the first material and LiFePO₄, LiCoO₂, LiFe_{0.5}Mn_{0.5}PO₄, or LiFe_{0.5}Ni_{0.5}PO₄ with an olivine structure is used as the second material is evaluated by density functional theory (DFT). Specifically, a structure with a combination of LiCoO₂ and LiFePO₄ and a structure with a combination of LiCoO₂ and LiFe_{0.5}Mn_{0.5}PO₄ or LiFe_{0.5}Ni_{0.5}PO₄ are optimized by DFT and evaluated. The main calculation conditions are listed in Table 3.

TABLE 3

| Software | VASP | |
|---|---|---|
| Functional | GGA + U (DFT-D2) | |
| Pseudo potential | PAW | |
| Cutoff energy (eV) | 600 | |
| U potential | Mn | 4.64 |
| | Fe | 4.90 |
| | Co | 4.91 |
| | Ni | 5.26 |

| | |
|---|---|
| Number of atoms | 52 Li atoms, 40 Co atoms, 6 Fe atoms, 6 atoms |
| | of Fe, Mn, or Ni, 12 P atoms, and 128 O atoms |
| k-points | 1 × 1 × 1 |
| Calculation target | Optimization of lattice and atomic site |

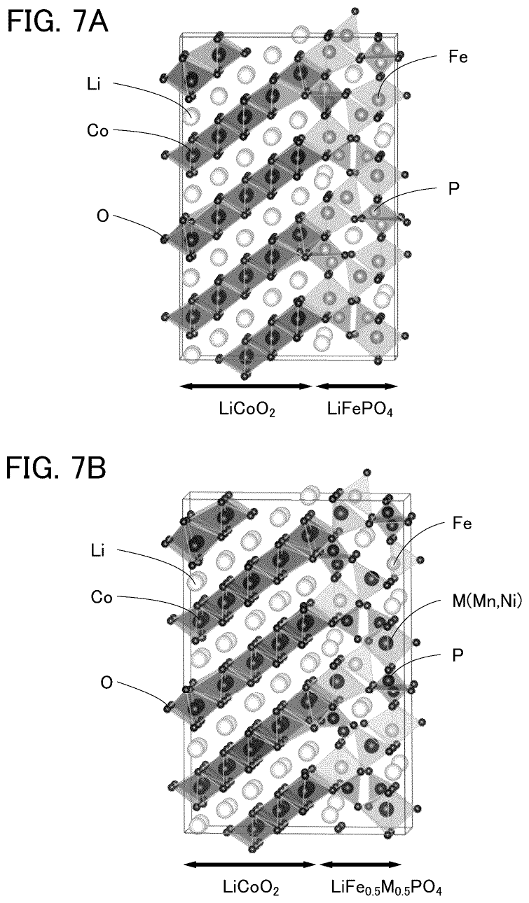

FIG. 7A shows an initial state of a model used for the calculation of the structure with the combination of LiCoO₂ and LiFePO₄. FIG. 7B shows an initial state of a model used for the calculation of the structure with the combination of LiCoO₂ and LiFe_{0.5}Mn_{0.5}PO₄ or LiFe_{0.5}Ni_{0.5}PO₄. In FIG. 7B, LiFe_{0.5}Mn_{0.5}PO₄ or LiFe_{0.5}Ni_{0.5}PO₄ is denoted as LiFe_{0.5}M_{0.5}PO₄. Note that LiFePO₄ and LiFe_{0.5}Mn_{0.5}PO₄ or LiFe_{0.5}Ni_{0.5}PO₄ can each be used as the barrier layer 116.

FIG. 7A shows the structure with the combination of LiCoO₂ and LiFePO₄ as the initial state of the model used for the calculation. FIG. 7B shows the structure with the combination of LiCoO₂ and LiFe_{0.5}MPO₄ (M is Mn or Ni, specifically, LiFe_{0.5}Mn_{0.5}PO₄ or LiFe_{0.5}Ni_{0.5}PO₄).

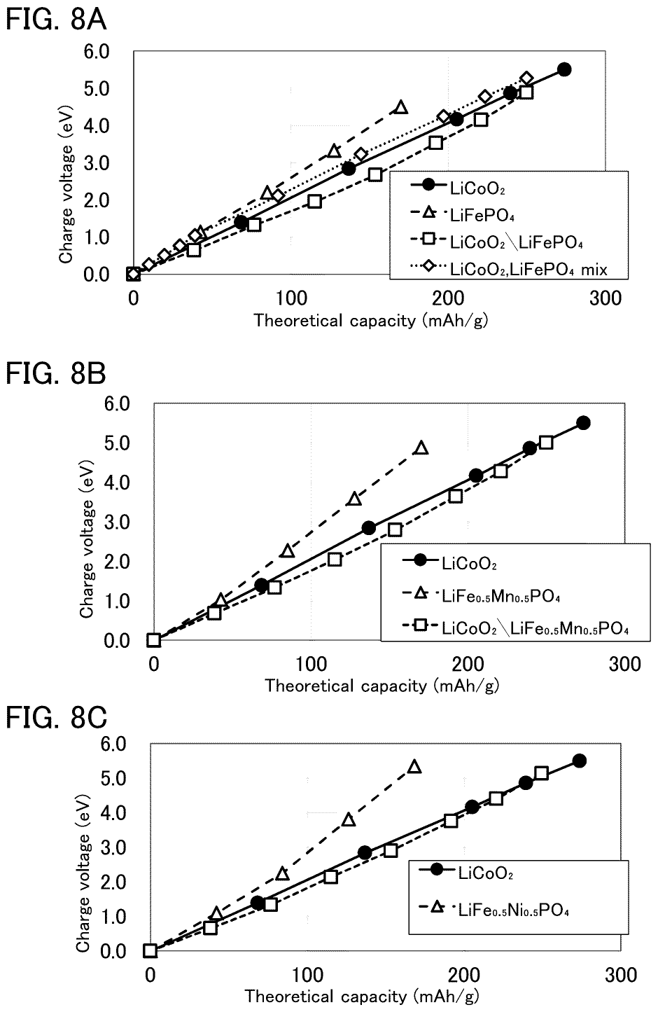

A potential difference between before and after extraction of Li (corresponding to a potential difference at the time of charge) is calculated for each of these models with the structures. FIG. 8A is a graph showing theoretical capacity-charge voltage curves of LiCoO₂, LiFePO₄ (sometimes referred to as LFP), a structure in which LiCoO₂ and LiFePO₄ are stacked, and a structure in which LiCoO₂ and LiFePO₄ are mixed. The structure in which LiCoO₂ and LiFePO₄ are stacked and the structure in which LiCoO₂ and LiFePO₄ are mixed are included in the structure with the combination of LiCoO₂ and LiFePO₄. FIG. 8B is a graph showing theoretical capacity-charge voltage curves of LiCoO₂, LiFe_{0.5}Mn_{0.5}PO₄ (sometimes referred to as LFMP), and a structure in which LiCoO₂ and LFMP are stacked. The structure in which LiCoO₂ and LFMP are stacked is included in the structure with the combination of LiCoO₂ and LFMP. FIG. 8C is a graph showing theoretical capacity-charge voltage curves of LiCoO₂, LiFe_{0.5}Ni_{0.5}PO₄ (sometimes referred to as LFNP), and a structure in which LiCoO₂ and LFNP are stacked. The structure in which LiCoO₂ and LFNP are stacked is included in the structure with the combination of LiCoO₂ and LFNP.

It is found from the results shown in FIGS. 8(A), (B), and (C) that the charge voltage tends to be higher in LiFePO₄ where part of Fe is replaced with Mn than in LiFePO₄, and that the charge voltage tends to be higher in LiFePO₄ where part of Fe is replaced with Ni than in LiFePO₄ where part of Fe is replaced with Mn.

This embodiment can be implemented in appropriate combination with the other embodiments.

### Embodiment 4

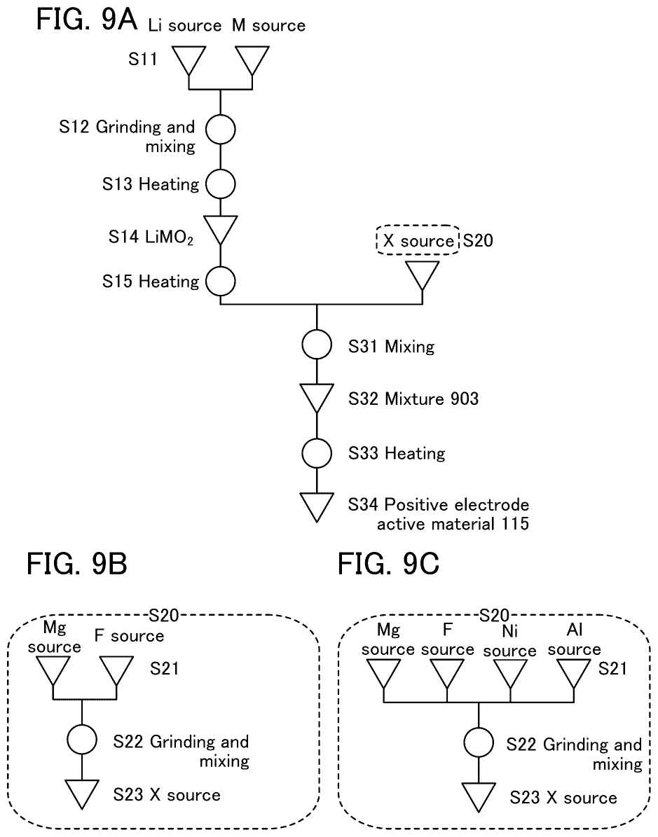

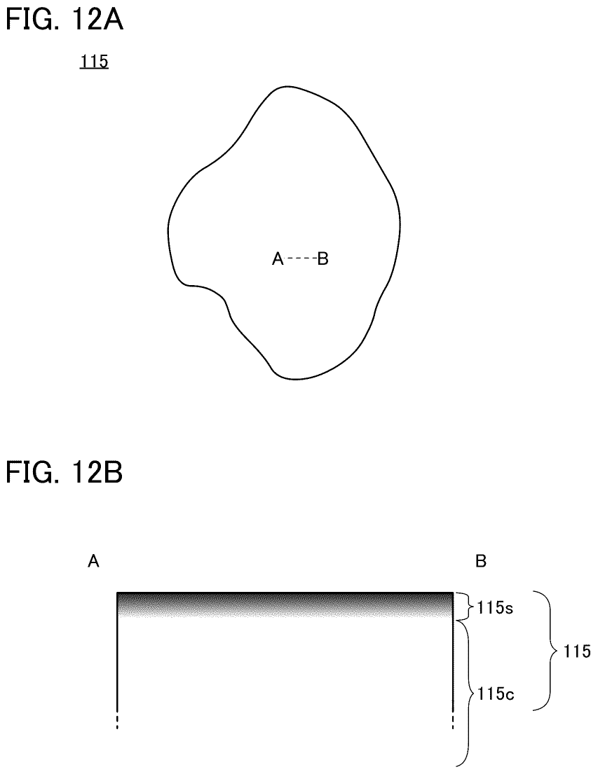

In this embodiment, an example of a method for forming the first material functioning as the positive electrode active material of one embodiment of the present invention will be described with reference to FIG. 9 to FIG. 11. Furthermore, the positive electrode active material of one embodiment of the present invention will be described with reference to FIG. 12 to FIG. 20.

### [Method 1 for Forming Positive Electrode Active Material]

### <Step S11>

In Step S11 shown in FIG. 9A, a lithium source (Li source) and a transition metal source (M source) are prepared as materials of lithium and a transition metal which are starting materials.

A compound containing lithium is preferably used as the lithium source; for example, lithium carbonate, lithium hydroxide, lithium nitrate, lithium fluoride, or the like can be used. The lithium source preferably has a high purity and is preferably a material having a purity of higher than or equal to 99.99%, for example.

The transition metal can be selected from the elements belonging to Groups 4 to 13 of the periodic table and, for example, at least one of manganese, cobalt, and nickel is used. As the transition metal, cobalt alone; nickel alone; two metals of cobalt and manganese; two metals of cobalt and nickel; or three metals of cobalt, manganese, and nickel may be used. When cobalt alone is used, the positive electrode active material to be obtained contains lithium cobalt oxide (LCO); when three metals of cobalt, manganese, and nickel are used, the positive electrode active material to be obtained contains lithium nickel-cobalt-manganese oxide (NCM).

As the transition metal source, a compound containing the above transition metal is preferably used and, for example, an oxide, a hydroxide, or the like of any of the metals given as examples of the transition metal can be used. As a cobalt source, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

The transition metal source preferably has a high purity and is preferably a material having a purity of higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using the high-purity material. As a result, a secondary battery with an increased capacity and/or increased reliability can be obtained.

Furthermore, the transition metal source preferably has high crystallinity and includes single crystal particles, for example. To evaluate the crystallinity of the transition metal source, the crystallinity can be judged by a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, or the like, or can be judged by X-ray diffraction (XRD), electron diffraction, neutron diffraction, or the like. Note that the above methods for evaluating crystallinity can also be employed to evaluate the crystallinity of materials other than the transition metal source.

In the case of using two or more transition metal sources, the two or more transition metal sources are preferably prepared to have a mixing ratio such that a layered rock-salt crystal structure would be obtained.

### <Step S12>

Next, in Step S12 shown in FIG. 9A, the lithium source and the transition metal source are ground and mixed to form a mixed material. The grinding and mixing can be performed by a dry process or a wet process. A wet process is preferred because it can crush a material into a smaller size. When a wet process is employed, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, dehydrated acetone with a purity of higher than or equal to 99.5% is used. It is preferable that the lithium source and the transition metal source be mixed into dehydrated acetone whose moisture content is less than or equal to 10 ppm and which has a purity of higher than or equal to 99.5% in the crushing and mixing. With the use of dehydrated acetone with the above-described purity, impurities that might be mixed can be reduced.

A ball mill, a bead mill, or the like can be used as a means of the mixing and the like. When the ball mill is used, alumina balls or zirconia balls are preferably used as grinding media. Zirconia balls are preferable because they release fewer impurities. When a ball mill, a bead mill, or the like is used, the peripheral speed is preferably higher than or equal to 100 mm/s and lower than or equal to 2000 mm/s in order to inhibit contamination from the media. In this embodiment, the peripheral speed is set to 838 mm/s (the rotational frequency is 400 rpm, and the diameter of the ball mill is 40 mm).

### <Step S13>

Next, the materials mixed in the above manner are heated in Step S13 shown in FIG. 9A. The heating temperature is preferably higher than or equal to 800° C. and lower than or equal to 1100° C., further preferably higher than or equal to 900° C. and lower than or equal to 1000° C., still further preferably approximately 950° C. An excessively low temperature might lead to insufficient decomposition and melting of the lithium source and the transition metal source. An excessively high temperature might lead to a defect due to evaporation of lithium from the lithium source and/or excessive reduction of the metal used as the transition metal source, for example. The defect is, for example, an oxygen defect which could be induced by a change of trivalent cobalt into divalent cobalt due to excessive reduction, in the case where cobalt is used as the transition metal.

The heating time is preferably longer than or equal to 1 hour and shorter than or equal to 100 hours, further preferably longer than or equal to 2 hours and shorter than or equal to 20 hours.

The temperature rising rate is preferably higher than or equal to 80° C./h and lower than or equal to 250° C./h, although depending on the end-point temperature of the heating. For example, in the case of heating at 1000° C. for 10 hours, the temperature rise is preferably at 200° C./h.

The heating is preferably performed in an atmosphere with little water such as dry air and, for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber, for example. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, the following method may be employed: the pressure in the reaction chamber is reduced, then the reaction chamber is filled with oxygen, and the oxygen is prevented from entering or exiting from the reaction chamber. Such a method is referred to as purging. For example, the pressure in the reaction chamber may be reduced to −970 hPa and then, the reaction chamber may be filled with oxygen until the pressure becomes 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A crucible or a saggar used at the time of the heating is preferably made of alumina (aluminum oxide), mullite cordierite, magnesia, or zirconia, i.e., preferably includes a highly heat resistant material. An alumina crucible is preferable because it is made of a material that hardly releases impurities. In this embodiment, a crucible made of alumina with a purity of 99.9% is preferably used. The heating is preferably performed with the crucible or the saggar covered with a lid. The heating performed with the crucible or the saggar covered with a lid can prevent volatilization of a material.

The heated material is ground as needed and may be made to pass through a sieve. Before collection of the heated material, the material may be moved from the crucible to a mortar. As the mortar, an alumina mortar is suitably used. An alumina mortar is made of a material that hardly releases impurities. Specifically, a mortar made of alumina with a purity of 90% or higher, preferably 99% or higher, is used. Note that heating conditions equivalent to those in Step S13 can be employed in a later-described heating step other than Step S13.

### <Step S14>

Through the above steps, a composite oxide containing the transition metal (LiMO₂) can be obtained in Step S14 shown in FIG. 9A. The composite oxide needs to have a crystal structure of a lithium composite oxide represented by LiMO₂, but the composition is not strictly limited to Li:M:O=1:1:2. When the transition metal is cobalt, the composite oxide is referred to as a composite oxide containing cobalt and is represented by LiCoO₂. Note that the composition is not strictly limited to Li:Co:O=1:1:2.

Although the example is described in which the composite oxide is formed by a solid phase method as in Step S11 to Step S14, the composite oxide may be formed by a coprecipitation method. Alternatively, the composite oxide may be formed by a hydrothermal method.

### <Step S15>

Next, in Step S15 shown in FIG. 9A, the above composite oxide is heated. The heating in Step S15 is the first heating performed on the composite oxide; thus, this heating is sometimes referred to as the initial heating. The heating is performed before Step S20 described below and thus is sometimes referred to as preheating or pretreatment.

The initial heating may cause release of lithium from part of the lithium composite oxide of Step 14. In addition, an effect of increasing the crystallinity of the lithium composite oxide can be expected. Since impurities are mixed into the lithium source and/or the transition metal M prepared in Step S11 and the like, the initial heating can reduce the impurities of the lithium composite oxide of Step 14.

Through the initial heating, the surface of the composite oxide becomes smooth. A smooth surface refers to a state where the composite oxide has little unevenness and is rounded as a whole and its corner portion is rounded. Being smooth refers to a state where few foreign matters are attached to the surface. Foreign matters are deemed to cause unevenness and are preferably not attached to a surface. In an observation on a cross section of a smooth active material by a scanning transmission electron microscope (STEM), the smooth active material can have a surface roughness of at least less than or equal to 10 nm, preferably less than 3 nm when the surface unevenness information is quantified with measurement data.

The initial heating is heating performed after a composite oxide is obtained, and the initial heating for making the surface smooth can reduce degradation after charge and discharge. The initial heating for making the surface smooth does not need a lithium source.

Alternatively, the initial heating for making the surface smooth does not need an additive element source.

Alternatively, the initial heating for making the surface smooth does not need a flux.

The lithium source or the transition metal source prepared in Step S11 or the like might contain impurities. The initial heating can reduce impurities in the composite oxide completed in Step S14.

The heating conditions in this step can be freely set as long as the heating makes the surface of the above composite oxide smooth. For example, any of the heating conditions described for Step S13 can be selected. Additionally, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature of higher than or equal to 700° C. and lower than or equal to 1000° C. for longer than or equal to 2 hours and shorter than or equal to 20 hours.

The heating in Step S13 might cause a temperature difference between the surface and an inner portion of the composite oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the composite oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the composite oxide is relieved. This is probably why the surface of the composite oxide becomes smooth through Step S15. This is also referred to as improvement of the surface. In other words, it is deemed that Step S15 reduces the differential shrinkage caused in the composite oxide to make the surface of the composite oxide smooth.

Such differential shrinkage might cause a micro shift in the composite oxide such as a shift in a crystal. To reduce the shift, this step is preferably performed. Performing this step can distribute a shift uniformly in the composite oxide. When the shift is distributed uniformly, the surface of the composite oxide might become smooth. This is also referred to as alignment of crystal grains. In other words, it is deemed that Step S15 reduces the shift in a crystal or the like which is caused in the composite oxide to make the surface of the composite oxide smooth.

In a secondary battery using a composite oxide with a smooth surface as a positive electrode active material, degradation by charge and discharge is suppressed and a crack in the positive electrode active material can be prevented.

It can be said that when surface unevenness information in one cross section of a composite oxide is quantified with measurement data, a smooth surface of the composite oxide has a surface roughness of at least less than or equal to 10 nm, preferably less than 3 nm. The one cross section is, for example, a cross section obtained in observation using a scanning transmission electron microscope (STEM).

Note that a pre-synthesized composite oxide containing lithium, the transition metal, and oxygen may be used in Step S14. In this case, Step S11 to Step S13 can be omitted. When Step S15 is performed on the pre-synthesized composite oxide, a composite oxide with a smooth surface can be obtained.

The initial heating might reduce the amount of lithium in the composite oxide. An additive element described for Step S20 or the like below might easily enter the composite oxide owing to the reduction in the amount of lithium.

### <Step S20>

The additive element X may be added to the composite oxide having a smooth surface as long as a layered rock-salt crystal structure can be obtained. When the additive element X is added to the composite oxide having a smooth surface, the additive element can be uniformly added. It is thus preferable that the initial heating precede the addition of the additive element. The step of adding the additive element is described with reference to FIG. 9B and FIG. 9C.

### <Step S21>

In Step S21 shown in FIG. 9B, an additive element source (X source) to be added to the composite oxide is prepared. A lithium source may be prepared together with the additive element source.

As the additive element, one or two or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the additive element, one or more selected from bromine and beryllium can be used. Note that the aforementioned additive elements are more suitable because bromine and beryllium are elements having toxicity to living things.

When magnesium is selected as the additive element, the additive element source can be referred to as a magnesium source. As the magnesium source, for example, magnesium fluoride, magnesium oxide, magnesium hydroxide, or magnesium carbonate can be used. Two or more of these magnesium sources may be used.

When fluorine is selected as the additive element, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VFs), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), sodium aluminum hexafluoride (Na₃AlF₆), or the like can be used. Among them, lithium fluoride, which has a relatively low melting point of 848° C., is preferable because it is easily melted in a heating step described later.

Magnesium fluoride can be used as both the fluorine source and the magnesium source. Lithium fluoride can be used also as the lithium source. Another example of the lithium source used in Step S21 is lithium carbonate.

The fluorine source may be a gas; for example, fluorine (F₂), carbon fluoride, sulfur fluoride, oxygen fluoride (OF₂, O₂F₂, O₃F₂, O₄F₂, or O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed at approximately LiF:MgF₂=65:35 (molar ratio), the effect of reducing the melting point becomes the highest (see Non-Patent Document 4). On the other hand, when the amount of lithium fluoride increases, cycle performance might deteriorate because of too large an amount of lithium. Thus, the molar ratio of lithium fluoride to magnesium fluoride (LiF:MgF₂) is preferably x:1 (0≤x≤1.9), further preferably x:1 (0.1≤x≤0.5), still further preferably x:1 (x=0.33 or an approximate value thereof). Note that an approximate value means a value greater than 0.9 times and less than 1.1 times a certain value.

### <Step S22>

Next, in Step S22 shown in FIG. 9B, the magnesium source and the fluorine source are ground and mixed. Any of the conditions for the grinding and mixing that are described for Step S12 can be selected to perform this step.

A heating step may be performed after Step S22 as needed. For the heating step, any of the heating conditions described for Step S13 can be selected. The heating time is preferably longer than or equal to 2 hours and the heating temperature is preferably higher than or equal to 800° C. and lower than or equal to 1100° C.

### <Step S23>

Next, in Step S23 shown in FIG. 9B, the materials ground and mixed in the above step are collected to obtain the additive element source (X source). Note that the additive element source in Step S23 contains a plurality of starting materials and can be referred to as a mixture.

As for the particle diameter of the mixture, its D50 (median diameter) is preferably greater than or equal to 600 nm and less than or equal to 20 m, further preferably greater than or equal to 1 m and less than or equal to 10 m. Also when one kind of material is used as the additive element source, the D50 (median diameter) is preferably greater than or equal to 600 nm and less than or equal to 20 m, further preferably greater than or equal to 1 m and less than or equal to 10 m.

Such a pulverized mixture (which may contain only one kind of the additive element) is easily attached to the surface of a composite oxide particle uniformly in a later step of mixing with the composite oxide. The mixture is preferably attached uniformly to the surface of the composite oxide, in which case the additive element is easily distributed or dispersed uniformly in a surface portion of the composite oxide after heating. The region where the additive element is distributed can also be referred to as a surface portion. When there is a region containing no additive element in the surface portion, the positive electrode active material might be less likely to have an O3′ type crystal structure, which is described later, in the charged state. Note that although fluorine is used in the above description, chlorine may be used instead of fluorine, and a general term “halogen” for these elements can replace “fluorine”.

### <Step S21>

A process different from that in FIG. 9B is described with reference to FIG. 9C. In Step S21 shown in FIG. 9C, four kinds of additive element sources to be added to the composite oxide are prepared. In other words, FIG. 9C is different from FIG. 9B in the kinds of the additive element sources. A lithium source may be prepared together with the additive element sources.

As the four kinds of additive element sources, a magnesium source (Mg source), a fluorine source (F source), a nickel source (Ni source), and an aluminum source (Al source)) are prepared. Note that the magnesium source and the fluorine source can be selected from the compounds and the like described with reference to FIG. 9B. As the nickel source, nickel oxide, nickel hydroxide, or the like can be used. As the aluminum source, aluminum oxide, aluminum hydroxide, or the like can be used.

### <Step S22> and <Step S23>

Next, Step S22 and Step S23 shown in FIG. 9C are similar to the steps described with reference to FIG. 9B.

### <Step S31>

Next, in Step S31 shown in FIG. 9A, the composite oxide and the additive element source (X source) are mixed. The ratio of the number M of the transition metal atoms in the composite oxide containing lithium, the transition metal, and oxygen to the number Mg of magnesium atoms in the additive element X is preferably M:Mg=100:y (0.1≤y≤6), further preferably M:Mg=100:y (0.3≤y≤3).

The conditions of the mixing in Step S31 are preferably milder than those of the mixing in Step S12 in order not to damage the composite oxide. For example, conditions with a lower rotation frequency or shorter time than the mixing in Step S12 are preferable. In addition, it can be said that the dry process has a milder condition than the wet process. For example, a ball mill, a bead mill, or the like can be used for the mixing. When a ball mill is used, zirconia balls are preferably used as media, for example.

In this embodiment, the mixing is performed with a ball mill using zirconia balls with a diameter of 1 mm by a dry process at 150 rpm for 1 hour. The mixing is performed in a dry room the dew point of which is higher than or equal to −100° C. and lower than or equal to −10° C.

### <Step S32>

Next, in Step S32 of FIG. 9A, the materials mixed in the above manner are collected to obtain a mixture 903. At the time of collection, the materials may be sieved as needed after being crushed.

Note that in this embodiment, the method is described in which lithium fluoride as the fluorine source and magnesium fluoride as the magnesium source are added to the composite oxide that has been subjected to the initial heating. However, the present invention is not limited to the above method. The magnesium source, the fluorine source, and the like can be added to the lithium source and the transition metal source in Step S11, i.e., at the stage of the starting materials of the composite oxide. Then, the heating in Step S13 is performed, so that LiMO₂ to which magnesium and fluorine are added can be obtained. In that case, there is no need to separate steps of Step S11 to Step S14 and steps of Step S21 to Step S23. This method can be regarded as being simple and highly productive.

Alternatively, lithium cobalt oxide to which magnesium and fluorine are added in advance may be used. When lithium cobalt oxide to which magnesium and fluorine are added is used, Step S11 to Step S32 and Step S20 can be skipped. This method can be regarded as being simple and highly productive.

Alternatively, to lithium cobalt oxide to which magnesium and fluorine are added in advance, a magnesium source and a fluorine source may be further added as in Step S20 of FIG. 9B, or a magnesium source, a fluorine source, a nickel source, and an aluminum source may be further added as in Step S20 of FIG. 9C.

### <Step S33>

Then, in Step S33 shown in FIG. 9A, the mixture 903 is heated. Any of the heating conditions described for Step S13 can be selected. The heating time is preferably longer than or equal to 2 hours.

Here, a supplementary explanation of the heating temperature is provided. The lower limit of the heating temperature in Step S33 needs to be higher than or equal to the temperature at which a reaction between the composite oxide (LiMO₂) and the additive element source proceeds. The temperature at which the reaction proceeds is the temperature at which interdiffusion of the element contained in LiMO₂ and the element contained in the additive element source occurs, and may be lower than the melting temperatures of these materials. It is known that in the case of an oxide as an example, solid phase diffusion occurs at a temperature that is 0.757 times (Tamman temperature T_{d}) the melting temperature Tₘ. Accordingly, it is only required that the heating temperature in Step S33 be higher than or equal to 500° C.

Needless to say, the reaction more easily proceeds at a temperature higher than or equal to the temperature at which at least part of the mixture 903 is melted. For example, in the case where LiF and MgF₂ are included in the additive element source, the eutectic point of LiF and MgF₂ is around 742° C. Therefore, the lower limit of the heating temperature in Step S33 is preferably higher than or equal to 742° C.

The mixture 903 obtained by mixing such that LiCoO₂:LiF:MgF₂=100:0.33:1 (molar ratio) exhibits an endothermic peak at around 830° C. in differential scanning calorimetry measurement (DSC measurement). Thus, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of LiMO₂ (the decomposition temperature of LiCoO₂ is 1130° C.). At around the decomposition temperature, a slight amount of LiMO₂ might be decomposed. Thus, the heating temperature is preferably lower than or equal to 1000° C., further preferably lower than or equal to 950° C., still further preferably lower than or equal to 900° C.

In view of the above, the heating temperature in Step S33 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is higher than or equal to 800° C. and lower than or equal to 1100° C., preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 900° C. Note that the heating temperature in Step S33 is preferably higher than that in Step S13.

In addition, at the time of heating the mixture 903, the partial pressure of fluorine or a fluoride originating from the fluorine source or the like is preferably controlled to be within an appropriate range.

In the formation method described in this embodiment, some of the materials, e.g., LiF as the fluorine source, function as a flux in some cases. Owing to this function, the heating temperature can be lower than the decomposition temperature of the composite oxide (LiMO₂), e.g., a temperature higher than or equal to 742° C. and lower than or equal to 950° C., which allows distribution of the additive element such as magnesium in the surface portion and formation of the positive electrode active material having excellent performance.

However, since LiF in a gas phase has a specific gravity less than that of oxygen, heating might volatilize LiF and in that case, the amount of LiF in the mixture 903 is reduced. As a result, the function of a flux deteriorates. Thus, heating needs to be performed while volatilization of LiF is inhibited. Note that even when LiF is not used as the fluorine source or the like, Li at the surface of LiMO₂ and F of the fluorine source might react to produce LiF, which might volatilize. Therefore, the volatilization needs to be inhibited also when a fluoride having a higher melting point than LiF is used.

In view of this, the mixture 903 is preferably heated in an atmosphere containing LiF, i.e., the mixture 903 is preferably heated in a state where the partial pressure of LiF in a heating furnace is high. Such heating can inhibit volatilization of LiF in the mixture 903.

The heating in this step is preferably performed such that the mixtures 903 are not adhered to each other. Adhesion of the mixtures 903 during the heating might decrease the area of contact with oxygen in the atmosphere and inhibit a path of diffusion of the additive element (e.g., fluorine), thereby hindering distribution of the additive element (e.g., magnesium and fluorine) in the surface portion.

It is considered that uniform distribution of the additive element (e.g., fluorine) in the surface portion leads to a smooth positive electrode active material with little unevenness. Thus, it is preferable that the particles not be adhered to each other in order to allow the smooth surface obtained through the heating in Step S15 to be maintained or to be smoother in this step.

In the case of using a rotary kiln for the heating, the flow rate of an oxygen-containing atmosphere in the kiln is preferably controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example.

A supplementary explanation of the heating time is provided. The heating time is changed depending on conditions such as the heating temperature and the size and composition of LiMO₂ in Step S14. In the case where the size of LiMO₂ is small, it is sometimes preferable that the heating be performed at a lower temperature or for a shorter time than the case where the size of LiMO₂ is large.

When the median diameter (D50) of the composite oxide (LiMO₂) in Step S14 in FIG. 9A is approximately 12 μm, the heating temperature is preferably higher than or equal to 600° C. and lower than or equal to 950° C., for example. The heating time is preferably longer than or equal to 3 hours, further preferably longer than or equal to 10 hours, still further preferably longer than or equal to 60 hours, for example. Note that the temperature decreasing time after the heating is, for example, preferably longer than or equal to 10 hours and shorter than or equal to 50 hours.

When the median diameter (D50) of the composite oxide (LiMO₂) in Step S14 is approximately 5 m, the heating temperature is preferably higher than or equal to 600° C. and lower than or equal to 950° C., for example. The heating time is preferably longer than or equal to 1 hour and shorter than or equal to 10 hours, further preferably approximately 2 hours, for example. Note that the temperature decreasing time after the heating is, for example, preferably longer than or equal to 10 hours and shorter than or equal to 50 hours.

### <Step S34>

Next, the heated material is collected in Step S34 shown in FIG. 9A, in which crushing is performed as needed; thus, the positive electrode active material 115 is obtained. Here, the collected positive electrode active material 115 is preferably made to pass through a sieve.

Through the above steps, the positive electrode active material 115 of one embodiment of the present invention can be formed. The positive electrode active material of one embodiment of the present invention has a smooth surface.

### [Method 2 for Forming Positive Electrode Active Material]

Next, as one embodiment of the present invention, a method different from that in Method 1 for forming positive electrode active material will be described.

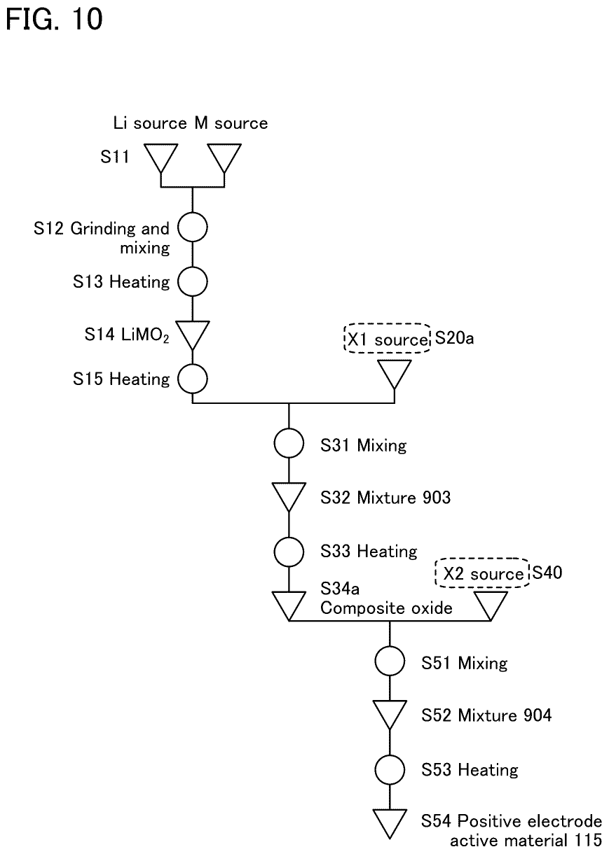

Steps S11 to S15 in FIG. 10 are performed as in FIG. 9A to prepare a composite oxide (LiMO₂) having a smooth surface.

### <Step S20a>

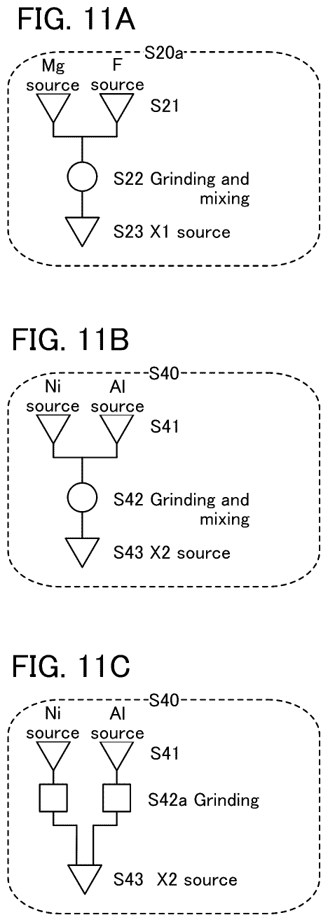

As already described above, the additive element X may be added to the composite oxide as long as a layered rock-salt crystal structure can be obtained. The formation method 2 has two or more steps of adding the additive element, as described below with reference to FIG. 11A.

### <Step S21>

FIG. 11A shows the details of Step S20a. In Step S21, a first additive element source (X1 source) is prepared. The X1 source can be selected from the additive elements X described for Step S21 with reference to FIG. 9B to be used. For example, one or two or more selected from magnesium, fluorine, and calcium can be used as the additive element X1. FIG. 11A shows an example of using a magnesium source (Mg source) and a fluorine source (F source) as the additive element source (X1 source).

Step S21 to Step S23 shown in FIG. 11A can be performed under the same conditions as those in Step S21 to Step S23 shown in FIG. 9B. As a result, the additive element source (X1 source) can be obtained in Step S23. The additive element source (X1 source) is used as the X1 source of Step S20a shown in FIG. 10.

Steps S31 to S33 shown in FIG. 10 can be performed in a manner similar to that of Steps S31 to S33 shown in FIG. 9A.

### <Step S34a>

Next, the material heated in Step S33 shown in FIG. 10 is collected to form a composite oxide containing the additive element X1. This composite oxide is called a second composite oxide to be distinguished from the composite oxide in Step S14.

### <Step S40>

In Step S40 shown in FIG. 10, a second additive element source (X2 source) is added. The details of Step S40 will be described with reference also to FIG. 11B and FIG. 11C.

### <Step S41>

In Step S41 shown in FIG. 11B, the second additive element source (X2 source) is prepared. The X2 source can be selected from the additive elements X described for Step S21 with reference to FIG. 9B to be used. For example, one or two or more selected from nickel, titanium, boron, zirconium, and aluminum can be suitably used as the additive element X2. FIG. 11B shows an example of using a nickel source and an aluminum source as the additive element source (X2 source).

Step S41 to Step S43 shown in FIG. 11B can be performed under the same conditions as those in Step S21 to Step S23 shown in FIG. 9B. As a result, the additive element source (X2 source) can be obtained in Step S43.

FIG. 11C shows a modification example of the steps described with reference to FIG. 11B. A nickel source (Ni source) and an aluminum source (Al source) are prepared in Step S41 shown in FIG. 11C and are separately ground in Step S42a. Accordingly, a plurality of the second additive element sources (X2 sources) are prepared in Step S43. FIG. 1C is different from FIG. 11B in separately grinding the additive elements in Step S42a.

### <Step S51 to Step S53>

Next, Step S51 to Step S53 shown in FIG. 10 can be performed under the same conditions as those in Step S31 to Step S34 shown in FIG. 9A. The heating in Step S53 can be performed at a lower temperature and for a shorter time than the heating in Step S33. Through the above steps, the positive electrode active material 115 of one embodiment of the present invention can be formed in Step S53. The positive electrode active material of one embodiment of the present invention has a smooth surface.

As shown in FIG. 10 and FIG. 11, in the formation method 2, introduction of the additive element to the composite oxide is separated into introduction of the first additive element X1 and that of the second additive element X2. When the elements are separately introduced, the additive elements can have different profiles in the depth direction. For example, the first additive element can have a profile such that the concentration is higher in the surface portion than in the inner portion, and the second additive element can have a profile such that the concentration is higher in the inner portion than in the surface portion.

The initial heating described in this embodiment makes it possible to obtain a positive electrode active material having a smooth surface.

The initial heating described in this embodiment is performed on a composite oxide. Thus, the initial heating is preferably performed at a temperature lower than the heating temperature for forming the composite oxide and for a time shorter than the heating time for forming the composite oxide. In the case of adding the additive element to the composite oxide, the adding step is preferably performed after the initial heating. The adding step may be separated into two or more steps. Such an order of steps is preferred in order to maintain the smoothness of the surface achieved by the initial heating. When a composite oxide contains cobalt as a transition metal, the composite oxide can be rephrased as a composite oxide containing cobalt.

### [Structure of Positive Electrode Active Material]

The positive electrode active material of one embodiment of the present invention will be described with reference to FIG. 12 to FIG. 20.

FIG. 12A is a schematic top view of the positive electrode active material 115 of one embodiment of the present invention. FIG. 12B is a schematic cross-sectional view taken along A-B in FIG. 12A.

### <Contained Elements and Distribution>

The positive electrode active material 115 contains lithium, a transition metal, oxygen, and an additive element. As the additive element, an element different from the transition metal contained in the positive electrode active material 115 is preferably used. In other words, the positive electrode active material 115 can be regarded as a composite oxide represented by LiMO₂ to which an element other than M is added.

As the transition metal contained in the positive electrode active material 115, a metal that can form, together with lithium, a composite oxide having the layered rock-salt structure belonging to the space group R-3m is preferably used; for example, at least one of manganese, cobalt, and nickel can be used. That is, as the transition metal contained in the positive electrode active material 115, only cobalt may be used, only nickel may be used, two metals of cobalt and manganese or two metals of cobalt and nickel may be used, or three metals of cobalt, manganese, and nickel may be used. In other words, the positive electrode active material 115 can contain a composite oxide containing lithium and the transition metal, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide. Nickel is preferably contained as the transition metal in addition to cobalt, in which case a crystal structure is more stable in a high-voltage charged state.

As the additive element X contained in the positive electrode active material 115, one or two or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic are preferably used. Such additive elements further stabilize a crystal structure of the positive electrode active material 115 in some cases. That is, the positive electrode active material 115 can contain lithium cobalt oxide containing magnesium and fluorine, lithium cobalt oxide containing magnesium, fluorine, and titanium, lithium nickel-cobalt oxide containing magnesium and fluorine, lithium cobalt-aluminum oxide containing magnesium and fluorine, lithium nickel-cobalt-aluminum oxide, lithium nickel-cobalt-aluminum oxide containing magnesium and fluorine, lithium nickel-manganese-cobalt oxide containing magnesium and fluorine, or the like. In this specification and the like, the additive element X may be rephrased as a constituent of a mixture or a raw material or the like.

As illustrated in FIG. 12B, the positive electrode active material 115 includes a surface portion 115s and an inner portion 115c. A transition metal (e.g., cobalt), which is a main component of the positive electrode active material 115, exists in the surface portion 115s and the inner portion 115c. An additive element (e.g., magnesium) exists at least in the surface portion 115s and may exist in the inner portion 115c. The additive element concentration in the surface portion 115s is preferably higher than that in the inner portion 115c. The additive element concentration preferably has a gradient as illustrated in FIG. 12B by gradation, in which the concentration increases from the inner portion toward the surface. In this specification and the like, the surface portion 115s refers to a region that is within 50 nm, preferably within 30 nm, further preferably within 10 nm in depth from the surface of the positive electrode active material 115. A plane generated by a split and/or a crack may also be referred to as a surface, and a region that is within 50 nm, preferably within 30 nm, further preferably within 10 nm in depth from the surface is referred to as the surface portion 115s. A region in a deeper position than the surface portion 115s of the positive electrode active material 115 is referred to as the inner portion 115c.

In order to prevent the breakage of a layered structure formed of octahedrons of cobalt and oxygen even when lithium is extracted from the positive electrode active material 115 of one embodiment of the present invention by charge, the surface portion 115s having a high concentration of the additive element, i.e., the outer portion of the positive electrode active material 115, is reinforced.

The additive element preferably exists, further preferably homogeneously, in the entire surface portion 115s of the positive electrode active material 115. When the surface portion 115s partly has reinforcement, stress might be concentrated on parts that do not have reinforcement. The concentration of stress on part of the positive electrode active material 115 might cause defects such as cracks from that part, leading to breakage of the positive electrode active material 115 and a decrease in discharge capacity.

Magnesium is divalent and is more stable in lithium sites than in transition metal sites in the layered rock-salt crystal structure; thus, magnesium is likely to enter the lithium sites. An appropriate concentration of magnesium in the lithium sites of the surface portion 115s facilitates maintenance of the layered rock-salt crystal structure. The bonding strength of magnesium with oxygen is high, thereby inhibiting extraction of oxygen around magnesium. An appropriate concentration of magnesium does not have an adverse effect on insertion and extraction of lithium in charge and discharge, and is thus preferable.

However, excess magnesium might adversely affect insertion and extraction of lithium. Thus, the atomic ratio (Mg/Co) of magnesium to cobalt, which is a transition metal, is preferably greater than or equal to 0.020 and less than or equal to 0.50. The atomic ratio is further preferably greater than or equal to 0.025 and less than or equal to 0.30. The atomic ratio is still further preferably greater than or equal to 0.030 and less than or equal to 0.20.

Aluminum is trivalent and can exist at a transition metal site in the layered rock-salt crystal structure. Aluminum can inhibit dissolution of surrounding cobalt. The bonding strength of aluminum with oxygen is high, thereby inhibiting extraction of oxygen around aluminum. Hence, aluminum used as the additive element enables the positive electrode active material 115 to have the crystal structure that is unlikely to be broken by repeated charge and discharge.

When fluorine, which is a monovalent anion, is substituted for part of oxygen in the surface portion 115s, the lithium extraction energy is lowered. This is because the change in valence of cobalt ions associated with lithium extraction is trivalent to tetravalent in the case of not containing fluorine and divalent to trivalent in the case of containing fluorine, and the oxidation-reduction potential differs therebetween. It can thus be said that when fluorine is substituted for part of oxygen in the surface portion 115s of the positive electrode active material 115, lithium ions near fluorine are likely to be extracted and inserted smoothly. Thus, using such a positive electrode active material 115 in a secondary battery is preferable because the charge and discharge characteristics, rate performance, and the like are improved.

A titanium oxide is known to have superhydrophilicity. Accordingly, the positive electrode active material 115 including a titanium oxide in the surface portion 115s presumably has good wettability with respect to a high-polarity solvent. Such a positive electrode active material 115 and a high-polarity electrolyte solution can have favorable contact at the interface therebetween and presumably inhibit a resistance increase when a secondary battery is formed using the positive electrode active material 115. Note that in this specification and the like, an electrolyte solution corresponds to a liquid electrolyte.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can suppress a capacity decrease due to repeated charge and discharge.

A short circuit of a secondary battery might cause not only malfunction in charge operation and/or discharge operation of the secondary battery but also heat generation and firing. In order to obtain a safe secondary battery, a short-circuit current is preferably inhibited even at a high charge voltage. In the positive electrode active material 115 of one embodiment of the present invention, a short-circuit current is inhibited even at a high charge voltage. Thus, a secondary battery with high capacity and safety can be obtained.

It is preferable that a secondary battery using the positive electrode active material 115 of one embodiment of the present invention have high capacity, excellent charge and discharge cycle performance, and safety simultaneously.

The gradient of the concentration of the additive element can be evaluated using energy dispersive X-ray spectroscopy (EDX). In the EDX measurement, to measure a region while scanning the region and evaluate the region two-dimensionally is referred to as EDX planar analysis in some cases. In addition, to extract data of a linear region from EDX planar analysis and evaluate the atomic concentration distribution in the positive electrode active material is referred to as linear analysis in some cases.

By EDX surface analysis (e.g., element mapping), the concentrations of the additive element in the surface portion 115s, the inner portion 115c, the vicinity of the grain boundary, and the like of the positive electrode active material 115 can be quantitatively analyzed. The vicinity of the grain boundary includes a position corresponding to the surface portion in the surface constituting the grain boundary. By EDX linear analysis, the concentration distribution of the additive element can be analyzed.

When the positive electrode active material 115 is subjected to the EDX linear analysis, a peak of the magnesium concentration in the surface portion 115s preferably exists in a region from the surface of the positive electrode active material 115 to a depth of 3 nm toward the center, further preferably to a depth of 1 nm, still further preferably to a depth of 0.5 nm.

In addition, the distribution of fluorine contained in the positive electrode active material 115 preferably overlaps with the distribution of magnesium. Thus, when the EDX linear analysis is performed, a peak of the fluorine concentration in the surface portion 115s preferably exists in a region from the surface of the positive electrode active material 115 to a depth of 3 nm toward the center, further preferably to a depth of 1 nm, still further preferably to a depth of 0.5 nm.

Note that the concentration distribution may differ between the additive elements. For example, in the case where the positive electrode active material 115 further contains aluminum as the additive element, the distribution of aluminum is preferably slightly different from that of magnesium and that of fluorine. For example, in the EDX linear analysis, the peak of the magnesium concentration is preferably closer to the surface than the peak of the aluminum concentration is in the surface portion 115s. For example, the peak of the aluminum concentration preferably exists in a region from the surface of the positive electrode active material 115 to a depth of 0.5 nm or more and 20 nm or less toward the center, further preferably to a depth of 1 nm or more and 5 nm or less.

When the linear analysis or the surface analysis is performed on the positive electrode active material 115, the ratio (X/M) of the additive element X to the transition metal in the vicinity of the grain boundary is preferably greater than or equal to 0.020 and less than or equal to 0.50. It is further preferably greater than or equal to 0.025 and less than or equal to 0.30. It is still further preferably greater than or equal to 0.030 and less than or equal to 0.20. For example, when the additive element is magnesium and the transition metal is cobalt, the atomic ratio (Mg/Co) of magnesium to cobalt is preferably greater than or equal to 0.020 and less than or equal to 0.50. It is further preferably greater than or equal to 0.025 and less than or equal to 0.30. It is still further preferably greater than or equal to 0.030 and less than or equal to 0.20.

As described above, an excess amount of the additive element in the positive electrode active material 115 might adversely affect insertion and extraction of lithium. The use of such a positive electrode active material 115 for a secondary battery might cause a resistance increase, a capacity decrease, and the like. Meanwhile, when the amount of the additive element is insufficient, the additive element is not distributed throughout the surface portion 115s, which might reduce an effect of maintaining the crystal structure. Thus, the additive element concentration is adjusted to be appropriate in the positive electrode active material 115.

For example, the positive electrode active material 115 may include a region where the excess additive element is unevenly distributed. The region where the excess additive element is unevenly distributed may be included in the inner portion or the surface portion. With such a region, the excess additive element can be positioned in the region where the excess additive element is unevenly distributed, so that the additive element concentration in most of the inner portion and the surface portion in the positive electrode active material 115 can be appropriate. An appropriate additive element concentration in most of the inner portion and the surface portion in the positive electrode active material 115 can inhibit a resistance increase, a capacity decrease, and the like when the positive electrode active material 115 is used for a secondary battery. A feature of inhibiting a resistance increase of a secondary battery is extremely preferable especially in charge and discharge at a high rate.

In the positive electrode active material 115 including the region where the excess additive element is unevenly distributed, mixing of an excess additive element to some extent in the formation process is acceptable. This is preferable because the margin of production can be increased.

Note that in this specification and the like, uneven distribution means that the concentration of an element differs between a region A and a region B. It may be rephrased as segregation, precipitation, unevenness, deviation, high concentration, low concentration, or the like.

### <Crystal Structure>

A material with the layered rock-salt crystal structure, such as lithium cobalt oxide (LiCoO₂), is known to have high discharge capacity and excel as a positive electrode active material of a secondary battery. As an example of the material with the layered rock-salt crystal structure, a composite oxide represented by LiMO₂ is given.

It is known that the action of the Jahn-Teller effect in a composite oxide varies in degree according to the number of electrons in the d orbital of a transition metal.

In a composite oxide containing nickel, distortion is likely to be caused because of the Jahn-Teller effect in some cases. Accordingly, when charge and discharge at a high voltage are performed on LiNiO₂, the crystal structure might be broken because of the distortion. The influence of the Jahn-Teller effect is suggested to be small in LiCoO₂; hence, LiCoO₂ is preferable because the resistance to high-voltage charge and discharge is higher in some cases.

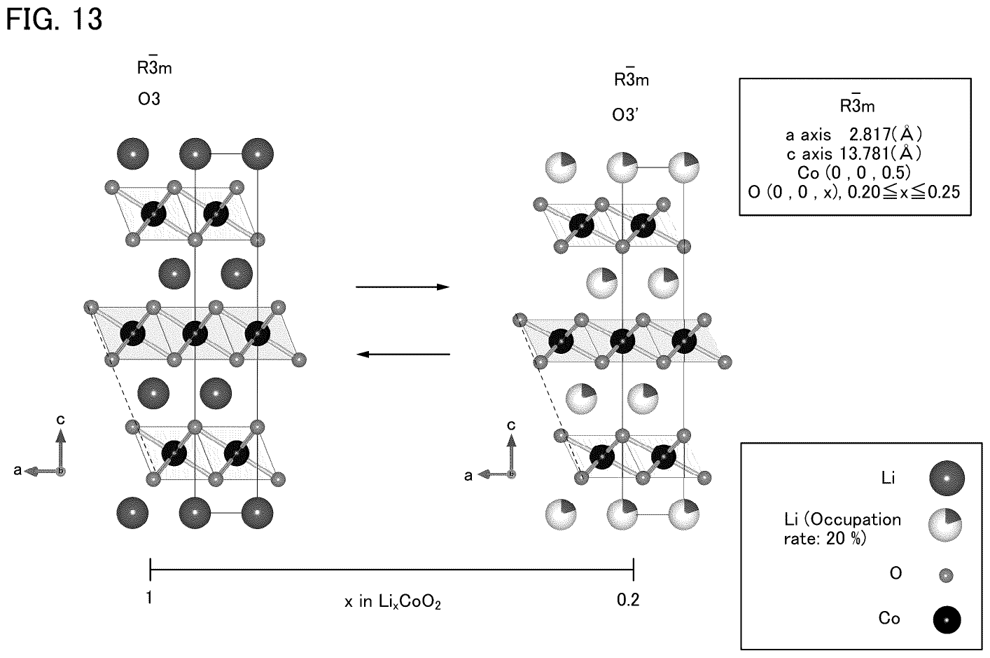

Positive electrode active materials are described with reference to FIG. 13 to FIG. 16. In FIG. 13 to FIG. 16, the case where cobalt is used as the transition metal contained in the positive electrode active materials is described.

<<x in LiₓCoO₂ being 1>>

The positive electrode active material 115 of one embodiment of the present invention preferably has a layered rock-salt crystal structure belonging to the space group R-3m in a discharged state, i.e., a state where x in LiₓCoO₂ is 1. A composite oxide having a layered rock-salt structure excels as a positive electrode active material of a secondary battery because it has high discharge capacity and a two-dimensional diffusion path for lithium ions and is thus suitable for an insertion/extraction reaction of lithium ions. For this reason, it is particularly preferable that the inner portion 115c, which accounts for the majority of the volume of the positive electrode active material 115, have a layered rock-salt crystal structure.

In FIG. 13, the layered rock-salt crystal structure is denoted with O3 along with the space group R-3m. The name O3 may be based on the fact that lithium occupies octahedral sites in this crystal structure and a unit cell includes three CoO₂ layers. This crystal structure is also referred to as an O3 type crystal structure in some cases. Note that the CoO₂ layer has a structure in which an octahedral structure with cobalt coordinated to six oxygen atoms continues in a plane in an edge-shared state. The CoO₂ layer is sometimes referred to as a layer formed of octahedrons of cobalt and oxygen.

<<State where x in LiₓCoO₂ is Small>>

The positive electrode active material 115 of one embodiment of the present invention is different from a conventional positive electrode active material in the crystal structure in the state where x in LiₓCoO₂ is small. Here, “x is small” means 0.1<x≤0.24. FIG. 13 shows a crystal structure with x of 0.2.

A conventional positive electrode active material and the positive electrode active material 115 of one embodiment of the present invention are compared in respect to a change in the crystal structure due to a change of x in LiₓCoO₂.

### <Conventional Positive Electrode Active Material>

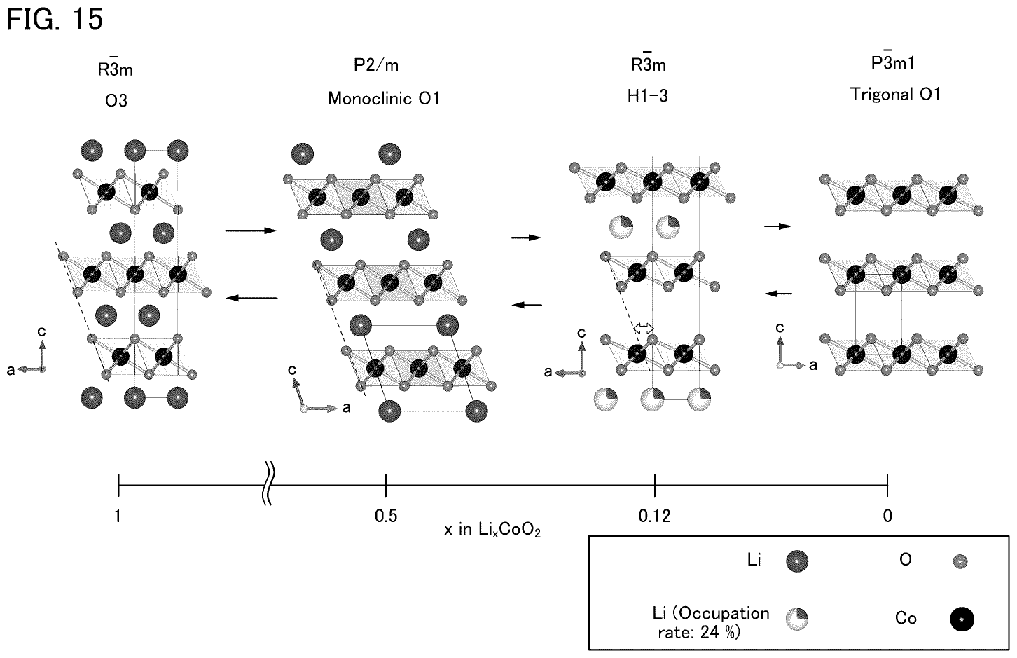

A change in the crystal structure of the conventional positive electrode active material is illustrated in FIG. 15. The conventional positive electrode active material illustrated in FIG. 15 is lithium cobalt oxide (LiCoO₂ or LCO) to which no additive element such as halogen or magnesium is added. As described in Non-Patent Document 1 to Non-Patent Document 3 and the like, the crystal structure of the lithium cobalt oxide illustrated in FIG. 15 changes.

In FIG. 15, the crystal structure of the lithium cobalt oxide with x in LiₓCoO₂ of 1 is denoted with R-3m O3. Note that x of 1 corresponds to a discharge state of a secondary battery. Next, the crystal structure of the lithium cobalt oxide with x of 0.5 is denoted with P2/m monoclinic O1. Conventional lithium cobalt oxide with x of approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

Furthermore, the crystal structure of lithium cobalt oxide with x in LiₓCoO₂ of 0 is denoted with P-3 m1 trigonal O1. Conventional lithium cobalt oxide with x of 0 has a trigonal crystal structure belonging to the space group P-3 m1. This structure includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when a trigonal crystal is converted into a composite hexagonal lattice.

Furthermore, the crystal structure of lithium cobalt oxide with x in LiₓCoO₂ of approximately 0.12 is denoted with R-3m H1-3. Conventional lithium cobalt oxide with x of approximately 0.12 has a crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that since insertion and extraction of lithium do not necessarily uniformly occur in reality, the H1-3 type crystal structure is started to be observed when x is approximately 0.25. Moreover, the number of cobalt atoms per unit cell in the H1-3 type crystal structure is actually twice as large as that of cobalt atoms per unit cell in other structures. However, in this specification including FIG. 15, the c-axis of the H1-3 type crystal structure is half that of the unit cell for easy comparison with the other crystal structures.

For the H1-3 type crystal structure, as disclosed in Non-Patent Document 2, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. A unit cell that should be used for representing a crystal structure of a positive electrode active material can be judged by the Rietveld analysis of XRD patterns, for example. In this case, a unit cell is selected such that the value of GOF (goodness of fit) is small.

When charge that makes x in LiₓCoO₂ be 0.24 or less and discharge are repeated, the crystal structure of conventional lithium cobalt oxide repeatedly changes between the H1-3 type crystal structure and the R-3m O3 structure in a discharged state (i.e., an unbalanced phase change).

However, there is a large shift in the CoO₂ layers between these two crystal structures. As denoted by the dotted lines and the arrow in FIG. 15, the CoO₂ layer in the H1-3 type crystal structure largely shifts from that in the structure belonging to R-3m O3. Such a dynamic structural change can adversely affect the stability of the crystal structure.

A difference in volume between these two crystal structures is also large. The difference in volume per the same number of cobalt atoms between the H1-3 type crystal structure and the R-3m O3 type crystal structure in the discharged state is greater than 3.5%, typically greater than or equal to 3.9%.

In addition, a structure in which there is no lithium between CoO₂ layers and CoO₂ layers are continuous, such as the trigonal O1 type structure, included in the H1-3 type crystal structure is highly likely to be unstable.

Thus, the repeated charge and discharge that make x be 0.24 or less gradually break the crystal structure of conventional lithium cobalt oxide. The broken crystal structure triggers deterioration of the cycle performance. This is because the broken crystal structure has a smaller number of sites where lithium can exist stably and makes it difficult to insert and extract lithium.

### <Positive Electrode Active Material of One Embodiment of the Present Invention>

In the positive electrode active material 115 of one embodiment of the present invention illustrated in FIG. 13, a change in the crystal structure between a discharged state with x in LiₓCoO₂ of 1 and a state with x of 0.24 or less, e.g., X=0.2, is smaller than that in a conventional positive electrode active material. Specifically, a shift in the CoO₂ layers between the state with x of 1 and the state with x of 0.2, which is less than or equal to 0.24, can be small. Furthermore, a change in the volume can be small in the case where the positive electrode active materials have the same number of cobalt atoms. Thus, the positive electrode active material 115 of one embodiment of the present invention can have a crystal structure that is unlikely to be broken even when charge and discharge are repeated so that x becomes 0.24 or less, and obtain excellent cycle performance.

In addition, the positive electrode active material 115 of one embodiment of the present invention with x in LiₓCoO₂ of 0.24 or less can have a more stable crystal structure than a conventional positive electrode active material. Thus, in the positive electrode active material 115 of one embodiment of the present invention, x in LiₓCoO₂ is preferably kept to be 0.24 or less, in which case a short circuit is less likely to occur and the safety of the secondary battery is improved.

FIG. 13 illustrates the crystal structures of lithium cobalt oxide with x in LiₓCoO₂ of 1 and approximately 0.2. It is a composite oxide containing lithium cobalt oxide, cobalt as a transition metal, and oxygen. In addition to the above, magnesium is preferably contained as an additive element. Furthermore, halogen such as fluorine or chlorine is preferably contained as an additive element.

The lithium cobalt oxide of one embodiment of the present invention with x of 1 has a crystal structure belonging to R-3m O3 that is the same as that of the conventional lithium cobalt oxide. The lithium cobalt oxide of one embodiment of the present invention with x of 0.24 or less, e.g., approximately 0.2, which makes the conventional lithium cobalt oxide have the H1-3 type crystal structure, has a crystal having a different structure from a conventional one.

The lithium cobalt oxide of one embodiment of the present invention with x of approximately 0.2 has a trigonal crystal structure belonging to the space group R-3m. The symmetry of the CoO₂ layers of this structure is the same as that of O3. Thus, this crystal structure is called an O3′ type crystal structure. In FIG. 13, the crystal structure with x of approximately 0.2 is denoted with R-3m O3′.

In the unit cell of the O3′ type crystal structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (Å), further preferably 2.807≤a≤2.827 (Å), typically a=2.817 (Å). The lattice constant of the c-axis is preferably 13.681≤c≤13.881 (Å), further preferably 13.751≤c≤13.811, typically c=13.781 (Å).

As denoted by the dotted lines in FIG. 13, the CoO₂ layers hardly shift between the R-3m O3 in the discharged state and the O3′ type crystal structure.

The R-3m O3 in the discharged state and the O3′ type crystal structure that contain the same number of cobalt atoms have a difference in volume of 2.5% or less, more specifically 2.2% or less, typically 1.8%, i.e., the difference in volume is small.

As described above, in the positive electrode active material 115, a change in the crystal structure caused when x in LiₓCoO₂ is small, i.e., when a large amount of lithium is extracted, is smaller than that in a conventional positive electrode active material. In addition, a change in the volume in the case where the positive electrode active materials having the same number of cobalt atoms are compared is inhibited. Thus, the crystal structure of the positive electrode active material 115 is unlikely to be broken even when charge that makes x be 0.24 or less and discharge are repeated. Therefore, a decrease in charge and discharge capacity of the positive electrode active material 115 in charge and discharge cycles is inhibited. Furthermore, the positive electrode active material 115 can stably use a large amount of lithium than a conventional positive electrode active material and thus has high discharge capacity per weight and per volume. Thus, with the use of the positive electrode active material 115, a secondary battery with high discharge capacity per weight and per volume can be fabricated.

Note that the positive electrode active material 115 is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27. However, the crystal structure is influenced not only by x in LixCOO₂ but also by the number of charge and discharge cycles, charge and discharge current, temperature, an electrolyte, and the like; thus, in some cases, the O3′ type crystal structure is obtained regardless of whether x is in the above range.

When x in LiₓCoO₂ in the positive electrode active material 115 is greater than 0.1 and less than or equal to 0.24, not the entire inner portion of the positive electrode active material 115 has to have the O3′ type crystal structure. Another crystal structure may be contained, or part of the inner portion may be amorphous.

In order to make x in LiₓCoO₂ small, charge at a high charge voltage is necessary in general. Thus, a state where x in LiₓCoO₂ is small can be rephrased as a state where charge at a high charge voltage has been performed. For example, when charge is performed at 25° C. and 4.6 V or higher with reference to the potential of a lithium metal, the H1-3 type crystal structure appears in a conventional positive electrode active material. Hence, a high charge voltage with reference to the potential of a lithium metal can be regarded as a charge voltage of 4.6 V or higher. In this specification and the like, unless otherwise specified, charge voltage is shown with reference to the potential of a lithium metal.

The positive electrode active material 115 is preferred because the crystal structure with the symmetry of R-3m O3 can be kept even when charge is performed at a high charge voltage. As the high charge voltage, for example, a voltage higher than or equal to 4.6 V at 25° C. can be given. As a higher charge voltage, for example, a voltage higher than or equal to 4.65 V and lower than or equal to 4.7 V at 25° C. can be given.

In the positive electrode active material 115, when the charge voltage is increased, the H1-3 type crystal is observed little by little in some cases. As described above, the crystal structure is influenced by the number of charge and discharge cycles, charge and discharge current, an electrolyte, and the like, so that the positive electrode active material 115 of one embodiment of the present invention sometimes has the O3′ type crystal structure even at a lower charge voltage, e.g., a charge voltage of higher than or equal to 4.5 V and lower than 4.6 V, at 25° C.

Note that in the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Thus, in the case of a secondary battery using graphite as a negative electrode active material, a similar crystal structure is obtained at a voltage obtained by subtracting the potential of the graphite from the above-described voltage.

Although a chance of the existence of lithium is the same in all lithium sites in O3′ in FIG. 13, one embodiment of the present invention is not limited thereto. Lithium may exist unevenly in only some of the lithium sites; for example, lithium may symmetrically exist as in the monoclinic O1 (Li_{0.5}CoO₂) illustrated in FIG. 15. Distribution of lithium can be analyzed by neutron diffraction, for example.

The O3′ type crystal structure can be regarded as a crystal structure that contains lithium between CoO₂ layers randomly and is similar to a CdCl₂ type crystal structure. The crystal structure similar to the CdCl₂ type crystal structure is close to a crystal structure of lithium nickel oxide when charged up to a charge depth of Li_{0.06}NiO₂; however, pure lithium cobalt oxide or a layered rock-salt positive electrode active material containing a large amount of cobalt is known not to have the CdCl₂ type crystal structure in general.

A slight amount of the additive element such as magnesium randomly existing between the CoO₂ layers, i.e., in lithium sites, can inhibit a shift in the CoO₂ layers at the time of charge at a high voltage. Thus, magnesium between the CoO₂ layers makes it easier to obtain the O3′ type crystal structure. Therefore, magnesium is distributed in at least the surface portion of the positive electrode active material 115 of one embodiment of the present invention, preferably distributed throughout the positive electrode active material 115. To distribute magnesium throughout the positive electrode active material 115, heat treatment is preferably performed in the formation process of the positive electrode active material 115 of one embodiment of the present invention.

However, heat treatment at an excessively high temperature might cause cation mixing, which increases the possibility of entry of the additive element such as magnesium into the cobalt sites. Magnesium in the cobalt sites does not have the effect of maintaining the structure belonging to R-3m in high-voltage charge. Furthermore, heat treatment at an excessively high temperature might have an adverse effect; for example, cobalt might be reduced to have a valence of two or lithium might be evaporated.

In view of the above, a halogen compound such as a fluorine compound is preferably added to lithium cobalt oxide before the heat treatment for distributing magnesium in the positive electrode active material 115. The addition of the halogen compound decreases the melting point of lithium cobalt oxide. The decrease in the melting point makes it easier to distribute magnesium in the positive electrode active material 115 at a temperature at which the cation mixing is unlikely to occur. Furthermore, the fluorine compound probably increases corrosion resistance to hydrofluoric acid generated by decomposition of an electrolyte solution.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material of one embodiment of the present invention is preferably greater than or equal to 0.001 times and less than or equal to 0.1 times, further preferably greater than 0.01 times and less than 0.04 times, still further preferably approximately 0.02 times the number of transition metal atoms such as cobalt atoms. The magnesium concentration described here may be a value obtained by element analysis on all the particles of the positive electrode active material 115 using ICP-MS or the like, or may be a value based on the ratio of the raw materials mixed in the process of forming the positive electrode active material, for example.

As a metal other than cobalt (hereinafter, a metal Z), one or more metals selected from nickel, aluminum, manganese, titanium, vanadium, and chromium may be added to lithium cobalt oxide, for example, and in particular, one or both of nickel and aluminum are preferably added. In some cases, manganese, titanium, vanadium, and chromium are likely to have a valence of four stably and thus contribute highly to a stable structure. The addition of the metal Z may enable the crystal structure to be more stable in a high-voltage charged state. Here, in the positive electrode active material of one embodiment of the present invention, the metal Z is preferably added at a concentration that does not greatly change the crystallinity of the lithium cobalt oxide. For example, the metal Z is preferably added at an amount with which the aforementioned Jahn-Teller effect is not exhibited.

Aluminum and the transition metal typified by nickel and manganese preferably exist in cobalt sites, but part of them may exist in lithium sites. Magnesium preferably exists in lithium sites. Fluorine may be substituted for part of oxygen.

As the magnesium concentration in the positive electrode active material of one embodiment of the present invention increases, the capacity of the positive electrode active material decreases in some cases. As an example, one possible reason is that the amount of lithium that contributes to charge and discharge decreases when magnesium enters the lithium sites. Another possible reason is that excess magnesium generates a magnesium compound that does not contribute to charge and discharge. When the positive electrode active material of one embodiment of the present invention contains nickel as the metal Z in addition to magnesium, the capacity per weight and per volume can be increased in some cases. When the positive electrode active material of one embodiment of the present invention contains aluminum as the metal Z in addition to magnesium, the capacity per weight and per volume can be increased in some cases. When the positive electrode active material of one embodiment of the present invention contains nickel and aluminum in addition to magnesium, the capacity per weight and per volume can be increased in some cases.

The concentrations of the elements, such as magnesium and the metal Z, contained in the positive electrode active material of one embodiment of the present invention are discussed below.

When containing magnesium in addition to the element X, the positive electrode active material of one embodiment of the present invention is extremely stable in a high-voltage charged state. When the element X is phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. The phosphorus concentration and the magnesium concentration described here may each be a value obtained by element analysis on all the particles of the positive electrode active material using ICP-MS or the like, or may be a value based on the ratio of the raw materials mixed in the process of forming the positive electrode active material, for example.

The number of nickel atoms in the positive electrode active material of one embodiment of the present invention is preferably less than or equal to 10%, further preferably less than or equal to 7.5%, still further preferably greater than or equal to 0.05% and less than or equal to 4%, especially preferably greater than or equal to 0.1% and less than or equal to 2% of the number of cobalt atoms. The nickel concentration described here may be a value obtained by element analysis on all the particles of the positive electrode active material using ICP-MS or the like, or may be a value based on the ratio of the raw materials mixed in the process of forming the positive electrode active material, for example.

When a high-voltage charged state is held for a long time, the transition metal dissolves in an electrolyte solution from the positive electrode active material, and the crystal structure might be broken. However, when nickel is contained at the above-described proportion, dissolution of the transition metal from the positive electrode active material 115 can be inhibited in some cases.

The number of aluminum atoms in the positive electrode active material of one embodiment of the present invention is preferably greater than or equal to 0.05% and less than or equal to 4%, further preferably greater than or equal to 0.1% and less than or equal to 2% of the number of cobalt atoms. The aluminum concentration described here may be a value obtained by element analysis on all the particles of the positive electrode active material using ICP-MS or the like, or may be a value based on the ratio of the raw materials mixed in the process of forming the positive electrode active material, for example.

It is preferable that the positive electrode active material of one embodiment of the present invention contain the element X and phosphorus be used as the element X. The positive electrode active material of one embodiment of the present invention further preferably includes a composite oxide containing phosphorus and oxygen.

When the positive electrode active material of one embodiment of the present invention includes a composite oxide containing the element X, a short circuit is unlikely to occur while a high-voltage charged state is maintained, in some cases.

When the positive electrode active material of one embodiment of the present invention contains phosphorus as the element X, phosphorus may react with hydrogen fluoride generated by the decomposition of the electrolyte solution, which might decrease the hydrogen fluoride concentration in the electrolyte solution.

In the case where the electrolyte solution contains LiPF₆ as a lithium salt, hydrogen fluoride may be generated by hydrolysis. In some cases, hydrogen fluoride is generated by the reaction of PVDF used as a component of the positive electrode and alkali. The decrease in hydrogen fluoride concentration in the electrolyte solution can inhibit corrosion and/or coating film separation of a current collector in some cases. Furthermore, the decrease in hydrogen fluoride concentration in the electrolyte solution can inhibit a reduction in adhesion properties due to gelling and/or insolubilization of PVDF in some cases.

In the case where the positive electrode active material has a crack, phosphorus, more specifically, a composite oxide containing phosphorus and oxygen, in the inner portion may inhibit crack development, for example.

As is obvious from oxygen atoms indicated by arrows in FIG. 13, the symmetry of the oxygen atoms slightly differs between the O3 type crystal structure and the O3′ type crystal structure. Specifically, the oxygen atoms in the O3 type crystal structure are aligned with the dotted line, whereas strict alignment of the oxygen atoms is not observed in the O3′ type crystal structure. This is caused by an increase in the amount of tetravalent cobalt along with a reduction in the amount of lithium in the O3′ type crystal structure, resulting in an increase in the Jahn-Teller distortion. Consequently, the octahedral structure of CoO₆ is distorted. In addition, an increase in repulsion between oxygen atoms in the CoO₂ layer with a reduction in the amount of lithium also affects.

<<Surface Portion 115s>>

It is preferable that magnesium be distributed throughout a particle of the positive electrode active material 115 of one embodiment of the present invention, and it is further preferable that the magnesium concentration in the surface portion 115s be higher than the average magnesium concentration in the whole particle. For example, the magnesium concentration of the surface portion 115s measured by XPS or the like is preferably higher than the average magnesium concentration in all the particles measured by ICP-MS or the like.

In the case where the positive electrode active material 115 of one embodiment of the present invention contains an element other than cobalt, for example, one or more metals selected from nickel, aluminum, manganese, iron, and chromium, the concentration of the metal in the vicinity of the surface of the particle is preferably higher than the average concentration in the whole particle. For example, the concentration of the element other than cobalt in the surface portion 115s measured by XPS or the like is preferably higher than the average concentration of the element in all the particles measured by ICP-MS or the like.

The surface portion of the positive electrode active material is a kind of crystal defects and lithium is extracted from the surface during charge; thus, the lithium concentration in the surface portion tends to be lower than that in the inner portion. Therefore, the surface portion tends to be unstable and its crystal structure is likely to be broken. The higher the magnesium concentration in the surface portion 115s is, the more effectively the change in the crystal structure can be reduced. In addition, a high magnesium concentration in the surface portion 115s probably increases the corrosion resistance to hydrofluoric acid generated by the decomposition of the electrolyte solution.

The concentration of halogen such as fluorine in the surface portion 115s of the positive electrode active material 115 of one embodiment of the present invention is preferably higher than the average concentration in the whole positive electrode active material 115. When halogen exists in the surface portion 115s, which is in contact with the electrolyte solution, the corrosion resistance to hydrofluoric acid can be effectively increased.

As described above, the surface portion 115s of the positive electrode active material 115 of one embodiment of the present invention preferably has a composition different from that in the inner portion 115c, i.e., the concentrations of the additive elements such as magnesium and fluorine are preferably higher than those in the inner portion 115c. The surface portion 115s having such a composition preferably has a crystal structure stable at room temperature. Accordingly, the surface portion 115s may have a crystal structure different from that of the inner portion 115c. For example, at least part of the surface portion 115s of the positive electrode active material 115 of one embodiment of the present invention may have a rock-salt crystal structure. When the surface portion 115s and the inner portion 115c have different crystal structures, the orientations of crystals in the surface portion 115s and the inner portion 115c are preferably substantially aligned with each other.

Anions of a layered rock-salt crystal and anions of a rock-salt crystal have cubic close-packed structures (face-centered cubic lattice structures). Anions of an O3′ type crystal are presumed to have a cubic close-packed structure. When these crystals are in contact with each other, there is a crystal plane at which orientations of cubic close-packed structures composed of anions are aligned. Note that a space group of the layered rock-salt crystal and the O3′ type crystal is R-3m, which is different from the space group Fm-3m of a rock-salt crystal (a space group of a general rock-salt crystal) and the space group Fd-3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, a state where the orientations of the cubic close-packed structures composed of anions in the layered rock-salt crystal, the O3′ type crystal, and the rock-salt crystal are aligned is referred to as a state where crystal orientations are substantially aligned in some cases.

Substantial alignment of the crystal orientations in two regions can be judged from a TEM (transmission electron microscope) image, a STEM (scanning transmission electron microscope) image, a HAADF-STEM (high-angle annular dark-field scanning transmission electron microscope) image, an ABF-STEM (annular bright-field scanning transmission electron microscope) image, or the like. X-ray diffraction (XRD), electron diffraction, neutron diffraction, and the like can also be used for judging. When the crystal orientations are substantially aligned with each other, a state where an angle between the orientations of lines in each of which cations and anions are alternately arranged is less than or equal to 5°, preferably less than or equal to 2.5° is observed from a TEM image and the like. Note that in the TEM image and the like, a light element such as oxygen or fluorine cannot be clearly observed in some cases; however, in such a case, alignment of orientations can be judged by arrangement of metal elements.

However, in the surface portion 115s where only MgO is contained or MgO and CoO(II) form a solid solution, it is difficult to insert and extract lithium. Thus, the surface portion 115s should contain at least cobalt, and also contain lithium in a discharged state to have the path through which lithium is inserted and extracted. The cobalt concentration is preferably higher than the magnesium concentration.

The element X is preferably positioned in the surface portion 115s of the positive electrode active material 115 of one embodiment of the present invention. For example, the positive electrode active material 115 of one embodiment of the present invention may be covered with a coating film (a barrier layer) containing the element X.

### <<Grain Boundary>>

The additive element X included in the positive electrode active material 115 of one embodiment of the present invention may randomly exist in the inner portion at a slight concentration, but part of the additive element X is preferably segregated in a grain boundary.

In other words, the concentration of the additive element X in the grain boundary and its vicinity of the positive electrode active material 115 of one embodiment of the present invention is preferably higher than that in the other regions in the inner portion.

Like the particle surface, the grain boundary is also a plane defect. Thus, the grain boundary tends to be unstable and its crystal structure easily starts to change. Therefore, the higher the concentration of the additive element X in the grain boundary and its vicinity is, the more effectively the change in the crystal structure can be inhibited.

In the case where the concentration of the additive element X is high in the grain boundary and its vicinity, even when a crack is generated along the grain boundary of the positive electrode active material 115 of one embodiment of the present invention, the concentration of the additive element X is increased in the vicinity of the surface generated by the crack. Thus, the positive electrode active material can have an increased corrosion resistance to hydrofluoric acid even after a crack is generated.

Note that in this specification and the like, the vicinity of the grain boundary refers to a region that is within 50 nm, preferably within 35 nm, further preferably within 20 nm, most preferably within 10 nm from the grain boundary.

### <<Particle Diameter>>

When the particle diameter of the positive electrode active material 115 of one embodiment of the present invention is too large, there are problems such as difficulty in lithium diffusion and large surface roughness of an active material layer at the time when the material is applied to a current collector. By contrast, when the particle diameter is too small, there are problems such as difficulty in loading of the active material layer at the time when the material is applied to the current collector and overreaction with an electrolyte solution. Therefore, an average particle diameter (D50, also referred to as median diameter) is preferably greater than or equal to 1 μm and less than or equal to 100 μm, further preferably greater than or equal to 2 m and less than or equal to 40 μm, still further preferably greater than or equal to 5 μm and less than or equal to 30 μm.

### <Analysis Method>

Whether or not a positive electrode active material is the positive electrode active material 115 of one embodiment of the present invention that has an O3′ type crystal structure when charged at a high voltage can be determined by analyzing a high-voltage charged positive electrode using XRD, electron diffraction, neutron diffraction, electron spin resonance (ESR), nuclear magnetic resonance (NMR), or the like. XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example.

As described above, the positive electrode active material 115 of one embodiment of the present invention has a feature of a small change in the crystal structure between a high-voltage charged state and a discharged state. A material 50 wt % or more of which has the crystal structure that largely changes between a high-voltage charged state and a discharged state is not preferable because the material cannot withstand charge and discharge at a high voltage. In addition, it should be noted that an objective crystal structure is not obtained in some cases only by addition of additive elements. For example, although the positive electrode active material that is lithium cobalt oxide containing magnesium and fluorine is a commonality, the positive electrode active material has the O3′ type crystal structure at 60 wt % or more in some cases, and has the H1-3 type crystal structure at 50 wt % or more in other cases, when charged at a high voltage. Furthermore, the positive electrode active material has the O3′ type crystal structure at almost 100 wt % at a predetermined voltage, and increasing the voltage to be higher than the predetermined voltage may cause the H1-3 type crystal structure. Thus, to determine whether or not a positive electrode active material is the positive electrode active material 115 of one embodiment of the present invention, the crystal structure should be analyzed by XRD or other methods.

However, the crystal structure of a positive electrode active material in a high-voltage charged state or a discharged state may be changed with exposure to the air. For example, the O3′ type crystal structure changes into the H1-3 type crystal structure in some cases. For that reason, all samples are preferably handled in an inert atmosphere such as an argon atmosphere.

### <<Charge Method>>

High-voltage charge for determining whether or not a composite oxide is the positive electrode active material 115 of one embodiment of the present invention can be performed on a coin cell (CR2032 type with a diameter of 20 mm and a height of 3.2 mm) with a lithium counter electrode, for example.

More specifically, a positive electrode can be formed by application of slurry in which the positive electrode active material and a conductive material are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

As a separator, 25-μm-thick polypropylene can be used.

Stainless steel (SUS) can be used for a positive electrode can and a negative electrode can.

The coin cell fabricated with the above conditions is subjected to constant current charge at 4.6 V and 0.5 C and then constant voltage charge until the current value reaches 0.01 C. Note that 1 C is set to 137 mA/g here. The temperature is set to 25° C. After the charge is performed in this manner, the coin cell is disassembled in a glove box with an argon atmosphere to take out the positive electrode, whereby the positive electrode active material charged at a high voltage can be obtained. In order to inhibit a reaction with components in the external environment, the taken positive electrode is preferably enclosed in an argon atmosphere in performing various analyses later. For example, XRD can be performed on the positive electrode enclosed in an airtight container with an argon atmosphere.

### <<XRD>>

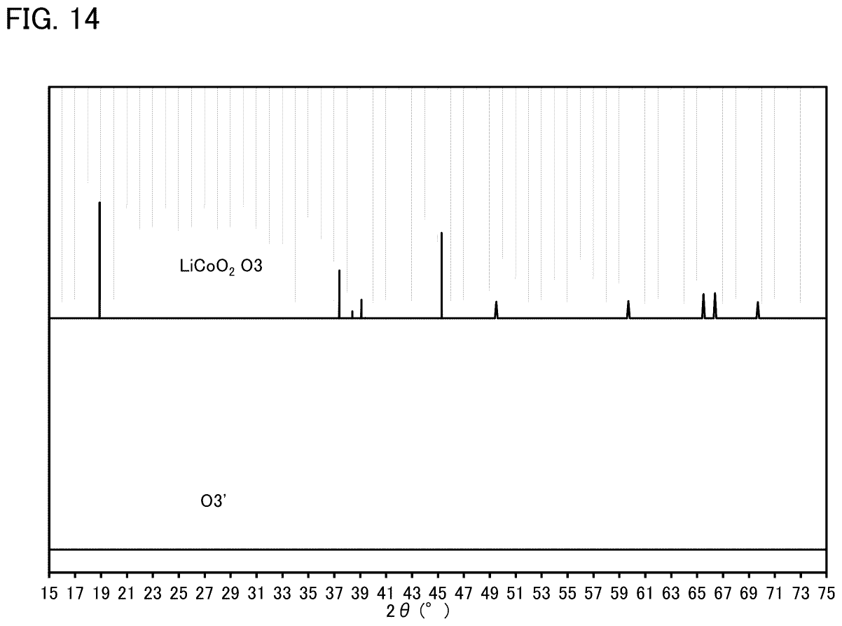

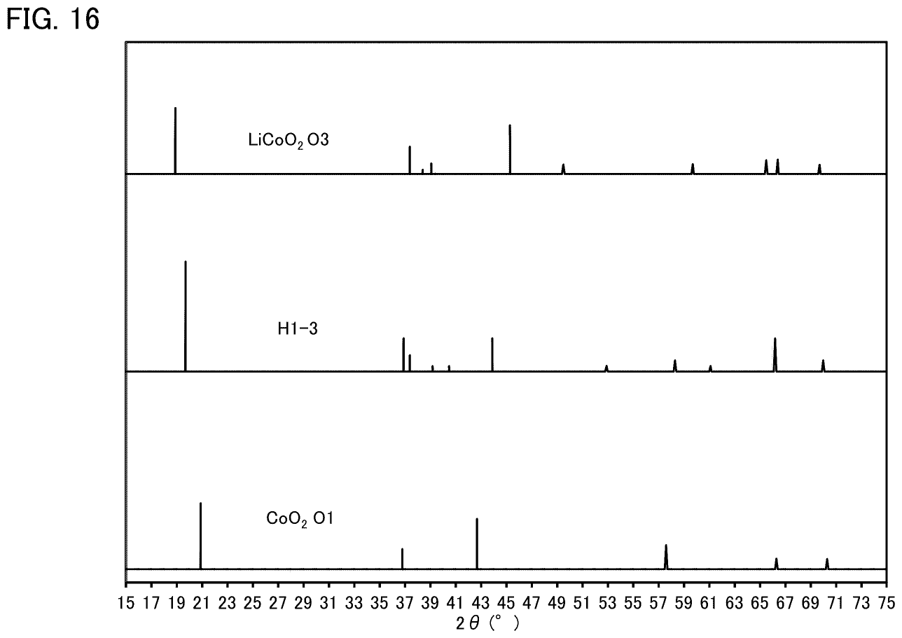

FIG. 14 and FIG. 16 show ideal powder XRD patterns with CuKα1 radiation that are calculated from models of the O3′ type crystal structure and the H1-3 type crystal structure. For comparison, ideal XRD patterns calculated from the crystal structure of LiCoO₂ O3 with x in LiₓCoO₂ of 1, the crystal structure of the H1-3 type, and the crystal structure of the trigonal O1 with x of 0 are also shown. Note that the patterns of LiCoO₂ O3 and CoO₂ O1 were made from crystal structure data obtained from ICSD (Inorganic Crystal Structure Database) (see Non-Patent Document 5) with Reflex Powder Diffraction, which is a module of Materials Studio (BIOVIA). The range of 2θ was from 15° to 75°, the step size was 0.01, the wavelength λ1 was 1.540562×10⁻¹⁰ m, the wavelength λ2 was not set, and a single monochromator was used. The pattern of the H1-3 type crystal structure was similarly made from the crystal structure data disclosed in Non-Patent Document 3. The O3′ type crystal structure was estimated from the XRD pattern of the positive electrode active material of one embodiment of the present invention, the crystal structure was fitted with TOPAS ver. 3 (crystal structure analysis software produced by Bruker Corporation), and the XRD pattern of the O3′ type crystal structure was made in a similar manner to other structures.

As shown in FIG. 14, the O3′ type crystal structure exhibits diffraction peaks at 2θ of 19.30±0.20° (greater than or equal to 19.10° and less than or equal to 19.50°) and 2θ of 45.55±0.10° (greater than or equal to 45.45° and less than or equal to 45.65°). More specifically, sharp diffraction peaks appear at 2θ of 19.30±0.10° (greater than or equal to 19.20° and less than or equal to 19.40°) and 2θ of 45.55±0.05° (greater than or equal to 45.50° and less than or equal to 45.60°). By contrast, as shown in FIG. 16, the H1-3 type crystal structure and CoO₂ O1 do not exhibit peaks at these positions. Thus, the peaks at 2θ of 19.30±0.20° and 2θ of 45.55±0.10° in a high-voltage charged state can be the features of the positive electrode active material 115 of one embodiment of the present invention.

It can be said that the positions of the XRD diffraction peaks exhibited at x=1 and x≤0.24 are close to each other. More specifically, it can be said that a difference in the positions of two or more, preferably three or more of the main diffraction peaks between the crystal structures is 2θ=0.7 or less, preferably 2θ=0.5 or less.

Although the positive electrode active material 115 of one embodiment of the present invention has the O3′ type crystal structure when x in LiₓCoO₂ is small, the entire crystal structure of the positive electrode active material 115 is not necessarily the O3′ type. The positive electrode active material 115 may have another crystal structure or be partly amorphous. Note that when the XRD patterns are subjected to the Rietveld analysis, the O3′ type crystal structure preferably accounts for greater than or equal to 50 wt %, further preferably greater than or equal to 60 wt %, still further preferably greater than or equal to 66 wt %. The positive electrode active material in which the O3′ type crystal structure accounts for greater than or equal to 50 wt %, preferably greater than or equal to 60 wt %, further preferably greater than or equal to 66 wt % can have sufficiently good cycle performance.

Furthermore, even after 100 or more cycles of charge and discharge after the cycle measurement starts, the O3′ type crystal structure preferably accounts for greater than or equal to 35 wt %, further preferably greater than or equal to 40 wt %, still further preferably greater than or equal to 43 wt %, in the Rietveld analysis.

The crystallite size of the O3′ type crystal structure of the positive electrode active material is only decreased to approximately one-tenth that of LiCoO₂ O3 in a discharged state. Thus, a clear peak of the O3′ type crystal structure can be observed when x in LiₓCoO₂ is small, even under the same XRD measurement conditions as those of a positive electrode before the charge and discharge. By contrast, simple LiCoO₂ has a small crystallite size and exhibits abroad and small peak although it can partly have a structure similar to the O3′ type crystal structure. The crystallite size can be calculated from the half width of the XRD peak.

As described above, the influence of the Jahn-Teller effect is preferably small in the positive electrode active material of one embodiment of the present invention. It is preferable that the positive electrode active material of one embodiment of the present invention have a layered rock-salt crystal structure and mainly contain cobalt as a transition metal. The positive electrode active material of one embodiment of the present invention may contain the above-described metal Z in addition to cobalt as long as the influence of the Jahn-Teller effect is small.

The range of the lattice constants where the influence of the Jahn-Teller effect is presumed to be small in the positive electrode active material is examined by XRD analysis.

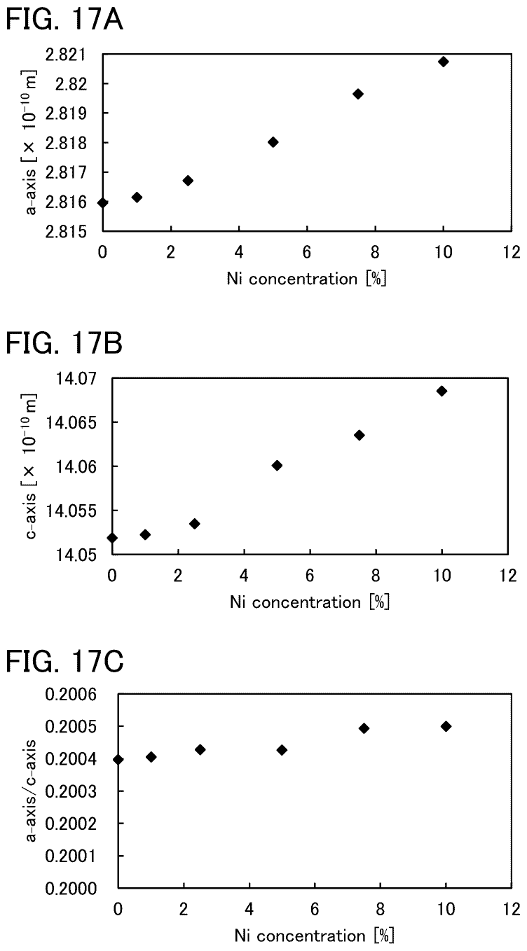

FIG. 17 shows the estimation results of the lattice constants of the a-axis and the c-axis by XRD in the case where the positive electrode active material of one embodiment of the present invention has a layered rock-salt crystal structure and contains cobalt and nickel. The positive electrode active material is formed through Step S11 to Step S34, which are described later, and at least a nickel source is used in Step S21. FIG. 17A shows the results of the a-axis, and FIG. 17B shows the results of the c-axis. Note that FIG. 17A and FIG. 17B show the results of a positive electrode active material powder obtained according to Step S11 to Step S34. That is, those are results obtained from the matter before being incorporated into a positive electrode. The nickel concentration (%) on the horizontal axis represents a nickel concentration proportion (percentage) with the sum of cobalt atoms and nickel atoms regarded as 100%. The nickel concentration proportion (percentage) can be obtained using a cobalt source and a nickel source.

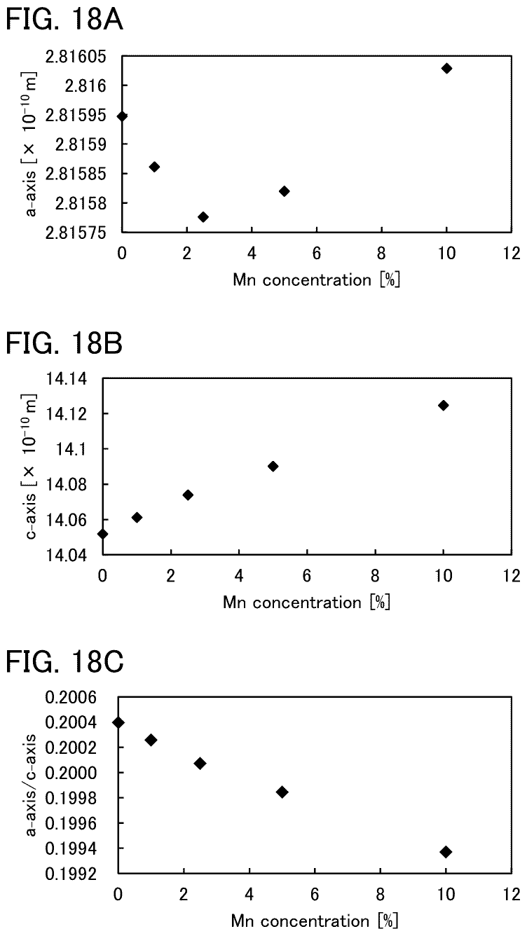

FIG. 18 shows the estimation results of the lattice constants of the a-axis and the c-axis using XRD patterns in the case where the positive electrode active material of one embodiment of the present invention has a layered rock-salt crystal structure and contains cobalt and manganese. The positive electrode active material is formed through Step S11 to Step S34, which are described later, and at least a manganese source is used in Step S21. FIG. 18A shows the results of the a-axis, and FIG. 18B shows the results of the c-axis. Note that FIG. 18A and FIG. 18B show the results of a positive electrode active material powder obtained according to Step S11 to Step S34. That is, those are results obtained from the matter before being incorporated into a positive electrode. The manganese concentration (%) on the horizontal axis represents a manganese concentration proportion (percentage) with the sum of cobalt atoms and manganese atoms regarded as 100%. The manganese concentration proportion (percentage) can be obtained using a cobalt source and a manganese source.

FIG. 17C shows values obtained by dividing the lattice constants of the a-axis by the lattice constants of the c-axis (a-axis/c-axis) in the positive electrode active material, whose results of the lattice constants are shown in FIG. 17A and FIG. 17B. FIG. 18C shows values obtained by dividing the lattice constants of the a-axis by the lattice constants of the c-axis (a-axis/c-axis) in the positive electrode active material, whose results of the lattice constants are shown in FIG. 18A and FIG. 18B.

As shown in FIG. 17C, the value of a-axis/c-axis tends to significantly change between nickel concentrations of 5% and 7.5% on the horizontal axis, indicating that the distortion of the a-axis becomes large. This distortion may be the Jahn-Teller distortion. It is suggested that an excellent positive electrode active material with small Jahn-Teller distortion can be obtained at a nickel concentration of lower than 7.5%.

FIG. 18A indicates that the lattice constant changes differently at manganese concentrations of 5% or higher and does not follow the Vegard's law. This suggests that the crystal structure changes at manganese concentrations of 5% or higher. Thus, the manganese concentration is preferably 4% or lower, for example.

Note that the nickel concentration and the manganese concentration in the surface portion 115s of the particle are not limited to the above ranges. That is, the nickel concentration and the manganese concentration in the surface portion 115s of the particle may be higher than the above concentrations.

Preferable ranges of the lattice constants of the positive electrode active material of one embodiment of the present invention are examined above. In the layered rock-salt crystal structure of the particle of the positive electrode active material in a discharged state or a state where charge and discharge are not performed, which can be estimated from the XRD patterns, the a-axis lattice constant is preferably greater than 2.814×10⁻¹⁰ m and less than 2.817×10⁻¹⁰ m, and the c-axis lattice constant is preferably greater than 14.05×10⁻¹⁰ m and less than 14.07×10⁻¹⁰ m. The state where charge and discharge are not performed may be the state of a powder before the fabrication of a positive electrode of a secondary battery.

Alternatively, in the layered rock-salt crystal structure of the particle of the positive electrode active material in the discharged state or the state where charge and discharge are not performed, the value obtained by dividing the a-axis lattice constant by the c-axis lattice constant (a-axis/c-axis) is preferably greater than 0.20000 and less than 0.20049.

Alternatively, when the layered rock-salt crystal structure of the particle of the positive electrode active material in the discharged state or the state where charge and discharge are not performed is subjected to XRD analysis, a first peak is observed at 20 of greater than or equal to 18.50° and less than or equal to 19.30°, and a second peak is observed at 20 of greater than or equal to 38.00° and less than or equal to 38.80°, in some cases.

Note that the peaks appearing in the powder XRD patterns reflect the crystal structure of the inner portion 115c of the positive electrode active material 115, which accounts for the majority of the volume of the positive electrode active material 115. The crystal structure of the surface portion 115s or the like can be analyzed by electron diffraction of a cross section of the positive electrode active material 115, for example.

### <<XPS>>

A region from the surface to a depth of 2 nm to 8 nm inclusive (normally, approximately 5 nm) can be analyzed by X-ray photoelectron spectroscopy (XPS); thus, the concentration of each element in approximately half of the surface portion 115s can be quantitatively analyzed. The bonding states of the elements can be analyzed by narrow scanning. Note that the quantitative accuracy of XPS is approximately ±1 atomic % in many cases. The lower detection limit is approximately 1 atomic % but depends on the element.

When the positive electrode active material 115 of one embodiment of the present invention is subjected to XPS analysis, the number of atoms of the additive element is preferably greater than or equal to 1.6 times and less than or equal to 6.0 times, further preferably greater than or equal to 1.8 times and less than 4.0 times the number of atoms of the transition metal. When the additive element is magnesium and the transition metal is cobalt, the number of magnesium atoms is preferably greater than or equal to 1.6 times and less than or equal to 6.0 times, further preferably greater than or equal to 1.8 times and less than 4.0 times the number of cobalt atoms. The number of atoms of halogen such as fluorine is preferably greater than or equal to 0.2 times and less than or equal to 6.0 times, further preferably greater than or equal to 1.2 times and less than or equal to 4.0 times the number of atoms of the transition metal.

In the XPS analysis, monochromatic aluminum can be used as an X-ray source, for example. An extraction angle is, for example, 45°.

In addition, when the positive electrode active material 115 of one embodiment of the present invention is analyzed by XPS, a peak indicating the bonding energy of fluorine with another element is preferably at greater than or equal to 682 eV and less than 685 eV, further preferably approximately 684.3 eV. This bonding energy is different from that of lithium fluoride (685 eV) and that of magnesium fluoride (686 eV). That is, in the case where the positive electrode active material 115 of one embodiment of the present invention contains fluorine, the fluorine is preferably in the bonding state other than lithium fluoride and magnesium fluoride.

Furthermore, when the positive electrode active material 115 of one embodiment of the present invention is analyzed by XPS, a peak indicating the bonding energy of magnesium with another element is preferably at greater than or equal to 1302 eV and less than 1304 eV, further preferably approximately 1303 eV. This bonding energy is different from that of magnesium fluoride (1305 eV) and is close to that of magnesium oxide. That is, in the case where the positive electrode active material 115 of one embodiment of the present invention contains magnesium, the magnesium is preferably in the bonding state other than magnesium fluoride.

The concentration of the additive element that preferably exists in the surface portion 115s in a large amount, such as magnesium or aluminum, measured by XPS or the like is preferably higher than the concentration measured by ICP-MS (inductively coupled plasma mass spectrometry), GD-MS (glow discharge mass spectrometry), or the like.

When a cross section is exposed by processing and analyzed by TEM-EDX, the concentration of magnesium or aluminum in the surface portion 115s is preferably higher than that in the inner portion 115c. An FIB can be used for the processing, for example.

In the XPS (X-ray photoelectron spectroscopy) analysis, the number of magnesium atoms is preferably greater than or equal to 0.4 times and less than or equal to 1.5 times the number of cobalt atoms. In the ICP-MS analysis, the atomic ratio of magnesium to cobalt (Mg/Co) is preferably greater than or equal to 0.001 and less than or equal to 0.06.

By contrast, it is preferable that nickel, which is one of the transition metals, not be unevenly distributed in the surface portion 115s but be distributed in the entire positive electrode active material 115. Note that one embodiment of the present invention is not limited thereto in the case where the above-described region where the excess additive element is unevenly distributed exists.

<<Charge Curve and dQ/dV Curve>>

An unbalanced phase change is presumed to occur around a peak in a dQ/dV curve obtained by differentiating capacitance (Q) with voltage (V) (dQ/dV) from the charge curve, resulting in a large change in the crystal structure. Note that in this specification and the like, an unbalanced phase change refers to a phenomenon that causes a nonlinear change in physical quantity.

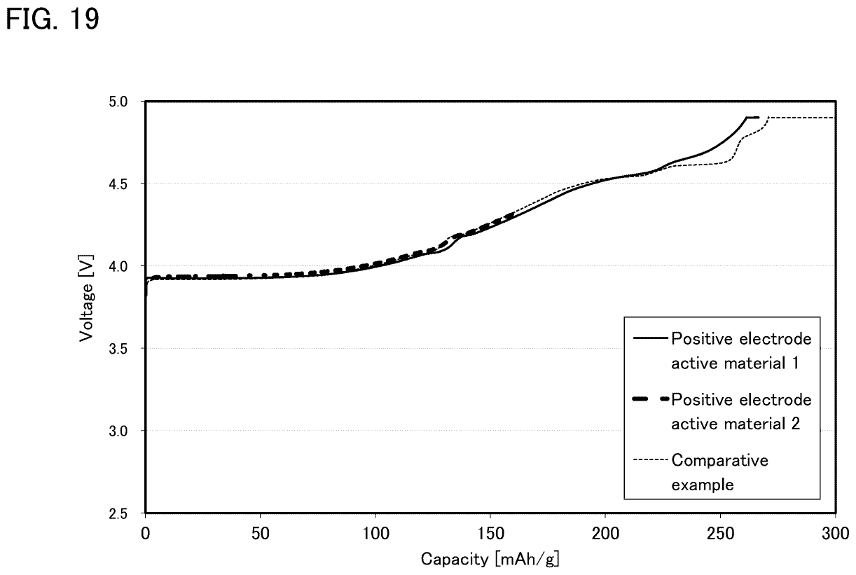

FIG. 19 shows charge curves of secondary batteries using the positive electrode active materials of embodiments of the present invention and a secondary battery using a positive electrode active material of a comparative example.

A positive electrode active material 1 of the present invention in FIG. 19 was formed by the formation method described in Embodiment 4 with reference to FIG. 9A and FIG. 9B. More specifically, the positive electrode active material 1 was formed by using lithium cobalt oxide (C-10N, produced by Nippon Chemical Industrial Co., Ltd.) as LiMO₂ in Step S14, mixing LiF and MgF₂, and performing heating. With the use of the positive electrode active material, a half cell was fabricated and charged in a manner similar to that of the fabrication and charge for the XRD measurement.

A positive electrode active material 2 of the present invention in FIG. 19 was formed by the formation method described in Embodiment 4 with reference to FIG. 9A and FIG. 9C. More specifically, the positive electrode active material 2 was formed by using lithium cobalt oxide (C-10N, produced by Nippon Chemical Industrial Co., Ltd.) as LiMO₂ in Step S14, mixing LiF, MgF₂, Ni(OH)₂, and Al(OH)₃, and performing heating. With the use of the positive electrode active material, a half cell was fabricated and charged in a manner similar to that of the fabrication and charge for the XRD measurement.

The positive electrode active material of the comparative example in FIG. 19 was formed by forming a layer containing aluminum on a surface of lithium cobalt oxide (C-5H, produced by Nippon Chemical Industrial Co., Ltd.) by a sol-gel method and performing heating at 500° C. for 2 hours. With the use of the positive electrode active material, a half cell was fabricated and charged in a manner similar to that of the fabrication and charge for the XRD measurement.

The charge curves in FIG. 19 are of the half cells charged up to 4.9 V at 25° C. at 10 mAh/g. Note that n of the positive electrode active material 1 and the comparative example is 2, and n of the positive electrode active material 2 is 1.

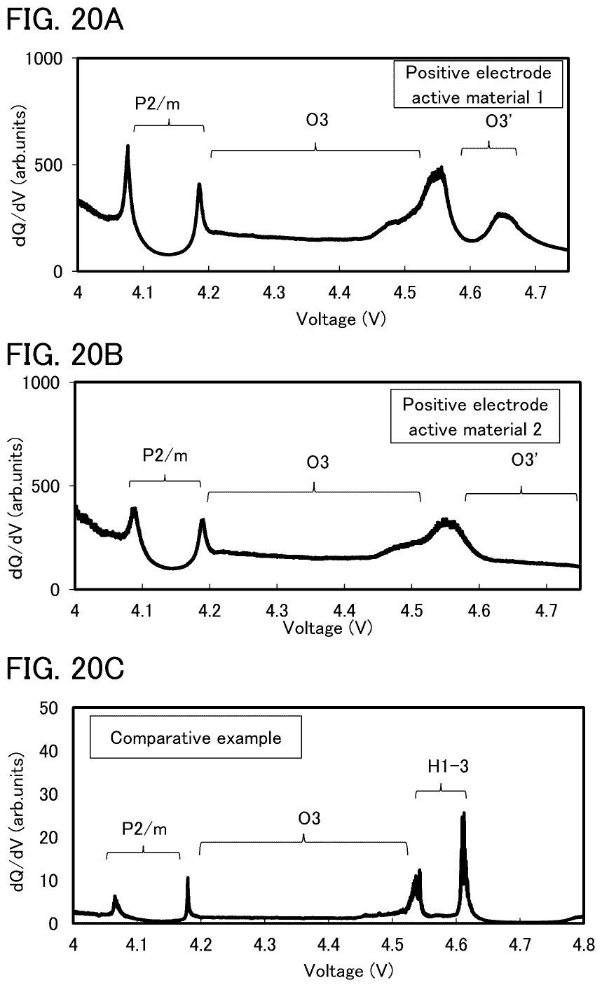

FIG. 20A to FIG. 20C show dQ/dV curves showing the amount of change in voltage with respect to charge capacity, which are calculated from the data of FIG. 19. FIG. 20A shows a dQ/dV curve of the half cell using the positive electrode active material 1 of one embodiment of the present invention, FIG. 20B shows a dQ/dV curve of the half cell using the positive electrode active material 2 of one embodiment of the present invention, and FIG. 20C shows a dQ/dV curve of the half cell using the positive electrode active material of the comparative example.

As apparent from FIG. 20A to FIG. 20C, in each of the embodiments of the present invention and the comparative example, peaks were observed at voltages of approximately 4.06 V and approximately 4.18 V, and the change in capacity with respect to voltage was nonlinear. The crystal structure with x in LiₓCoO₂ of 0.5 (space group P2/m) is probably between these two peaks. In the space group P2/m with x in LiₓCoO₂ of 0.5, lithium is arranged as illustrated in FIG. 15. It is suggested that energy is used for this lithium arrangement, and thus the change in capacity with respect to voltage becomes nonlinear.

In addition, in the comparative example of FIG. 20C, large peaks were observed at approximately 4.54 V and approximately 4.61 V. An H1-3 phase type crystal structure is probably between these two peaks.

Meanwhile, in the secondary batteries of embodiments of the present invention of FIG. 20A and FIG. 20B showing extremely excellent cycle performance, a small peak was observed at approximately 4.55 V but it was not clear. Moreover, the positive electrode active material 2 does not show the next peak at voltages exceeding 4.7 V, suggesting that the O3′ structure is kept. Thus, in the dQ/dV curves of the secondary batteries using the positive electrode active materials of embodiments of the present invention, some peaks might be extremely broad or small at 25° C. In such a case, there is a possibility that two crystal structures coexist. For example, two phases of O3 and O3′ may coexist, or two phases of 03′ and H1-3 may coexist.

<<Discharge Curve and dQ/dV Curve>>

Moreover, when the positive electrode active material of one embodiment of the present invention is discharged at a low rate of, for example, 0.2 C or less after high-voltage charge, a characteristic change in voltage appears just before the end of discharge, in some cases. This change can be clearly observed by the fact that at least one peak appears within the range to 3.5 V at a voltage lower than that of a peak which appears around 3.9 V in a dQ/dV curve calculated from a discharge curve.

### <<Surface Roughness and Specific Surface Area>>

The positive electrode active material 115 of one embodiment of the present invention preferably has a smooth surface with little unevenness. A smooth surface with little unevenness indicates favorable distribution of the additive element in the surface portion 115s.

A smooth surface with little unevenness can be recognized from, for example, a cross-sectional SEM image or a cross-sectional TEM image of the positive electrode active material 115 or the specific surface area of the positive electrode active material 115.

The level of the surface smoothness of the positive electrode active material 115 can be quantified from its cross-sectional SEM image, as described below, for example.

First, the positive electrode active material 115 is processed with an FIB or the like such that its cross section is exposed. At this time, the positive electrode active material 115 is preferably covered with a protection film, a protection agent, or the like. Next, a SEM image of the interface between the positive electrode active material 115 and the protection film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 115 and the protection film or the like is selected with a magic hand tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square (RMS) surface roughness is obtained by calculating standard deviation.

On the particle surface of the positive electrode active material 115 of this embodiment, root-mean-square (RMS) surface roughness, which is an index of roughness, is less than or equal to 10 nm, preferably less than 3 nm, further preferably less than 1 nm, still further preferably less than 0.5 nm.

Note that the image processing software used for the noise processing, the interface extraction, or the like is not particularly limited, and for example, “ImageJ” can be used. In addition, the spreadsheet software or the like is not particularly limited, and Microsoft Office Excel can be used, for example.

For example, the level of surface smoothness of the positive electrode active material 115 can also be quantified from the ratio of an actual specific surface area A_{R} measured by a constant-volume gas adsorption method to an ideal specific surface area Aᵢ.

The ideal specific surface area Aᵢ is calculated on the assumption that all the particles have the same diameter as D50, have the same weight, and have ideal spherical shapes.

The median diameter D50 can be measured with a particle size distribution analyzer or the like using a laser diffraction and scattering method. The specific surface area can be measured with a specific surface area analyzer or the like by a constant-volume gas adsorption method, for example.

In the positive electrode active material 115 of one embodiment of the present invention, the ratio of the actual specific surface area A_{R} to the ideal specific surface area Aᵢ obtained from the median diameter D50 (A_{R}/Aᵢ) is preferably less than or equal to 2.

This embodiment can be used in combination with the other embodiments.

### [Defects in Positive Electrode Active Material]

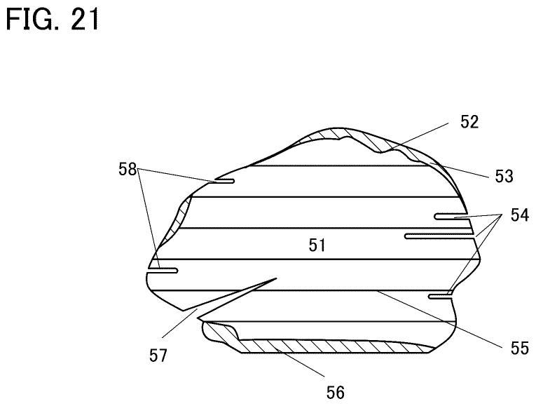

Examples of defects that can be generated in the positive electrode active material are shown in FIG. 21 to FIG. 31. An effect of inhibiting the generation of the defects can be expected in the positive electrode active material of one embodiment of the present invention.

With charge and discharge under a high-voltage condition at 4.5 V or higher or at a high temperature (45° C. or higher), a progressive defect such as a pit might be generated in the positive electrode active material. In addition, a crevice-like defect such as a crack is sometimes generated by expansion and contraction of the positive electrode active material due to charge and discharge. FIG. 21 is a schematic cross-sectional view of a positive electrode active material 51. Although pits 54 and 58 in the positive electrode active material 51 are illustrated as holes, their opening shapes are not circular and have a depth. Moreover, the positive electrode active material 51 sometimes has a crack 57. The positive electrode active material 51 has a crystal plane 55 and may have a depression 52. It is preferable that barrier layers 53 and 56 cover the positive electrode active material 51, and they may be separated. The barrier layer 53 covers the depression 52.

A positive electrode active material of a lithium-ion secondary battery is LCO or NCM typically, and can also be referred to as an alloy containing a plurality of metal elements (cobalt, nickel, and the like). At least one of a plurality of positive electrode active materials has a defect and the defect might change before and after charge and discharge. When used in a secondary battery, a positive electrode active material might undergo chemical or electrochemical erosion or degradation in the material quality due to environmental substances (e.g., an electrolyte solution) surrounding the positive electrode active material. This degradation does not occur uniformly in the surface of the positive electrode active material but occurs locally in a concentrated manner, and a defect is formed deeply from the surface toward the inner portion, for example, by repeated charge and discharge of the secondary battery.

Progress of a defect in a positive electrode active material to form a hole can be referred to as pitting corrosion.

In this specification, a crack and a pit are different from each other. Immediately after formation of a positive electrode active material, a crack can exist but a pit does not exist. A pit can also be regarded as a hole formed by extraction of some layers of cobalt or oxygen due to charge and discharge under a high-voltage condition at 4.5 V or higher or at a high temperature (45° C. or higher), i.e., a portion from which cobalt has been eluted. Therefore, there is no pit immediately after formation of the positive electrode active material. A crack refers to a surface newly generated by application of physical pressure or a crevice generated owing to a grain boundary. A crack might be caused by expansion and contraction of the particle due to charge and discharge. Furthermore, a pit might be generated from a crack or a cavity in the particle.

### <Disassembly of Secondary Battery>

Fifty cycles of charge and discharge tests were performed. The discharge capacity at the 50th cycle was reduced to be lower than 40% of that at the 1st cycle. The secondary battery was disassembled, and the positive electrode was extracted. The disassembly was performed in an argon atmosphere. After the disassembly, washing with DMC was performed, and then the solvent was volatilized. The positive electrode subjected to 50 cycles of charge and discharge tests and a positive electrode before being incorporated into the secondary battery, i.e., a positive electrode immediately after being fabricated, were observed.

### <SEM Observation>

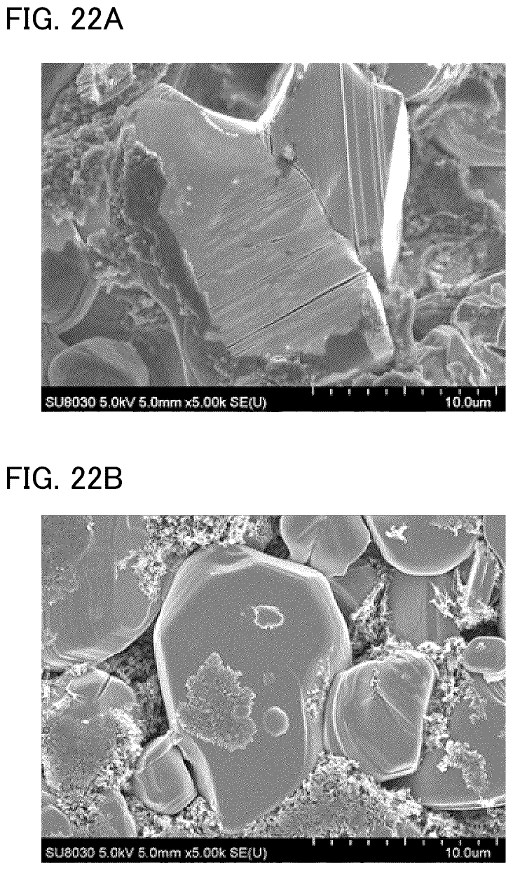

The positive electrodes were observed with a scanning electron microscope (SEM). FIG. 22A shows a SEM image of the positive electrode of the secondary battery after 50 cycles. FIG. 22B shows a SEM image of the positive electrode before being incorporated into the secondary battery. An SU8030 scanning electron microscope produced by Hitachi High-Tech Corporation was used for the SEM observation.

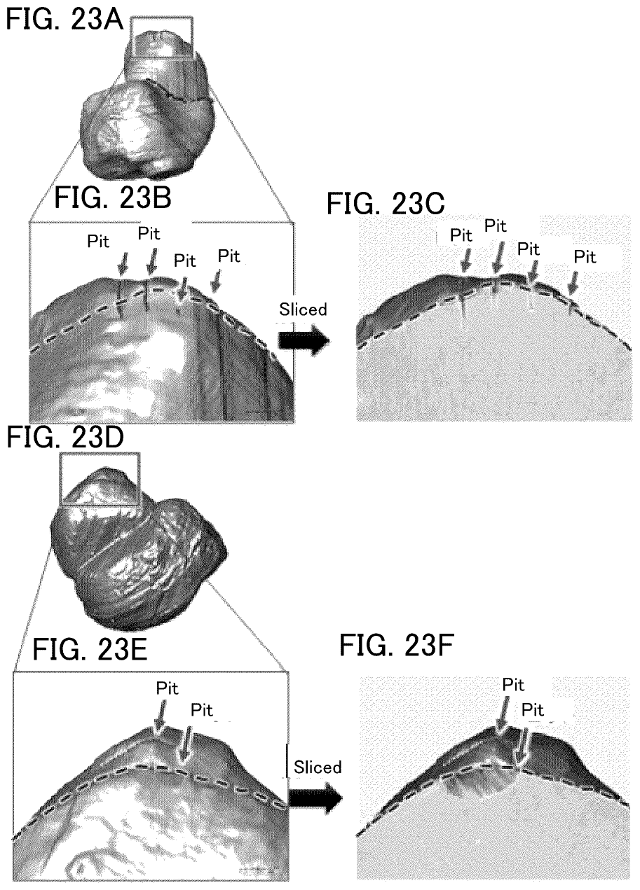

Next, the positive electrode active material was subjected to cross-section processing by an FIB, and the cross-section of the positive electrode active material was observed with a SEM. By repeating the cross-section processing by an FIB and the SEM observation, three-dimensional data on the structure shown in FIG. 23A or FIG. 23D can be obtained. Note that XVision 210B produced by Hitachi High-Tech Corporation was used for the FIB processing and the SEM observation.

FIG. 23B shows enlarged part of the front view of the three-dimensional data in FIG. 23A, and FIG. 23C shows its sliced cross section. Three-dimensional data on a side surface obtained by rotating the three-dimensional data in FIG. 23A corresponds to FIG. 23D. FIG. 23E shows enlarged part of FIG. 23D, and FIG. 23F shows its sliced cross section. As shown in FIG. 23F, a pit is not a hole but has a shape that can be referred to as a groove having a width or a split.

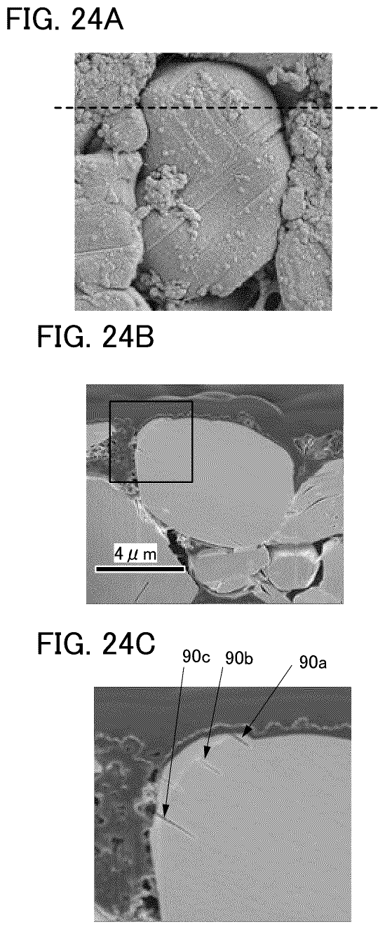

FIG. 24A shows a SEM image of the top surface of the positive electrode of the secondary battery after 50 cycles. FIG. 24B is a cross-sectional view taken along a dashed line in FIG. 24A. FIG. 24C is an enlarged view of a portion surrounded by a frame in FIG. 24B. Pits 90a, 90b, and 90c are shown in FIG. 24C.

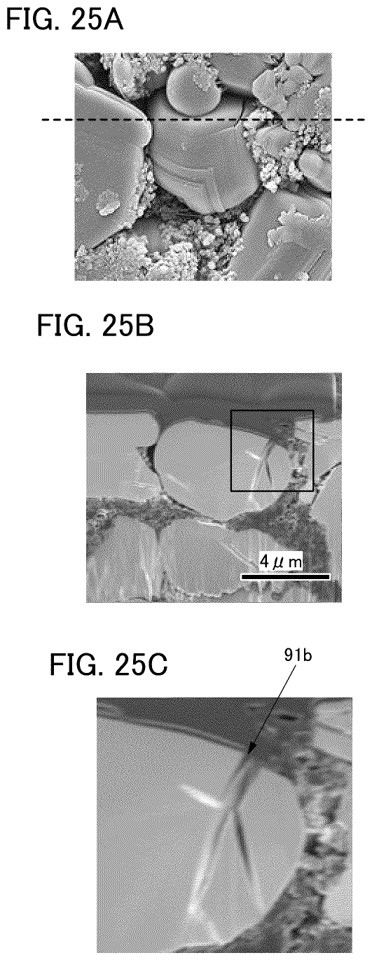

FIG. 25A shows a SEM image of the top surface of the positive electrode before being incorporated into the secondary battery. FIG. 25B is a cross-sectional view taken along a dashed line in FIG. 25A. FIG. 25C is an enlarged view of a portion surrounded by a frame in FIG. 25B. A crack 91b is shown in FIG. 25C.

As described above, pits and a crack were observed in the positive electrode after 50 cycles.

### <STEM Observation>

Then, a cross section of the positive electrode of the secondary battery after 50 cycles was observed with a scanning transmission electron microscope (STEM). An FIB was used for processing the sample for cross-sectional observation.

### <EDX Analysis>

The positive electrode of the secondary battery after 50 cycles was evaluated by energy dispersive X-ray spectroscopy (EDX).

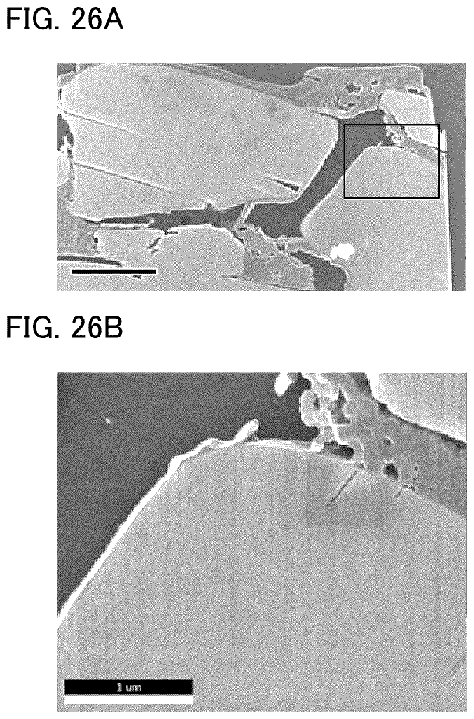

FIG. 26A shows a cross-sectional STEM image of the positive electrode. FIG. 26B is an enlarged view of a portion surrounded by a frame in FIG. 26A.

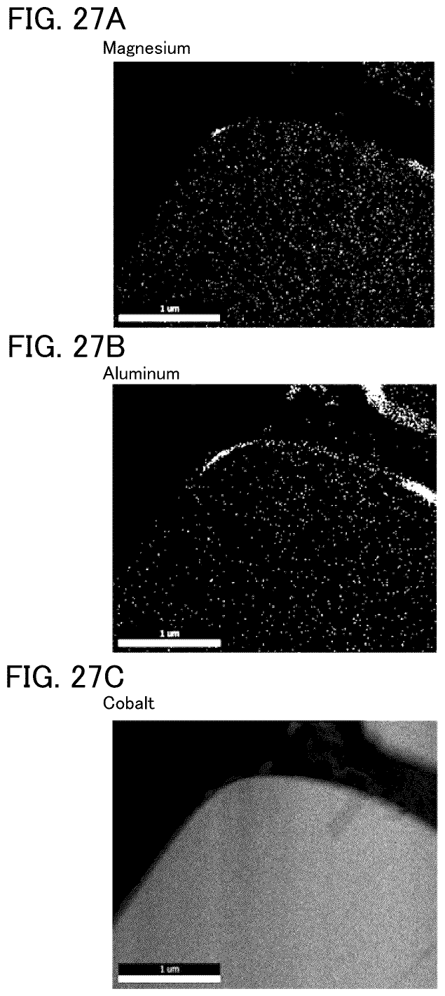

FIG. 27A to FIG. 27C show EDX maps of the region shown in FIG. 26B. FIG. 27A, FIG. 27B, and FIG. 27C show the EDX maps of magnesium, aluminum, and cobalt, respectively. For the EDX analysis, HD-2700 produced by Hitachi High-Tech Corporation was used. The accelerating voltage was set to 200 kV. The EDX maps suggest that magnesium and aluminum exist in at least part of the surface portion of the particle of the positive electrode active material.

### <Nanobeam Electron Diffraction>

Next, the crystal structures of the grain boundary of lithium cobalt oxide and the vicinity thereof were analyzed by nanobeam electron diffraction.

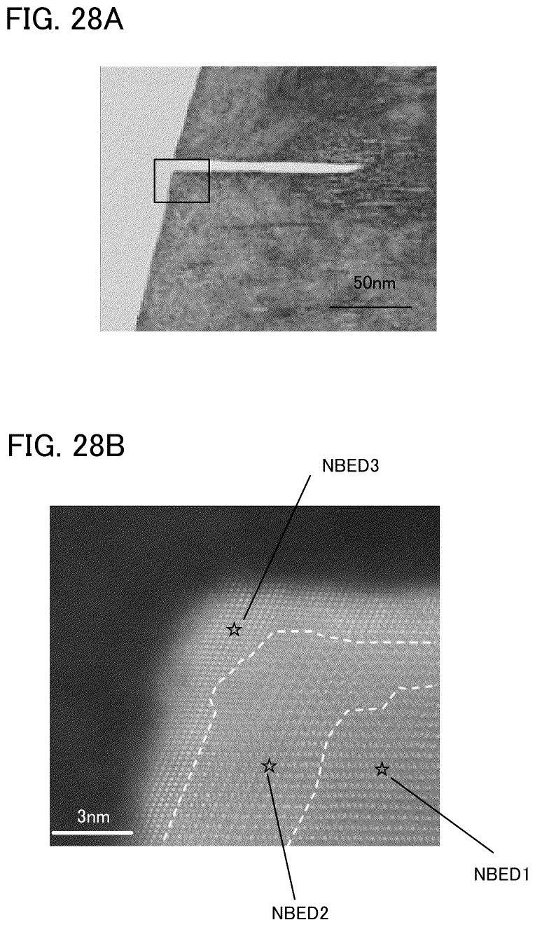

FIG. 28A is a cross-sectional TEM image of degraded lithium cobalt oxide after 50 cycles. FIG. 28B is an enlarged view of a portion surrounded by black lines in FIG. 28A. Portions analyzed by nanobeam electron diffraction are denoted by a star NBED1, a star NBED2, and a star NBED3 in FIG. 28B.

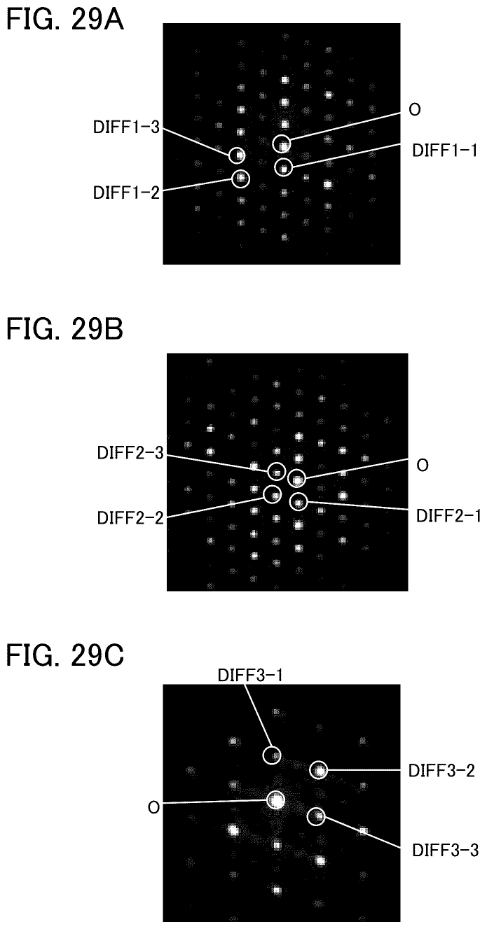

FIG. 29A shows a nanobeam electron diffraction pattern of the star NBED1 portion. Transmitted light is denoted by O, and some of diffraction spots are denoted by DIFF1-1, DIFF1-2, and DIFF1-3 in the FIGURE. From the analysis on the star NBED1 portion, the interplanar spacing of DIFF1-1, the interplanar spacing of DIFF1-2, and the interplanar spacing of DIFF1-3 were calculated as 0.475 nm, 0.199 nm, and 0.238 nm, respectively. The interplanar angles were ∠1O2=55°, ∠1O3=80°, and ∠2O3=24°. In this case, the incident direction of the electron beam is [0-10] and the interplanar spacings and the interplanar angles suggest that 1 is 10-2 of a layered rock-salt crystal, 2 is 10-5 of a layered rock-salt crystal, and 3 is 00-3 of a layered rock-salt crystal, which indicates that a crystal structure of LiCoO₂ is included.

FIG. 29B shows a nanobeam electron diffraction pattern of the star NBED2 portion. Transmitted light is denoted by O, and some of diffraction spots are denoted by DIFF2-1, DIFF2-2, and DIFF2-3 in the FIGURE. From the analysis on the star NBED2 portion, the interplanar spacing of 1, the interplanar spacing of 2, and the interplanar spacing of 3 were calculated as 0.468 nm, 0.398 nm, and 0.472 nm, respectively. The interplanar angles were φ1O2=54°, ∠1O3=110°, and ∠2O3=56°. The interplanar spacings and the interplanar angles suggest that 1, 2, and 3 are each a spinel crystal, which indicates that a crystal structure of CO₃O₄ or a crystal structure of LiCo₂O₄ is included.

FIG. 29C shows a nanobeam electron diffraction pattern of the star NBED3 portion. Transmitted light is denoted by O, and some of diffraction spots are denoted by DIFF3-1, DIFF3-2, and DIFF3-3 in the FIGURE. From the analysis on the star NBED1 portion, the interplanar spacing of 1, the interplanar spacing of 2, and the interplanar spacing of 3 were calculated as 0.241 nm, 0.210 nm, and 0.246 nm, respectively. The interplanar angles were φ1O2=55°, ∠1O3=110°, and ∠2O3=55°. The interplanar spacings and the interplanar angles suggest that 1, 2, and 3 are each a rock-salt crystal, which indicates that a crystal structure of CoO is included.

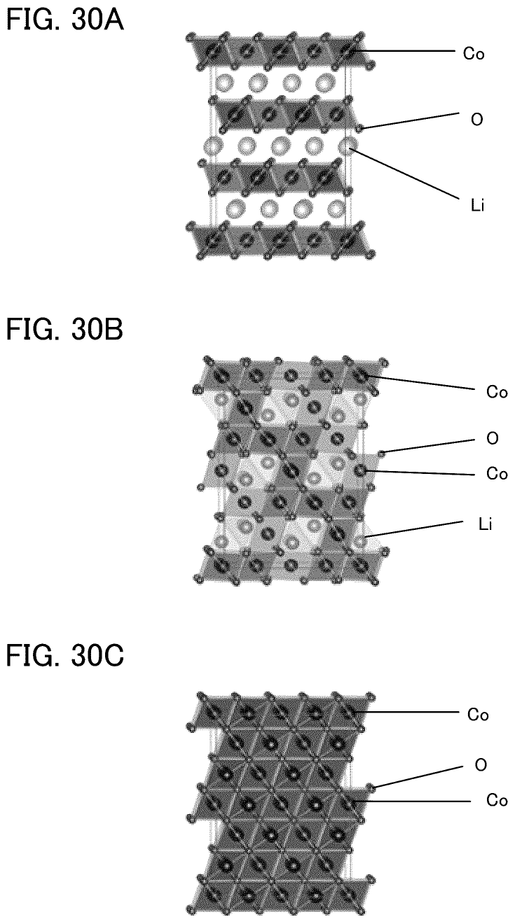

FIG. 30A shows a crystal structure of LiCoO₂, which is a layered rock-salt structure. FIG. 30B shows a crystal structure of LiCo₂O₄, which is a spinel crystal structure. FIG. 30C shows a crystal structure of CoO, which is a rock-salt crystal structure.

### <Slipping>

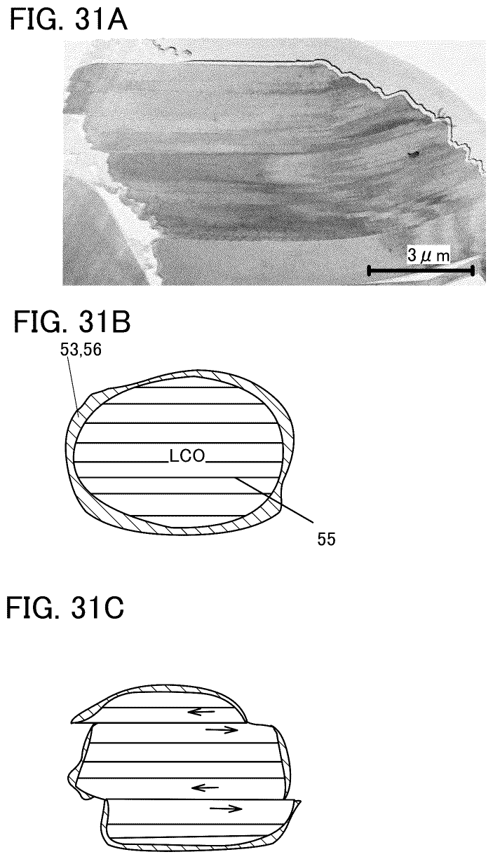

FIG. 31A is a cross-sectional STEM image of part of a positive electrode active material layer at the time after slurry to be the positive electrode active material layer is applied to a current collector and pressing is performed. There is a step on the particle surface in a direction (c-axis direction) perpendicular to lattice fringes owing to the pressing, and an evidence of deformation is found to be along the lattice fringe direction (ab plane direction).

FIG. 31B is a schematic cross-sectional view of the particle before being pressed. In the particle before being pressed, a barrier layer exists relatively uniformly on the particle surface along the direction perpendicular to the lattice fringes.

FIG. 31C is a schematic cross-sectional view of the particle after being pressed. Owing to the press step, distortion is generated in the lattice fringe direction (ab plane direction). Similarly, a barrier layer has a plurality of steps and is not uniform. With regard to the distortion in the ab plane direction, on a particle surface opposite to the surface where unevenness is observed, similarly shaped unevenness is also generated, and part of the particle has distortion in the ab plane direction.

The plurality of steps shown in FIG. 31C are observed as a stripe pattern on the particle surface. Such a stripe pattern on the particle surface, which is observed as the steps on the particle surface where distortion is caused owing to pressing, is called slipping (stacking fault). The slipping of the particle makes the barrier layer uneven, which might cause deterioration. Thus, it is desirable that the positive electrode active material have little or no slipping.

This embodiment can be implemented in appropriate combination with the other embodiments.

### Embodiment 5

This embodiment will describe examples of shapes of several types of secondary batteries including a positive electrode or a negative electrode fabricated by the fabrication method described in the foregoing embodiment.

### [Coin-Type Secondary Battery]

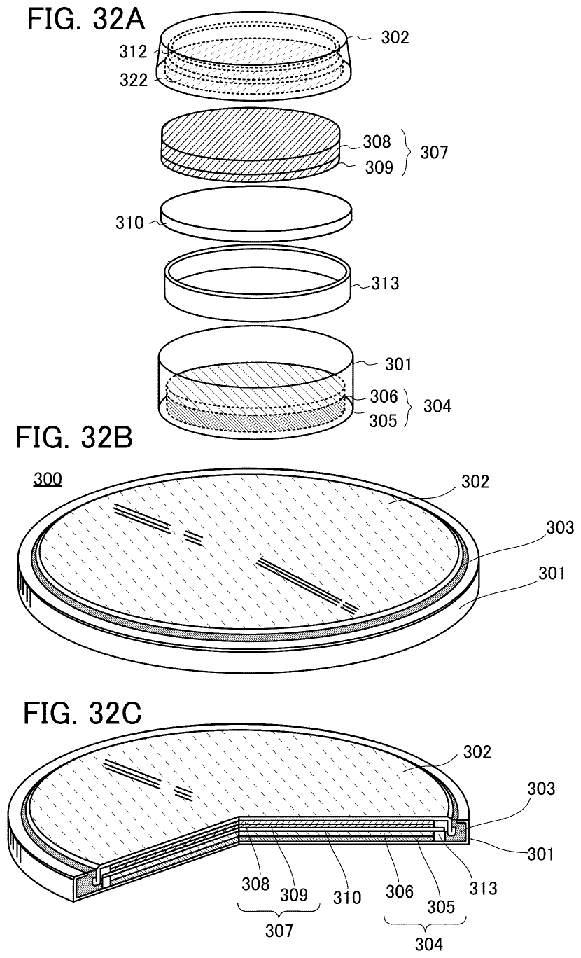

An example of a coin-type secondary battery will be described. FIG. 32A is an exploded perspective view of a coin-type (single-layer flat) secondary battery, FIG. 32B is an external view, and FIG. 32C is a cross-sectional view thereof. Coin-type secondary batteries are mainly used in small electronic devices. In this specification and the like, coin-type batteries include button-type batteries.

For easy understanding, FIG. 32A is a schematic view illustrating overlap (a vertical relation and a positional relation) between components. Thus, FIG. 32A and FIG. 32B do not completely correspond with each other.

In FIG. 32A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 32A. The spacer 322 and the washer 312 are used to protect the inside or fix the position of the components inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

To prevent a short circuit between the positive electrode and the negative electrode, the separator 310 and a ring-shaped insulator 313 are provided to cover the side surface and top surface of the positive electrode 304. The separator 310 has a larger flat surface area than the positive electrode 304.

FIG. 32B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of the current collector of each of the positive electrode 304 and the negative electrode 307 used for the coin-type secondary battery 300 is provided with an active material layer.

For the positive electrode can 301 and the negative electrode can 302, a metal having corrosion resistance to an electrolyte, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 32C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

The coin-type secondary battery 300 has high capacity, high discharge capacity, and excellent cycle performance. Note that the separator 310 is not necessarily provided between the negative electrode 307 and the positive electrode 304.

### [Cylindrical Secondary Battery]

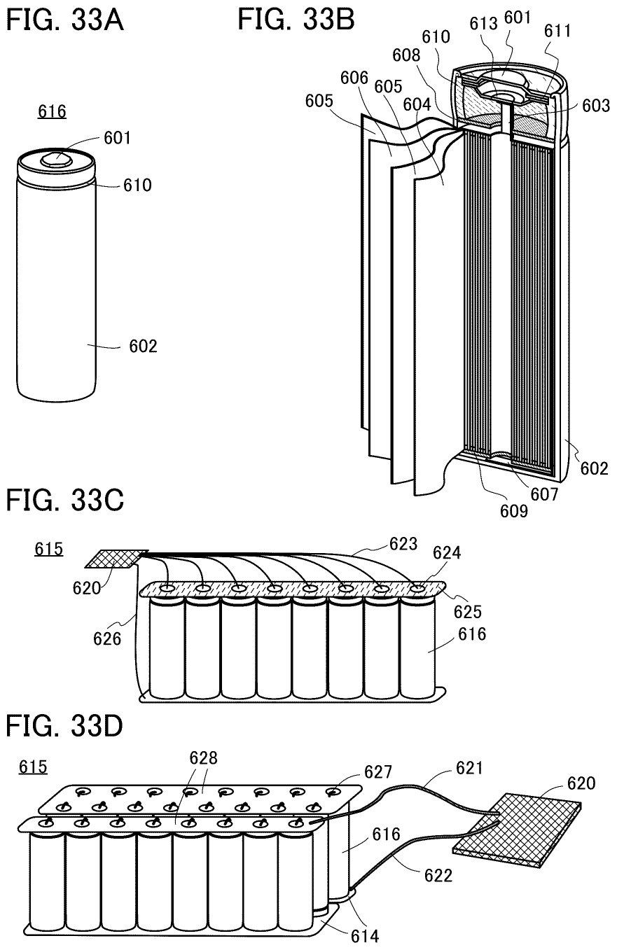

An example of a cylindrical secondary battery is described with reference to FIG. 33A. As illustrated in FIG. 33A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 33B schematically illustrates a cross section of a cylindrical secondary battery. The cylindrical secondary battery illustrated in FIG. 33B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around the central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. The inside of the battery can 602 provided with the battery element is filled with a nonaqueous electrolyte solution (not illustrated). As the nonaqueous electrolyte solution, an electrolyte solution similar to that for the coin-type secondary battery can be used.

Since a positive electrode and a negative electrode that are used for a cylindrical storage battery are wound, active materials are preferably formed on both surfaces of a current collector. Although FIG. 33A to FIG. 33D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

The positive electrode active material 115 obtained in Embodiment 1 is used in the positive electrode 604, whereby the cylindrical secondary battery 616 can have high capacity, high discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 33C illustrates an example of a power storage system 615. The power storage system 615 includes a plurality of the secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge or the like can be used, for example.

FIG. 33D illustrates an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel or connected in series; alternatively, the plurality of secondary batteries 616 may be connected in parallel and then connected in series. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 33D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### Other Structure Examples of Secondary Battery

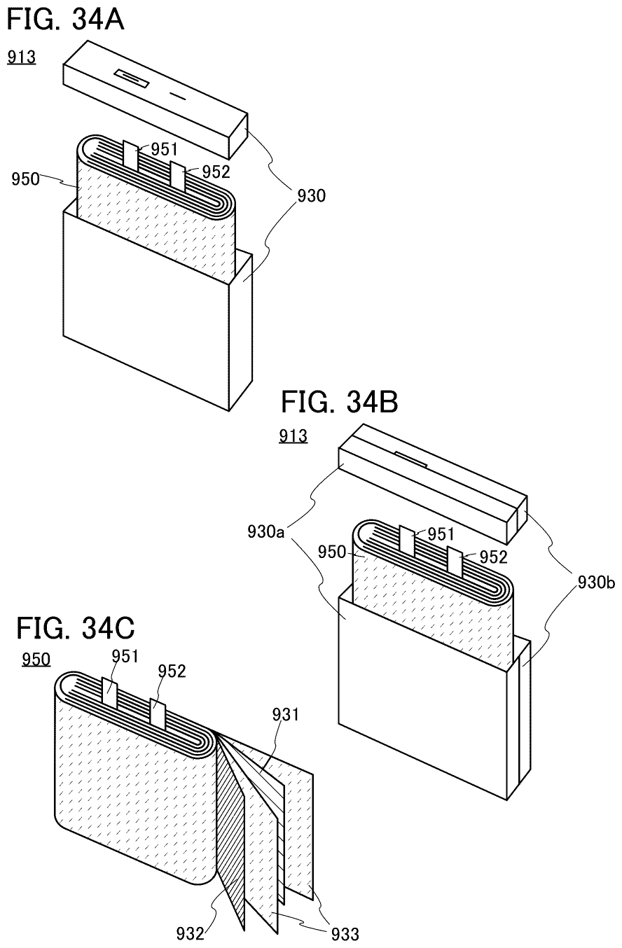

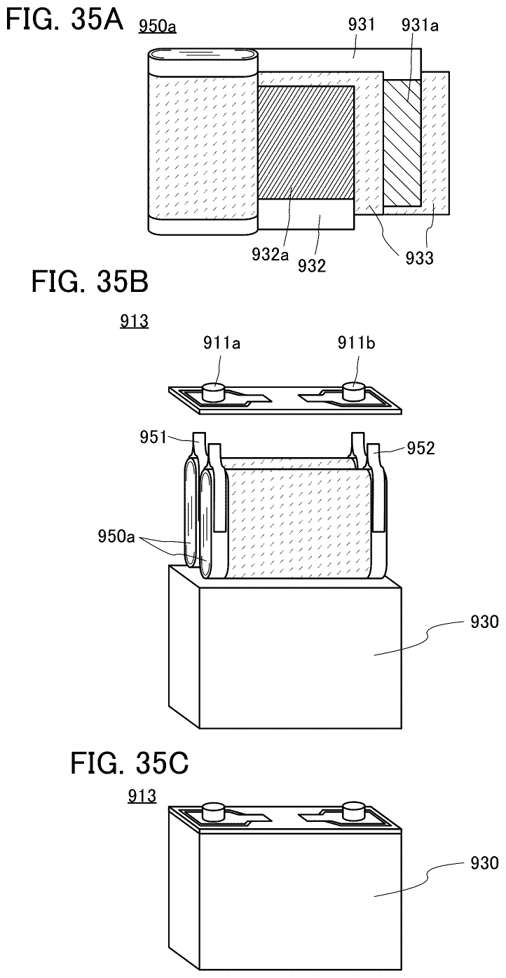

Structure examples of secondary batteries are described with reference to FIG. 34 and FIG. 35.

A secondary battery 913 illustrated in FIG. 34A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 34A, the housing 930 divided into two pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 34B, the housing 930 illustrated in FIG. 34A may be formed using a plurality of materials. For example, in the secondary battery 913 illustrated in FIG. 34B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 34C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be overlaid.

As illustrated in FIG. 35A to FIG. 35C, the secondary battery 913 may include a wound body 950a. The wound body 950a illustrated in FIG. 35A includes the negative electrode 931, the positive electrode 932, and the separators 933. The negative electrode 931 includes a negative electrode active material layer 931a. The positive electrode 932 includes a positive electrode active material layer 932a.

The positive electrode active material 115 obtained in Embodiment 1 is used in the positive electrode 932, whereby the secondary battery 913 can have high capacity, high discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 35B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 35C, the wound body 950a and an electrolyte solution are covered with the housing 930, whereby the secondary battery 913 is completed. The housing 930 is preferably provided with a safety valve, an overcurrent protection element, and the like. A safety valve is a valve for releasing a gas, in order to prevent the battery from exploding, when the pressure inside the housing 930 reaches a predetermined pressure.

As illustrated in FIG. 35B, the secondary battery 913 may include a plurality of the wound bodies 950a. The use of the plurality of wound bodies 950a enables the secondary battery 913 to have higher discharge capacity. The description of the secondary battery 913 illustrated in FIG. 34A to FIG. 34C can be referred to for the other components of the secondary battery 913 illustrated in FIG. 35A and FIG. 35B.

### <Laminated Secondary Battery>

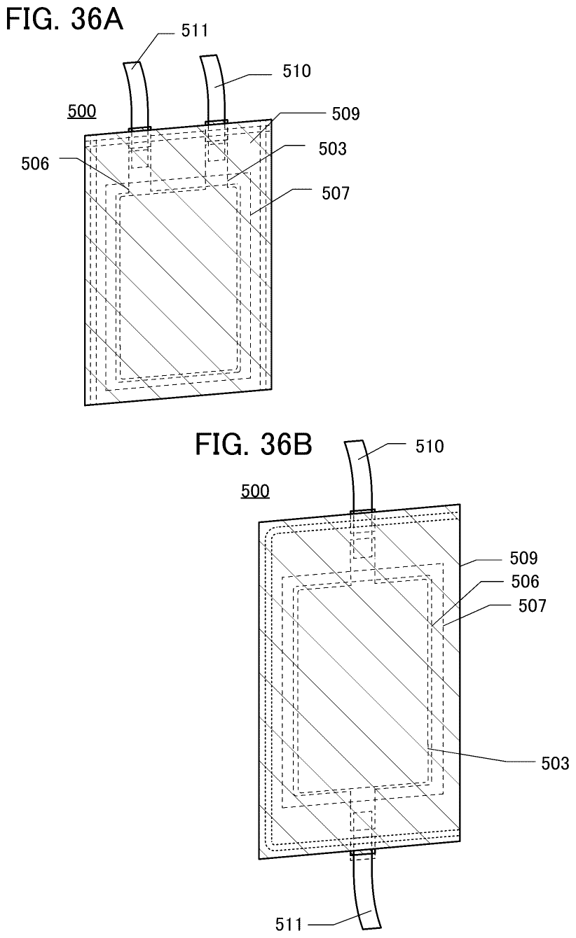

Next, examples of the appearance of a laminated secondary battery are illustrated in FIG. 36A and FIG. 36B. FIG. 36A and FIG. 36B each illustrate a positive electrode 503, a negative electrode 506, a separator 507, an exterior body 509, a positive electrode lead electrode 510, and a negative electrode lead electrode 511.

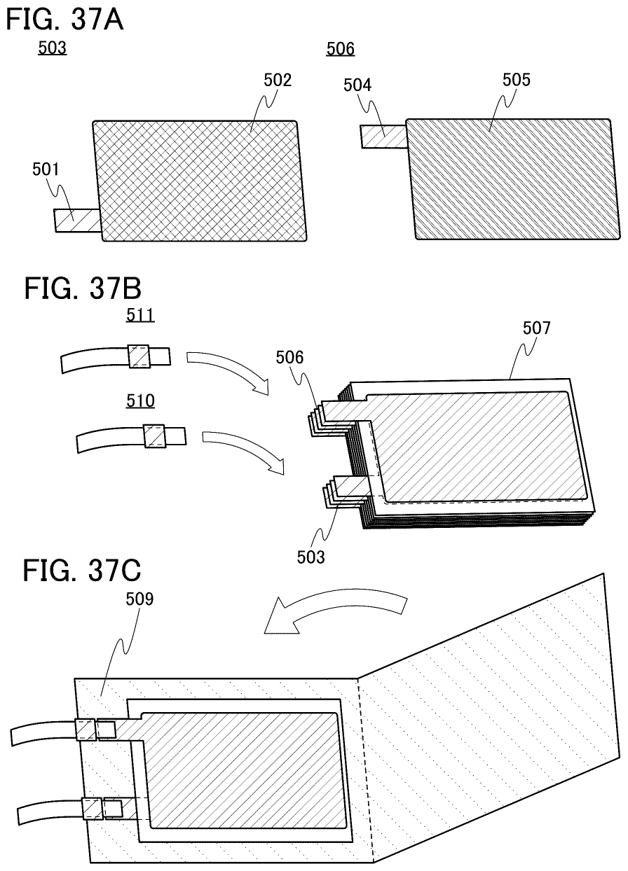

FIG. 37A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those illustrated in FIG. 37A.

### <Method for Fabricating Laminated Secondary Battery>

Here, an example of a method for fabricating the laminated secondary battery having the appearance illustrated in FIG. 36A will be described with reference to FIG. 37B and FIG. 37C.

First, the negative electrode 506, the separator 507, and the positive electrode 503 are stacked. FIG. 37B illustrates the negative electrodes 506, the separators 507, and the positive electrodes 503 that are stacked. Here, an example in which 5 negative electrodes and 4 positive electrodes are used is illustrated. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 37C. Then, the outer edges of the exterior body 509 are bonded to each other. The bonding can be performed by thermocompression bonding, for example. At this time, a part (or one side) of the exterior body 509 is left unbonded (such a part is hereinafter referred to as an inlet) so that an electrolyte solution can be introduced later.

Next, the electrolyte solution (not illustrated) is introduced into the exterior body 509 from the inlet of the exterior body 509. The electrolyte solution is preferably introduced in a reduced pressure atmosphere or in an inert atmosphere. Lastly, the inlet is sealed by bonding. In this manner, a laminated secondary battery 500 can be fabricated.

The positive electrode active material 115 obtained in Embodiment 1 is used in the positive electrode 503, whereby the secondary battery 500 can have high capacity, high discharge capacity, and excellent cycle performance.

### Examples of Battery Pack

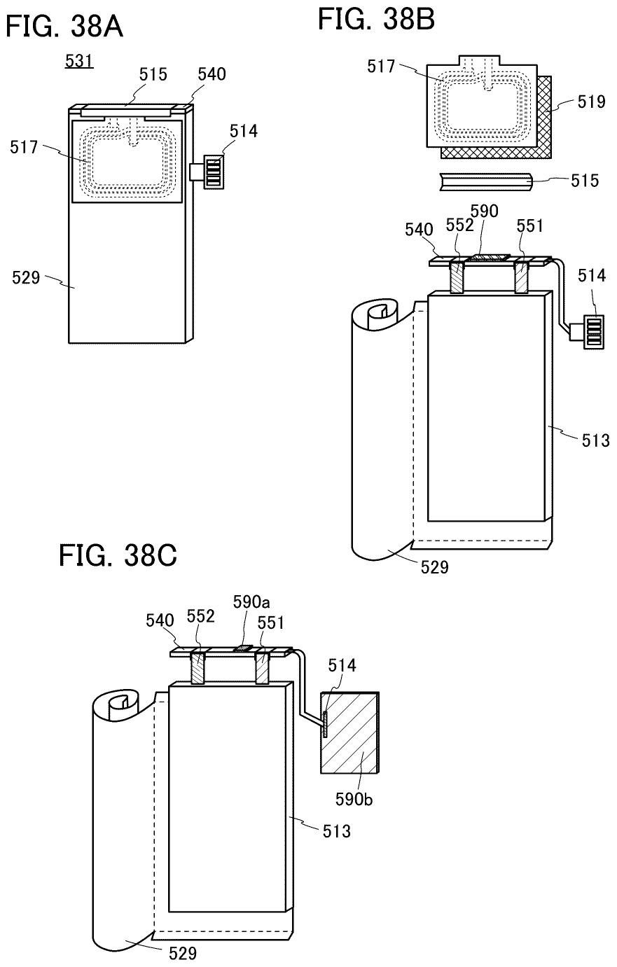

Examples of a secondary battery pack of one embodiment of the present invention that is capable of wireless charging using an antenna will be described with reference to FIG. 38A to FIG. 38C.

FIG. 38A illustrates the appearance of a secondary battery pack 531 that has a rectangular solid shape with a small thickness (also referred to as a flat plate shape with a certain thickness). FIG. 38B illustrates the structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 38B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 38C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

The contents in this embodiment can be freely combined with the contents in the other embodiments.

### Embodiment 6

This embodiment will describe an example in which an all-solid-state secondary battery is fabricated using the positive electrode active material 115 obtained in Embodiment 1.

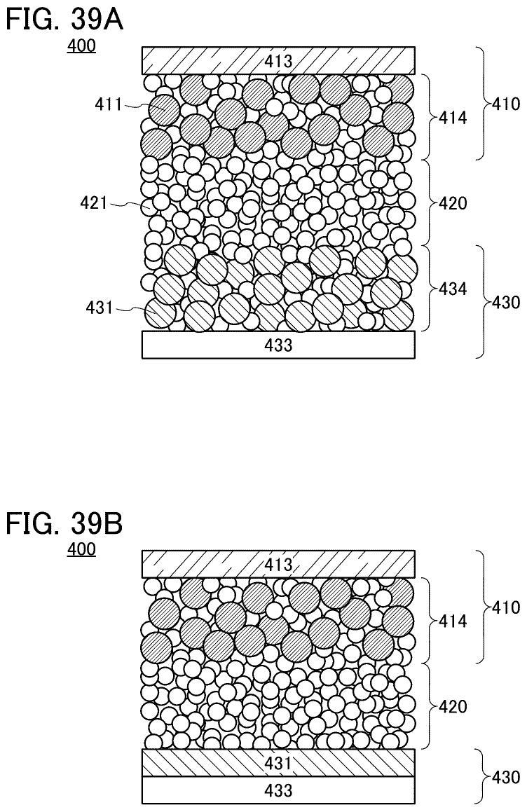

As illustrated in FIG. 39A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material 115 obtained in Embodiment 1 is used as the positive electrode active material 411. The positive electrode active material layer 414 may also include a conductive material and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive material and a binder. Note that when metal lithium is used as the negative electrode active material 431, metal lithium does not need to be processed into particles; thus, the negative electrode 430 that does not include the solid electrolyte 421 can be fabricated, as illustrated in FIG. 39B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

The sulfide-based solid electrolyte includes a thio-LISICON-based material (e.g., Li₁₀GeP₂S₁₂ or Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, and 50Li₂S·50GeS₂), or sulfide-based crystallized glass (e.g., Li₇P3S₁ or Li_{3.25}P_{0.95}S₄). The sulfide-based solid electrolyte has advantages such as high conductivity of some materials, low-temperature synthesis, and ease of maintaining a path for electrical conduction after charge and discharge because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1-Y}Al_{Y}Ti₂—Y(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃(0<x<1) having a NASICON crystal structure (hereinafter, LATP) is preferable because it contains aluminum and titanium, each of which is the element the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification and the like, a NASICON crystal structure refers to a composite oxide that is represented by M₂(XO₄)₃ (M:transition metal; X:S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can employ a variety of materials and have a variety of shapes, and preferably has a function of applying pressure to the positive electrode, the solid electrolyte layer, and the negative electrode.

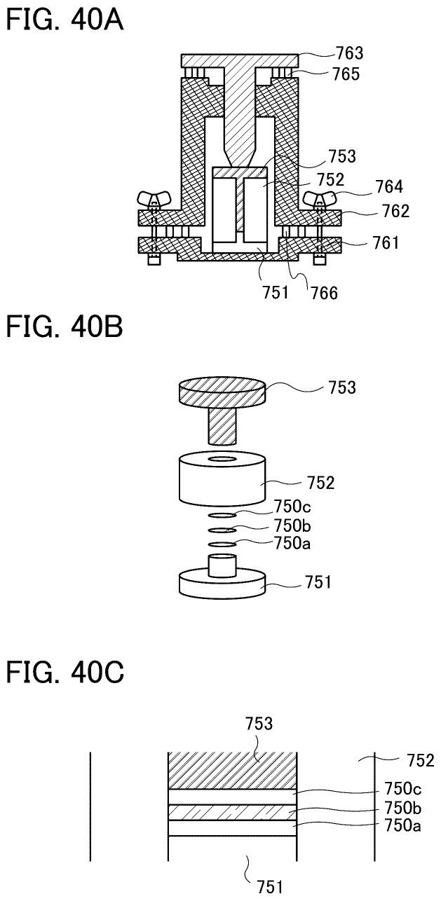

FIG. 40 illustrates an example of a cell for evaluating materials of an all-solid-state secondary battery, for example.

FIG. 40A is a schematic cross-sectional view of the evaluation cell. The evaluation cell includes a lower component 761, an upper component 762, and a fixation screw or a butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An 0 ring 765 for hermetic sealing is provided between the upper component 762 and the pressure screw 763.

The evaluation material is placed on an electrode plate 751, surrounded by an insulating tube 752, and pressed from above by the electrode plate 753. FIG. 40B is an enlarged perspective view of the evaluation material and its vicinity.

A stack of a positive electrode 750a, a solid electrolyte layer 750b, and a negative electrode 750c is illustrated here as an example of the evaluation material, and its cross section is illustrated in FIG. 40C. Note that the same portions in FIG. 40A to FIG. 40C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. The exterior body is sealed preferably in a closed atmosphere where the outside air is blocked, for example, in a glove box.

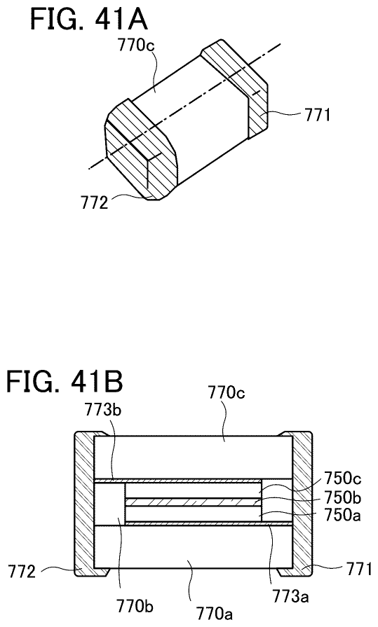

FIG. 41A is a perspective view of a secondary battery of one embodiment of the present invention that has an exterior body and a shape different from those in FIG. 40. The secondary battery in FIG. 41A includes external electrodes 771 and 772 and is sealed with an exterior body including a plurality of package components.

FIG. 41B illustrates an example of a cross section along the dashed-dotted line in FIG. 41A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material such as a resin material or ceramic can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the positive electrode active material 115 obtained in Embodiment 1 can achieve an all-solid-state secondary battery having a high energy density and favorable output characteristics.

The contents in this embodiment can be combined with the contents in the other embodiments as appropriate.

### Embodiment 7

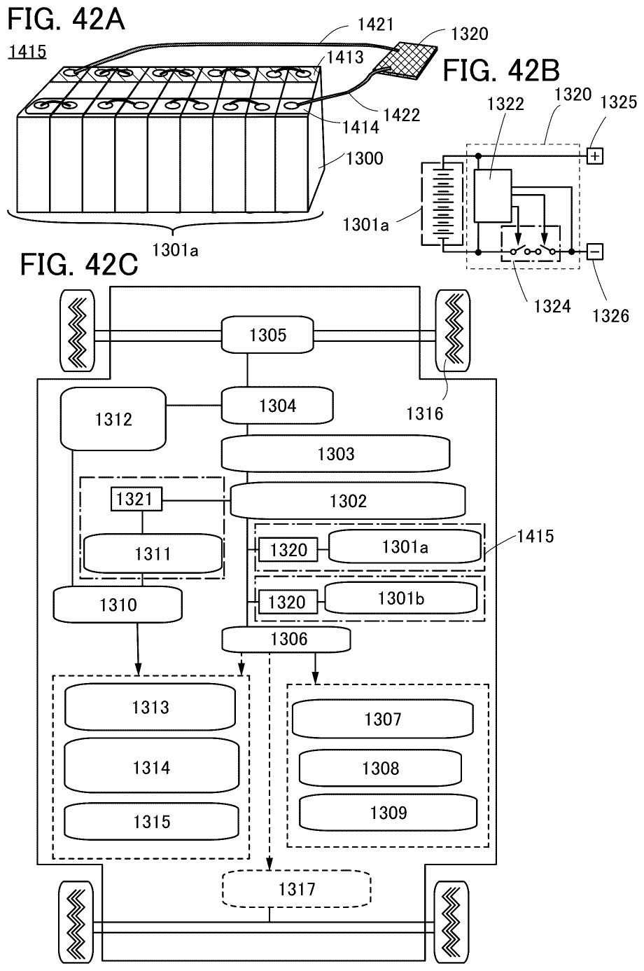

This embodiment is an example different from the cylindrical secondary battery of FIG. 33D. An example of application to an electric vehicle (EV) will be described with reference to FIG. 42C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery or a starter battery. The second battery 1311 needs high output and high capacity is not so necessary, and the capacity of the second battery 1311 is lower than that of the first batteries 1301a and 1301b.

The internal structure of the first battery 1301a may be the wound structure illustrated in FIG. 34A or FIG. 35C or the stacked structure illustrated in FIG. 36A or FIG. 36B. Alternatively, the first battery 1301a may be the all-solid-state secondary battery in Embodiment 6. Using the all-solid-state secondary battery in Embodiment 6 as the first battery 1301a achieves high capacity, a high level of safety, reduction in size, and reduction in weight.

Although this embodiment describes an example in which two first batteries 1301a and 1301b are connected in parallel, three or more first batteries may be connected in parallel. When the first battery 1301a is capable of storing sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries can also be referred to as an assembled battery.

An in-vehicle secondary battery includes a service plug or a circuit breaker that can cut off a high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14 V (such as a stereo 1313, power windows 1314, and lamps 1315) through a DC-DC circuit 1310.

The first battery 1301a will be described with reference to FIG. 42A.

FIG. 42A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment describes the example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode of each battery is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a BTOS (Battery operating system or Battery oxide semiconductor).

A metal oxide functioning as an oxide semiconductor is preferably used. For example, as the oxide, a metal oxide such as an In-M-Zn oxide (the element M is one or more selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the oxide is preferably a CAAC-OS (C-Axis Aligned Crystal Oxide Semiconductor) or a CAC-OS (Cloud-Aligned Composite Oxide Semiconductor). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. When an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. In addition, the CAC-OS refers to one composition of a material in which elements constituting a metal oxide are unevenly distributed with a size greater than or equal to 0.5 nm and less than or equal to 10 nm, preferably greater than or equal to 1 nm and less than or equal to 3 nm, or a similar size, for example. Note that a state in which one or more metal elements are unevenly distributed and regions including the metal element(s) are mixed with a size greater than or equal to 0.5 nm and less than or equal to 10 nm, preferably greater than or equal to 1 nm and less than or equal to 3 nm, or a similar size in a metal oxide is hereinafter referred to as a mosaic pattern or a patch-like pattern.

In addition, the CAC-OS has a composition in which materials are separated into a first region and a second region to form a mosaic pattern, and the first regions are distributed in the film (this composition is hereinafter also referred to as a cloud-like composition). That is, the CAC-OS is a composite metal oxide having a composition in which the first regions and the second regions are mixed.

Here, the ratios of the numbers of In, Ga, and Zn atoms to the metal elements contained in the CAC-OS in an In—Ga—Zn oxide are denoted by [In], [Ga], and [Zn], respectively. For example, the first region in the CAC-OS in the In—Ga—Zn oxide has [In] higher than [In] in the composition of the CAC-OS film. Moreover, the second region has [Ga] higher than [Ga] in the composition of the CAC-OS film. Alternatively, for example, the first region has [In] higher than [In] in the second region and [Ga] lower than [Ga] in the second region. Moreover, the second region has [Ga] higher than [Ga] in the first region and [In] lower than [In] in the first region.

Specifically, the first region is a region including an indium oxide, an indium zinc oxide, or the like as its main component. The second region is a region including a gallium oxide, a gallium zinc oxide, or the like as its main component. That is, the first region can be referred to as a region containing In as its main component. The second region can be referred to as a region containing Ga as its main component.

Note that a clear boundary between the first region and the second region cannot be observed in some cases.

For example, in EDX mapping obtained by energy dispersive X-ray spectroscopy (EDX), it is confirmed that the CAC-OS in the In—Ga—Zn oxide has a structure in which the region containing In as its main component (the first region) and the region containing Ga as its main component (the second region) are unevenly distributed and mixed.

In the case where the CAC-OS is used for a transistor, a switching function (on/off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Thus, when the CAC-OS is used for a transistor, high on-state current (Iₒₙ), high field-effect mobility (μ), and favorable switching operation can be achieved.

An oxide semiconductor has various structures with different properties. Two or more kinds among an amorphous oxide semiconductor, a polycrystalline oxide semiconductor, an a-like OS, the CAC-OS, an nc-OS, and the CAAC-OS may be included in an oxide semiconductor of one embodiment of the present invention.

The control circuit portion 1320 preferably uses a transistor using an oxide semiconductor because the transistor using an oxide semiconductor can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C. inclusive, which is wider than that of a single crystal Si transistor, and thus shows a smaller change in characteristics than the single crystal Si transistor when the secondary battery is heated. The off-state current of the transistor using an oxide semiconductor hardly depends on the temperature and is lower than or equal to the lower measurement limit even at 150° C. On the other hand, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the level of safety. When the control circuit portion 1320 is used in combination with a secondary battery including a positive electrode using the positive electrode active material 115 obtained in Embodiment 1 or the like, the synergy on safety can be obtained.

The control circuit portion 1320 that includes a memory circuit including a transistor using an oxide semiconductor can also function as an automatic control device for the secondary battery to resolve ten items of causes of instability, such as a micro-short circuit. Examples of functions of resolving the ten items of causes of instability include prevention of overcharge, prevention of overcurrent, control of overheating during charge, cell balance of an assembled battery, prevention of overdischarge, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A micro-short circuit refers to a minute short circuit caused in a secondary battery. A micro-short circuit refers to not a state where the positive electrode and the negative electrode of a secondary battery are short-circuited so that charge and discharge are impossible, but a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

A cause of a micro-short circuit is a plurality of charge and discharge; uneven distribution of positive electrode active materials leads to local concentration of current in part of the positive electrode and the negative electrode; and then part of a separator stops functioning or a by-product is generated by a side reaction, which is thought to generate a micro short-circuit.

It can be said that the control circuit portion 1320 not only detects a micro-short circuit but also senses a terminal voltage of the secondary battery and controls the charge and discharge state of the secondary battery. For example, to prevent overcharge, the control circuit portion 1320 can turn off an output transistor of a charge circuit and an interruption switch substantially at the same time.

FIG. 42B is an example of a block diagram of the battery pack 1415 illustrated in FIG. 42A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery used, and controls the upper limit of current from the outside, the upper limit of output current to the outside, or the like. The range from the lower limit voltage to the upper limit voltage of the secondary battery is a recommended voltage range, and when a voltage is out of the range, the switch portion 1324 operates and functions as a protection circuit. The control circuit portion 1320 can also be referred to as a protection circuit because it controls the switch portion 1324 to prevent overdischarge and overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOx (gallium oxide; x is a real number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system).

In this embodiment, an example in which a lithium-ion secondary battery is used as each of the first battery 1301a and the second battery 1311 is described. As the second battery 1311, a lead storage battery, an all-solid-state secondary battery, or an electric double layer capacitor may be used. For example, the all-solid-state secondary battery in Embodiment 6 may be used. Using the all-solid-state secondary battery in Embodiment 6 as the second battery 1311 achieves high capacity, reduction in size, and reduction in weight.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charge with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge characteristics of a secondary battery to be used, so that fast charge can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, or a three-phase 200V outlet with 50 kW, for example. Furthermore, charge can be performed with electric power supplied from external charge equipment by a contactless power feeding system or the like.

For fast charge, secondary batteries that can withstand high-voltage charge have been desired to perform charge in a short time.

The above-described secondary battery in this embodiment includes the positive electrode active material 115 obtained in Embodiment 1 or the like. Moreover, it is possible to achieve a secondary battery in which graphene is used as a conductive material, the electrode layer is formed thick to increase the loading amount while suppressing a reduction in capacity, and the electrical characteristics are significantly improved in synergy with maintenance of high capacity. This secondary battery is particularly effectively used in a vehicle and can achieve a vehicle that has a long range, specifically a driving range per charge of 500 km or longer, without increasing the proportion of the weight of the secondary battery to the weight of the entire vehicle.

Specifically, in the above-described secondary battery in this embodiment, the use of the positive electrode active material 115 described in Embodiment 1 or the like can increase the operating voltage of the secondary battery, and the increase in charge voltage can increase the available capacity. Moreover, using the positive electrode active material 115 described in Embodiment 1 or the like in the positive electrode can provide an automotive secondary battery having excellent cycle performance.

Next, examples in which the secondary battery of one embodiment of the present invention is mounted on a vehicle, typically a transport vehicle, will be described.

Mounting the secondary battery illustrated in any of FIG. 33D, FIG. 35C, and FIG. 42A on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

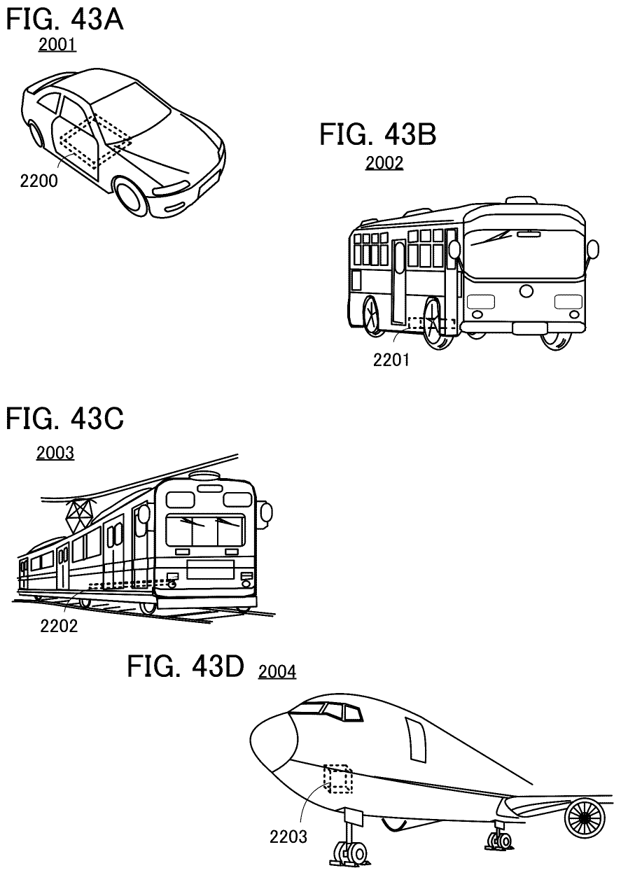

FIG. 43A to FIG. 43D illustrate examples of transport vehicles using one embodiment of the present invention. A motor vehicle 2001 illustrated in FIG. 43A is an electric vehicle that runs on an electric motor as a power source. Alternatively, the motor vehicle 2001 is a hybrid electric vehicle that can appropriately select an electric motor or an engine as a driving power source. In the case where the secondary battery is mounted on the vehicle, an example of the secondary battery described in Embodiment 5 is provided at one position or several positions. The motor vehicle 2001 illustrated in FIG. 43A includes a battery pack 2200, and the battery pack includes a secondary battery module in which a plurality of secondary batteries are connected to each other. Moreover, the battery pack preferably includes a charge control device that is electrically connected to the secondary battery module.

The motor vehicle 2001 can be charged when the secondary battery of the motor vehicle 2001 receives electric power from external charge equipment through a plug-in system, a contactless power feeding system, or the like. In charge, a given method such as CHAdeMO (registered trademark) or Combined Charging System may be employed as a charge method, the standard of a connector, and the like as appropriate. A charge apparatus may be a charge station provided in a commerce facility or a household power supply. For example, a plug-in technique enables the secondary battery mounted on the motor vehicle 2001 to be charged by being supplied with electric power from the outside. Charge can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 43B illustrates a large transporter 2002 having a motor controlled by electricity, as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has a function similar to that in FIG. 43A except, for example, the number of secondary batteries forming the secondary battery module of the battery pack 2201; thus the description is omitted.

FIG. 43C illustrates a large transport vehicle 2003 having a motor controlled by electricity as an example. The secondary battery module of the transport vehicle 2003 has 100 or more secondary batteries with a nominal voltage of 3.0 V or higher and 5.0 V or lower connected in series, and the maximum voltage is 600 V, for example. With the use of the positive electrode using the positive electrode active material 115 described in Embodiment 1 or the like, a secondary battery having favorable rate characteristics and charge and discharge cycle performance can be fabricated, which can contribute to higher performance and a longer lifetime of the transport vehicle 2003. A battery pack 2202 has a function similar to that in FIG. 43A except, for example, the number of secondary batteries forming the secondary battery module of the battery pack 2202; thus, the description is omitted.

FIG. 43D illustrates an aircraft 2004 having a combustion engine as an example. The aircraft 2004 illustrated in FIG. 43D can be regarded as a kind of transport vehicle since it is provided with wheels for takeoff and landing, and has a battery pack 2203 including a secondary battery module and a charge control device; the secondary battery module includes a plurality of connected secondary batteries.

The secondary battery module of the aircraft 2004 has eight 4 V secondary batteries connected in series, which has a maximum voltage of 32 V, for example. A battery pack 2203 has a function similar to that in FIG. 43A except, for example, the number of secondary batteries forming the secondary battery module of the battery pack 2203; thus the description is omitted.

The contents in this embodiment can be combined with the contents in the other embodiments as appropriate.

### Embodiment 8

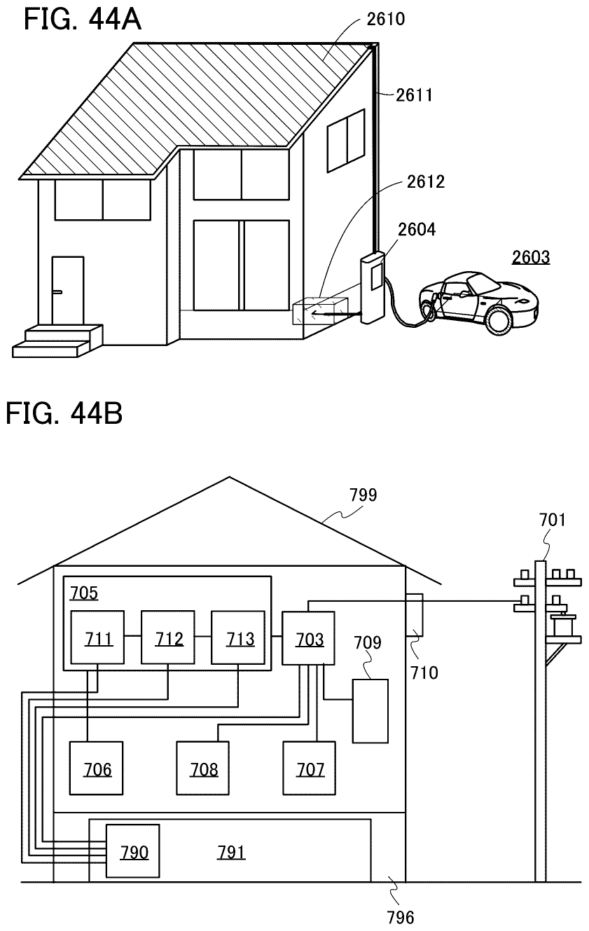

In this embodiment, examples in which the secondary battery of one embodiment of the present invention is mounted on a building will be described with reference to FIG. 44A and FIG. 44B.

A house illustrated in FIG. 44A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to a ground-based charge apparatus 2604. The power storage device 2612 can be charged with electric power generated by the solar panel 2610. The secondary battery included in a vehicle 2603 can be charged with the electric power stored in the power storage device 2612 through the charge apparatus 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 44B illustrates an example of a power storage device of one embodiment of the present invention. As illustrated in FIG. 44B, a power storage device 791 of one embodiment of the present invention is provided in an underfloor space 796 of a building 799. The power storage device 791 may be provided with the control circuit described in Embodiment 7 or the like, and the use of a secondary battery including a positive electrode using the positive electrode active material 115 obtained in Embodiment 1 or the like for the power storage device 791 enables the power storage device 791 to have a long lifetime.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

The contents in this embodiment can be combined with the contents in the other embodiments as appropriate.

### Embodiment 9

This embodiment will describe examples in which the secondary battery of one embodiment of the present invention is mounted on a motorcycle and a bicycle.

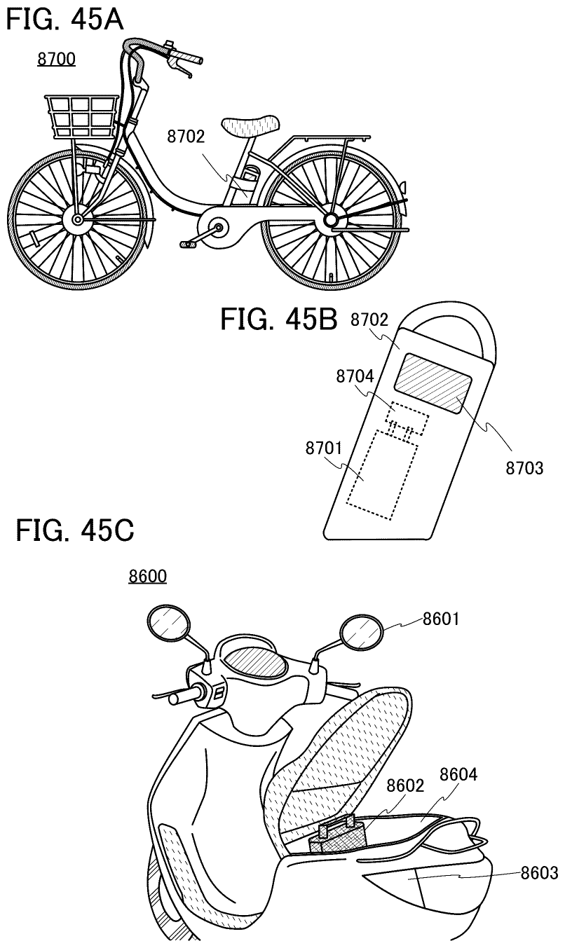

FIG. 45A illustrates an example of an electric bicycle using the secondary battery of one embodiment of the present invention. The secondary battery of one embodiment of the present invention can be used for an electric bicycle 8700 illustrated in FIG. 45A. A power storage device 8702 illustrated in FIG. 45B includes a plurality of secondary batteries and a protection circuit, for example.

The electric bicycle 8700 includes the power storage device 8702. The power storage device 8702 can supply electricity to a motor that assists a rider. The power storage device 8702 is portable, and FIG. 45B illustrates the state where the power storage device 8702 is detached from the bicycle. A plurality of secondary batteries 8701 of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 7 or the like. The control circuit 8704 is electrically connected to a positive electrode and a negative electrode of the secondary battery 8701. The control circuit 8704 may include the small solid-state secondary battery illustrated in FIG. 41A and FIG. 41B. When the small solid-state secondary battery illustrated in FIG. 41A and FIG. 41B is provided in the control circuit 8704, electric power can be supplied to store data in a memory circuit included in the control circuit 8704 for a long time. When the control circuit 8704 is used in combination with a secondary battery including a positive electrode using the positive electrode active material 115 obtained in Embodiment 1 or the like, the synergy on safety can be obtained. The secondary battery including the positive electrode using the positive electrode active material 115 obtained in Embodiment 1 or the like and the control circuit 8704 can contribute greatly to elimination of accidents due to secondary batteries, such as fires.

FIG. 45C illustrates an example of a motorcycle using the secondary battery of one embodiment of the present invention. A motor scooter 8600 illustrated in FIG. 45C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 115 obtained in Embodiment 1 or the like can have high capacity and contribute to a reduction in size.

In the motor scooter 8600 illustrated in FIG. 45C, the power storage device 8602 can be stored in an under-seat storage unit 8604. The power storage device 8602 can be stored in the under-seat storage unit 8604 even with a small size.

The contents in this embodiment can be combined with the contents in the other embodiments as appropriate.

### Embodiment 10

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book terminal, and a mobile phone.

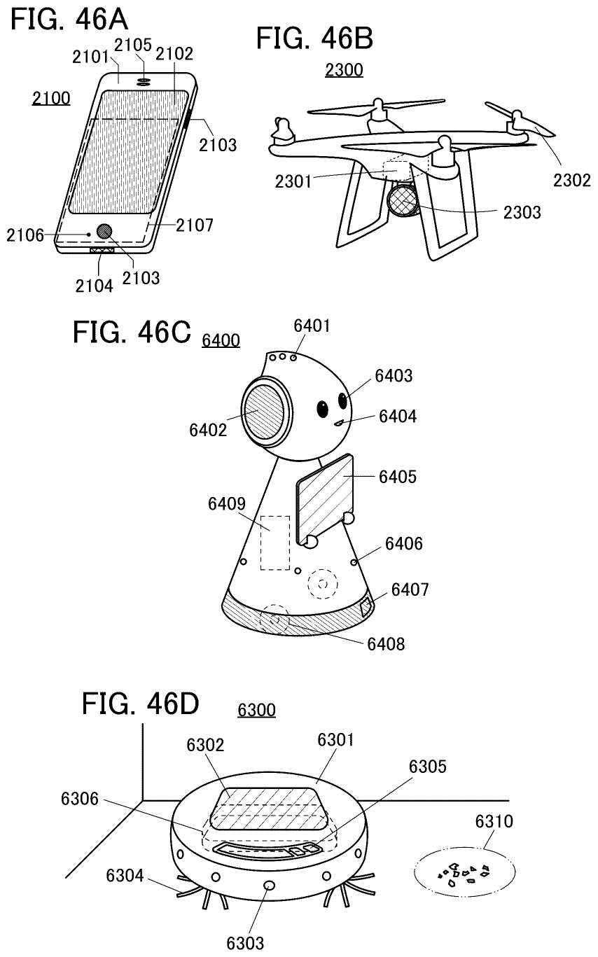

FIG. 46A illustrates an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. The use of the secondary battery 2107 including a positive electrode using the positive electrode active material 115 described in Embodiment 1 or the like achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication based on an existing communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 46B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 115 obtained in Embodiment 1 or the like has high energy density and a high level of safety, and thus can be used safely for a long time over a long period of time and is preferable as the secondary battery included in the unmanned aircraft 2300.

FIG. 46C illustrates an example of a robot. A robot 6400 illustrated in FIG. 46C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 115 obtained in Embodiment 1 or the like has high energy density and a high level of safety, and thus can be used safely for a long time over a long period of time and is preferable as the secondary battery 6409 included in the robot 6400.

FIG. 46D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material 115 obtained in Embodiment 1 or the like has high energy density and a high level of safety, and thus can be used safely for a long time over a long period of time and is preferable as the secondary battery 6306 included in the cleaning robot 6300.

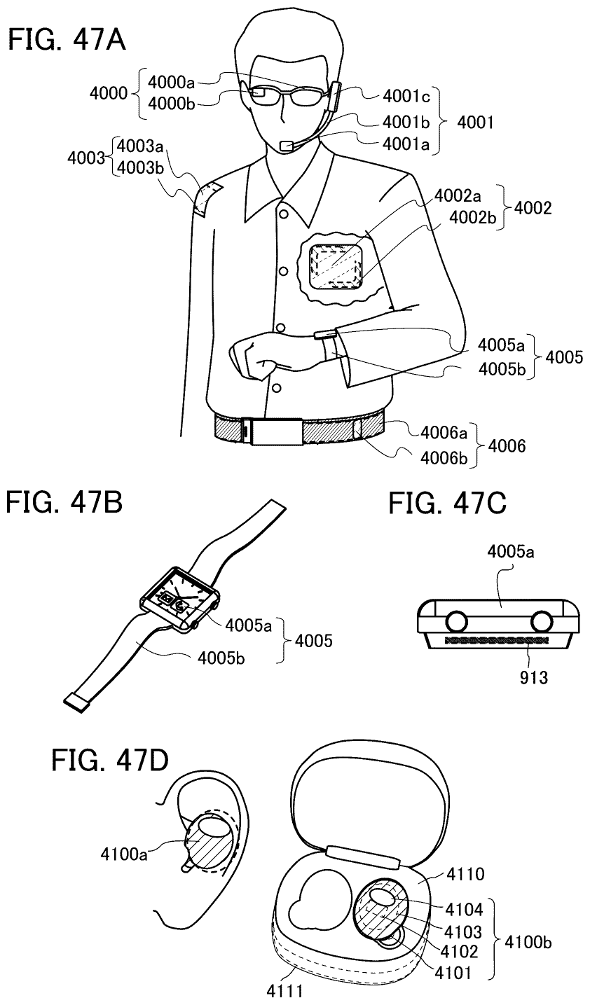

FIG. 47A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 47A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. A secondary battery including a positive electrode using the positive electrode active material 115 obtained in Embodiment 1 or the like has high energy density and achieves a structure that accommodates space saving due to a reduction in size of the housing.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c. A secondary battery including a positive electrode using the positive electrode active material 115 obtained in Embodiment 1 or the like has high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material 115 obtained in Embodiment 1 or the like has high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material 115 obtained in Embodiment 1 or the like has high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material 115 obtained in Embodiment 1 or the like has high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material 115 obtained in Embodiment 1 or the like has high energy density and achieves a structure that accommodates space saving due to a reduction in size of the housing.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 47B is a perspective view of the watch-type device 4005 that is detached from an arm.

FIG. 47C is a side view. FIG. 47C illustrates a state where the secondary battery 913 is incorporated in the inner region. The secondary battery 913 is the secondary battery described in Embodiment 5 or the like. The secondary battery 913 is provided to overlap with the display portion 4005a, can have high density and high capacity, and is small and lightweight.

Since the secondary battery in the watch-type device 4005 is required to be small and lightweight, the use of the positive electrode active material 115 obtained in Embodiment 1 or the like in the positive electrode of the secondary battery 913 enables the secondary battery 913 to have high energy density and a small size.

FIG. 47D illustrates an example of wireless earphones. The wireless earphones illustrated as an example consist of, but not limited to, a pair of earphone bodies 4100a and 4100b.

Each of the earphone bodies 4100a and 4100b includes a driver unit 4101, an antenna 4102, and a secondary battery 4103. Each of the earphone bodies 4100a and 4100b may also include a display portion 4104. Moreover, each of the earphone bodies 4100a and 4100b preferably includes a substrate where a circuit such as a wireless IC is provided, a terminal for charge, and the like. Each of the earphone bodies 4100a and 4100b may also include a microphone.

A case 4110 includes a secondary battery 4111. Moreover, the case 4110 preferably includes a substrate where a circuit such as a wireless IC or a charge control IC is provided, and a terminal for charge. The case 4110 may also include a display portion, a button, and the like.

The earphone bodies 4100a and 4100b can communicate wirelessly with another electronic device such as a smartphone. Thus, sound data and the like transmitted from another electronic device can be played through the earphone bodies 4100a and 4100b. When the earphone bodies 4100a and 4100b include a microphone, sound captured by the microphone is transmitted to another electronic device, and sound data obtained by processing with the electronic device can be transmitted to and played through the earphone bodies 4100a and 4100b. Hence, the wireless earphones can be used as a translator, for example.

The secondary battery 4103 included in the earphone body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery including a positive electrode using the positive electrode active material 115 obtained in Embodiment 1 or the like has high energy density; thus, with the use of the secondary battery as the secondary battery 4103 and the secondary battery 4111, a structure that accommodates space saving due to a reduction in size of the wireless earphones can be achieved.

This embodiment can be implemented in appropriate combination with the other embodiments.

### Example 1

In this example, a molecular crystal of one embodiment of the present invention was formed and the features thereof were analyzed.

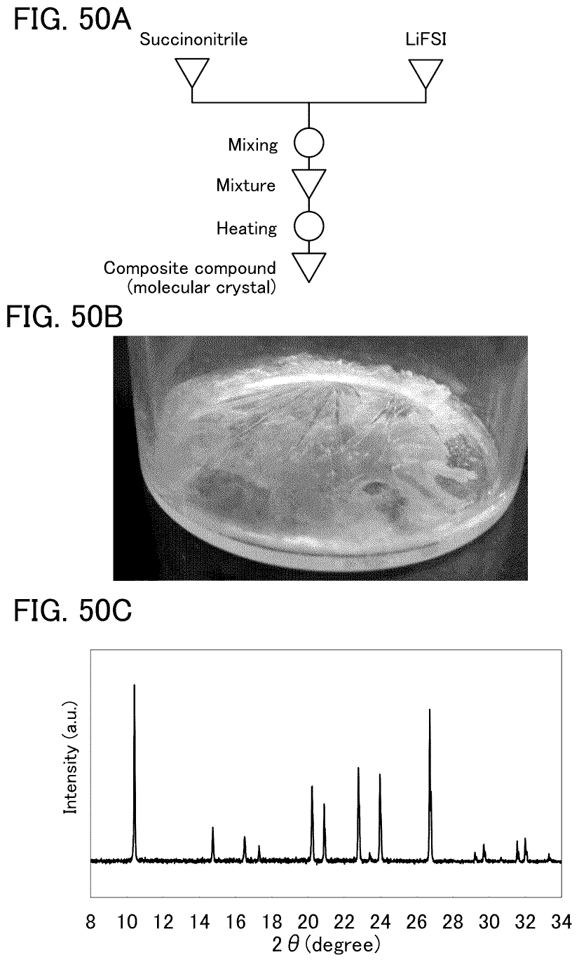

A composite compound (Sample A) of this example was formed by a formation method shown in FIG. 50A.

In FIG. 50A, succinonitrile (SN) and LiFSI (lithium bis(fluorosulfonyl)imide) were mixed at a molar ratio of 2:1, whereby a mixture was obtained. The mixture was heated at 69° C. for 2 hours, and then heated at 75° C. for 30 minutes. The temperature was lowered to room temperature after the heating, so that Sample A was obtained.

FIG. 50B is a photograph of Sample A. Sample A had a needle-like shape.

Sample A was subjected to XRD measurement. The apparatus and conditions for the XRD measurement are as follows.
XRD apparatus: D8 ADVANCE produced by Bruker AXS
X-ray source: CuKα radiation
Output: 40 KV, 40 mA
Slit system: Div. Slit, 0.5°
Detector: LynxEye
Scanning method: 2θ/θ continuous scanning
Measurement range (2θ): from 8° to 34°
Step width (2θ): 0.01°
Counting time: 1 second/step
Rotation of sample stage: 15 rpm

FIG. 50C shows X-ray diffraction (XRD) results. Table 4 shows the positions and intensities of peaks observed in the XRD measurement.

TABLE 4

| | Peak position (2θ [°]) | | | | |
|---|---|---|---|---|---|
| | 10.41 | 20.22 | 22.79 | 23.97 | 26.73 |
| Peak intensity (Normalized intensity) | 1.00 | 0.43 | 0.53 | 0.50 | 0.86 |

Analysis of the XRD measurement results reveals that a peak indicating a substance Li(FSI)(SN)₂ is observed. In addition, according to the XRD measurement results, the half width of the peak is found to be narrow, which means that Li(FSI)(SN)₂ has high crystallinity.

### Example 2

In this example, a molecular crystal of one embodiment of the present invention was formed and the features thereof were analyzed.

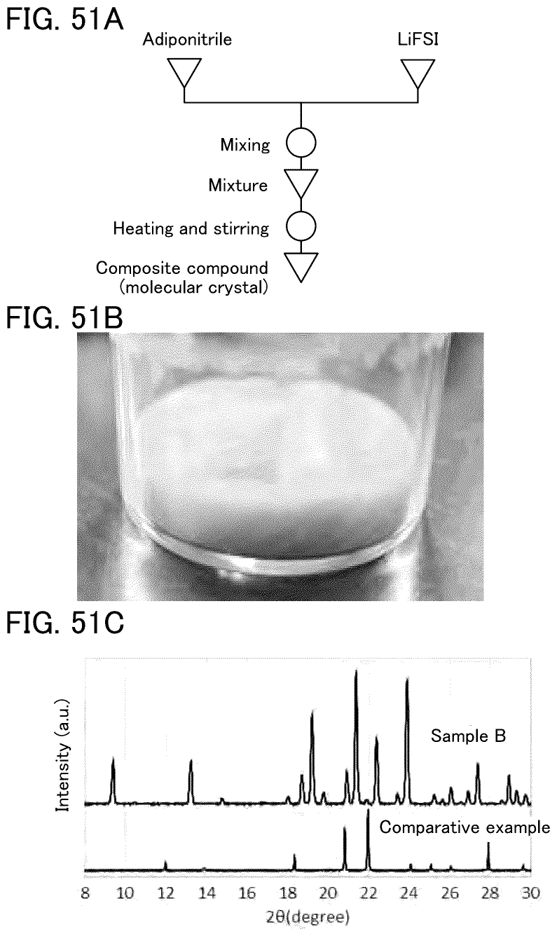

A composite compound (Sample B) of this example was formed by a formation method shown in FIG. 51A.

In FIG. 51A, adiponitrile and LiFSI (lithium bis(fluorosulfonyl)imide) were mixed at a molar ratio of 2:1 to obtain a mixture, and the obtained mixture was heated and stirred. The heating and the stirring were performed at 120° C. for 30 minutes. The temperature was lowered to room temperature after the heating, so that Sample B was obtained.

FIG. 51B is a photograph of Sample B. Sample B was a white solid.

FIG. 51C shows X-ray diffraction (XRD) results of Sample B and XRD results of LiFSI as a comparative example. The XRD measurement conditions were the same as those in Example 1. Table 5 shows the positions and intensities of peaks of Sample B observed in the XRD measurement.

TABLE 5

| | | | | | | |
|---|---|---|---|---|---|---|
| Peak position | 9.41 | 13.08 | 19.22 | 21.38 | 22.39 | 23.90 |
| (2θ [°]) | | | | | | |
| Peak intensity | 0.34 | 0.33 | 0.68 | 1.00 | 0.50 | 0.94 |
| (Normalized | | | | | | |
| intensity) | | | | | | |

Analysis of the XRD measurement results reveals that the peaks of Sample B do not agree with those of the comparative example and another peak is observed; thus, Sample B has a molecular crystal. Specifically, Sample B exhibits the peaks at 2θ=9.41°, 13.08°, 19.22°, 21.38°, 22.39°, and 23.90°. The peaks at lower angles, e.g., 2θ=15° or less, indicate that Sample B has a long periodicity. This presumably reflects the structure of adiponitrile.

### REFERENCE NUMERALS

100: secondary battery, 101: positive electrode, 102: negative electrode, 104: positive electrode current collector, 105: positive electrode active material layer, 106: negative electrode current collector, 107: negative electrode active material layer, 110: separator, 111: binder, 112: region, 113: region, 114: electrolyte, 115: positive electrode active material, 115a: first positive electrode active material, 115b: second positive electrode active material, 115c: inner portion, 115s: surface portion, 116: barrier layer, 117: composite compound, 118: conductive material, 120: dispersion medium, 125a: first negative electrode active material, 125b: second negative electrode active material, 125: first negative electrode active material, 127: composite compound, 128: conductive material, 129: second negative electrode active material

1. A secondary battery comprising:
a positive electrode; and
a negative electrode,
wherein one or both of the positive electrode and the negative electrode comprise an active material and a composite compound with a crystal structure, and
wherein the composite compound is configured to be a binder.

2. The secondary battery according to claim 1, further comprising an electrolyte,
wherein the composite compound comprises a region positioned between the active material and the electrolyte.

3. The secondary battery according to claim 1,
wherein the composite compound is further configured to be an electrolyte.

4. The secondary battery according to claim 1, further comprising a first binder,
wherein the composite compound is further configured to be an electrolyte.

5. The secondary battery according to claim 1,
wherein the composite compound comprises succinonitrile, a lithium ion, and a bis(fluorosulfonyl)imide ion.

6. The secondary battery according to claim 1,
wherein the composite compound comprises glutaronitrile, a lithium ion, and a bis(fluorosulfonyl)imide ion.

7. The secondary battery according to claim 1,
wherein the composite compound comprises adiponitrile, a lithium ion, and a bis(fluorosulfonyl)imide ion.

8. The secondary battery according to claim 1, further comprising an electrolyte,
wherein the composite compound comprises a region positioned between the active material and the electrolyte, and
wherein the composite compound comprises succinonitrile, a lithium ion, and bis(fluorosulfonyl)imide.

9. The secondary battery according to claim 1, further comprising an electrolyte,
wherein the composite compound comprises a region positioned between the active material and the electrolyte, and
wherein the composite compound comprises glutaronitrile, a lithium ion, and bis(fluorosulfonyl)imide.

10. The secondary battery according to claim 1, further comprising an electrolyte,
wherein the composite compound comprises a region positioned between the active material and the electrolyte, and
wherein the composite compound comprises adiponitrile, a lithium ion, and a bis(fluorosulfonyl)imide ion.

11. The secondary battery according to claim 1,
wherein the composite compound is further configured to an electrolyte, and
wherein the composite compound comprises succinonitrile, a lithium ion, and a bis(fluorosulfonyl)imide ion.

12. The secondary battery according to claim 1,
wherein the composite compound is further configured to be an electrolyte, and
wherein the composite compound comprises adiponitrile, a lithium ion, and bis(fluorosulfonyl)imide ion.

13. The secondary battery according to claim 1,
wherein the composite compound is configured to be an electrolyte, and
wherein the composite compound comprises adiponitrile, a lithium ion, and bis(fluorosulfonyl)imide.

14. The secondary battery according to claim 1,
wherein the active material in the positive electrode comprises a composite oxide comprising magnesium and cobalt,
wherein the cobalt exists in an inner portion and a surface portion of the active material, and
wherein the magnesium exists at least in the surface portion.

15. The secondary battery according to claim 1,
wherein, in cross-sectional observation by a scanning transmission electron microscope (STEM), the active material in the positive electrode has a surface roughness of at least less than 3 nm when surface unevenness information is quantified.

16. The secondary battery according to claim 1,
wherein a separator is provided between the positive electrode and the negative electrode.

17. The secondary battery according to claim 1,
wherein the active material in the positive electrode has a layered rock-salt crystal structure.

18. The secondary battery according to claim 1,
wherein the active material in the negative electrode comprises one or both of silicon and carbon.

19. The secondary battery according to claim 1,
wherein one or both of the positive electrode and the negative electrode comprise a conductive material.

20. The secondary battery according to claim 19,
wherein the conductive material in the positive electrode comprises at least one of carbon black, graphene, and carbon nanotube.

21. The secondary battery according to claim 19,
wherein the conductive material in the negative electrode comprises at least one of carbon black, graphene, and carbon nanotube.

22. A power storage system comprising:
the secondary battery according to claim 1; and
a protection circuit.

23. A vehicle comprising the secondary battery according to claim 1.

24. A method for fabricating a positive electrode, comprising a first step and a second step,
wherein the first step comprises a step of forming positive electrode slurry by mixing a composite compound with a crystal structure and a positive electrode active material while heating is performed,
wherein the second step comprises a step of applying the positive electrode slurry to a current collector, and
wherein the heating is performed at higher than or equal to a melting point of the composite compound with a crystal structure.

25. A method for fabricating a positive electrode, comprising a first step and a second step,
wherein the first step comprises a step of forming positive electrode slurry by mixing a first compound, a second compound, and a positive electrode active material while heating is performed,
wherein the second step comprises a step of applying the positive electrode slurry to a current collector, and
wherein the heating in the first step is performed at higher than or equal to melting points of the first compound and the second compound.

26. A method for fabricating a positive electrode, comprising a first step to a third step,
wherein the first step comprises a step of forming a composite compound with a crystal structure by mixing a first compound and a second compound while heating is performed,
wherein the second step comprises a step of forming positive electrode slurry by mixing a positive electrode active material and the composite compound while heating is performed,
wherein the third step comprises a step of applying the positive electrode slurry to a current collector, and
wherein the heating in the first step is performed at higher than or equal to a melting point of the composite compound.

27. The method for fabricating a positive electrode, according to claim 25,
wherein the first compound comprises at least one of succinonitrile, glutaronitrile, and adiponitrile, and the second compound comprises lithium bis(fluorosulfonyl)imide.

28. A method for fabricating a positive electrode, comprising a first step to a fifth step,
wherein the first step comprises a step of forming a first mixture by mixing a first binder mixture and a conductive material,
wherein the second step comprises a step of forming a second mixture by mixing the first mixture and a positive electrode active material,
wherein the third step comprises a step of forming a third mixture by mixing the second mixture, a second binder mixture, and a dispersion medium,
wherein the fourth step comprises a step of fabricating a coated electrode by applying the third mixture to a current collector and drying the dispersion medium, and
wherein the fifth step comprises a step of injecting a composite compound with a crystal structure into a space in the coated electrode while heating is performed.

29. The method for fabricating a positive electrode, according to claim 28,
wherein the composite compound with a crystal structure is obtained by mixing lithium bis(fluorosulfonyl)imide and at least one of succinonitrile, glutaronitrile, and adiponitrile while heating is performed.

30. The method for fabricating a positive electrode, according to claim 26,
wherein the first compound comprises at least one of succinonitrile, glutaronitrile, and adiponitrile, and the second compound comprises lithium bis(fluorosulfonyl)imide.
